(19) United States
(12) Patent Application Publication
(10) Pub. No.: US 2025/0258815 A1
(43) Pub. Date: Aug. 14, 2025

(54) METHOD FOR PERFORMING DATA QUERY USING A GRAPH ANALYTICS ENGINE AND RELATED APPARATUS

(71) Applicant: PuppyQuery Inc., Santa Clara, CA (US)

(72) Inventors: Weimo LIU, Santa Clara, CA (US); Danfeng XU, Belmont, CA (US); Lei HUANG, Fremont, CA (US)

(21) Appl. No.: 18/442,085

(22) Filed: Feb. 14, 2024

(51) Int. Cl. G06F 16/2452; G06F 16/242; G06F 16/2453

(52) U.S. Cl. CPC G06F 16/24526; G06F 16/2428; G06F 16/24542

(57) ABSTRACT

This application is directed to data query. A data query method includes receiving a query that defines a graph relationship between target entities within a to-be-queried database. The data query method further includes traversing the to-be-queried database using the query through a graph analytics engine to obtain output entries. Each output entry includes data items matching the graph relationship defined by the query. The graph analytics engine includes an auxiliary component for the query. The auxiliary component further includes vertices and edges associated with the to-be-queried database, and each edge links two vertices. The data query method further includes generating a graph-based representation of output entries.

### TECHNICAL FIELD

This application relates generally to data query, including but not limited to techniques for performing data query using a graph analytics engine across diverse databases.

### BACKGROUND

Data querying serves as a fundamental building block of data management and analytics. Continuous advancements in data querying technologies and methodologies are required to keep pace with users' demands. Challenges in data querying spans various aspects, including query optimization, query scalability, and complexity of traversing interconnected data. In particular, large-scale graph-based data querying requires an efficient graph processing and an effective integration into expandable databases. Moreover, balancing trade-offs between query complexity and computational efficiency remains an ongoing challenge in this domain.

As such, there is a need to address one or more of the above-identified challenges. A brief summary of solutions to the issues noted above are described below.

### SUMMARY

Implementing a graph analytics engine brings a unique solution to data querying and provides a robust data querying platform for accessing large-scale databases. This approach brings several advantages. First, an “Extract, Transform, and Load” (ETL) Process is no longer required. Users can query tables to obtain graphs based on existing tabular databases. The existing tabular databases can be built on Apache Hive, Apache Iceberg, Apache Hudi, Delta Lake, MySQL/Postgre SQL, or other forms that support database connectivity. Second, auto-scaling becomes achievable, as scalability is no longer a concern for graphs. This is because data are auto-sharded, with computation and storage being separately distributed. Third, exceptional performance can be achieved with low latency for complex data queries (e.g., queries for 10-hop neighbors). Fourth, a data querying platform based on the graph analytics engine can be easily migrated because of its compatibility with existing query languages (e.g., Apache Gremlin and OpenCypher) and established data lakes (e.g., Apache Iceberg, Apache Hudi, and Delta Lake). Fifth, data management is streamlined, because there is no need to create additional persisted data copies, which simplifies retention obligations. This simplification of data management process can be further achieved by leveraging existing data lake permissions. Lastly, a data querying platform based on the graph analytics engine empowers users to maintain complete control of their data within data centers that are seamlessly integrated into their cloud-native infrastructure.

In accordance with one aspect of the application, a data query method includes receiving a query that defines a graph relationship between target entities within a to-be-queried database. The data query method further includes traversing the to-be-queried database using the query through a graph analytics engine to obtain a plurality of output entries. Each output entry includes a plurality of data items matching the graph relationship defined by the query. The graph analytics engine includes an auxiliary component for the query. The auxiliary component further includes a plurality of vertices and a plurality of edges associated with the to-be-queried database, and each edge links two vertices. The data query method further includes generating a graph-based representation of the plurality of output entries.

In another aspect of the application, a computer system includes one or more processes and memory storing one or more programs. The one or more programs include instructions that, when executed by the one or more processors, cause the one or more processors to perform operations for any of the methods described above.

In yet another aspect of the application, a non-transitory computer-readable storage medium stores one or more programs. The one or more programs include instructions that, when executed by a computer system that includes one or more processors, cause the one or more processors to perform operations for any of the methods described above.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates a first example data query system based on a graph analytics engine, in accordance with some embodiments.

FIG. 2 illustrates a second example data query system based on the graph analytics engine, in accordance with some embodiments.

FIG. 3 illustrates an example graph query process based on an example graph analytics engine, in accordance with some embodiments.

FIGS. 4A-4C illustrate an example transaction trace graph query based on the graph analytics engine for a to-be-queried tabular database, in accordance with some embodiments.

FIGS. 5A-5L illustrate a series of graph query steps associated with a first example person_knows_person graph query that is performed based on a management user interface (UI) of the graph analytics engine, in accordance with some embodiments.

FIGS. 6A-6F illustrate a series of graph query steps associated with a second example person_knows_person graph query that is performed based on the management UI of the graph analytics engine, in accordance with some embodiments.

FIGS. 7A-7D illustrate an example graph query using the graph analytics engine with locally deployed Apache Iceberg, in accordance with some embodiments.

FIG. 7E illustrates an example graph query using the graph analytics engine with locally deployed PostgreSQL, in accordance with some embodiments.

FIG. 7F illustrates an example graph query using the graph analytics engine with locally deployed DuckDB, in accordance with some embodiments.

FIGS. 8A-8J illustrate an example graph query using the graph analytics engine with data lakes, in accordance with some embodiments.

FIGS. 9A-9O illustrates an example graph query using the graph analytics engine with relational databases, in accordance with some embodiments.

FIGS. 10A-10Q illustrate a series of screenshots of an example schema creation UI for creating an example person_knows_person_UI graph schema, in accordance with some implementations.

FIG. 11 illustrates a flow diagram of an example data query method, in accordance with some embodiments.

These illustrative aspects are mentioned not to limit or define the disclosure, but to provide examples to aid understanding thereof. Additional embodiments are discussed in the Detailed Description, and further description is provided there.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, and networks have not been described in detail so as not to unnecessarily obscure aspects of the embodiments.

### System Architectures

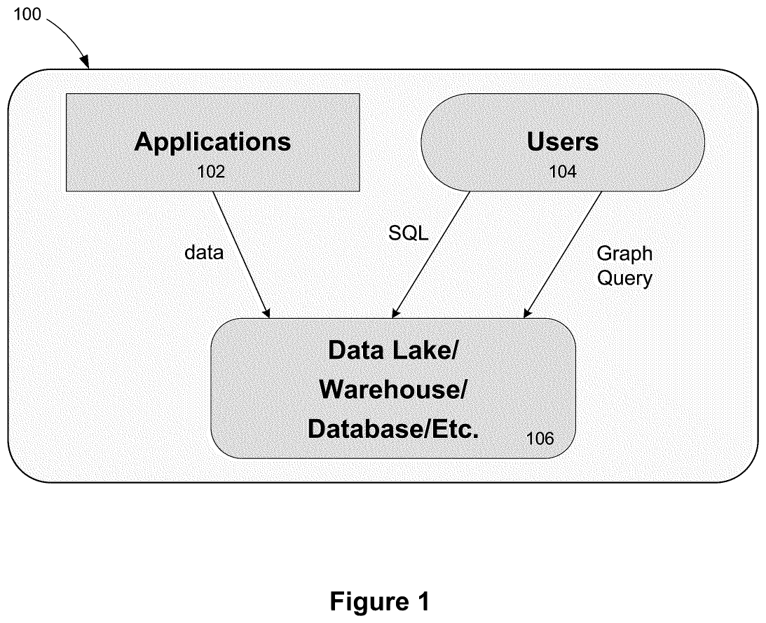

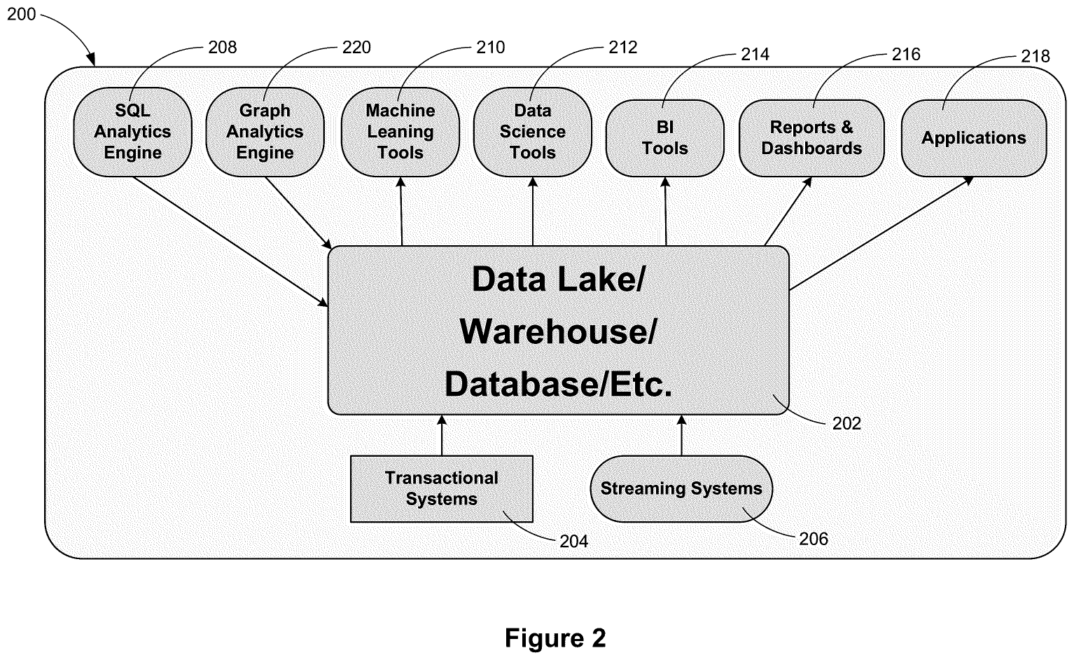

FIG. 1 illustrates a first example data query system 100 based on a graph analytics engine, in accordance with some embodiments. As shown the first example graph query system 100, applications (e.g., software, networks, user interfaces, or open-source projects) 102 are configured to create and manage a to-be-queried database 106. The to-be-queried database 106 is created in accordance with a data architecture that includes at least one of a relational database, a data warehouse, a data lake, or other forms. In particular, the to-be-queried database 106 includes non-graph relationships between non-graph entities and/or graph relationships between graph entities. A user 104 creates a non-graph query that defines a non-graph relationship between the non-graph entities and/or generates a graph query that defines a graph relationship between the graph entities. The user 104 traverses the to-be-queried database 106 using the non-graph query via structured query language (SQL) to obtain output non-graph entries for the non-graph query. Alternatively, the user 104 traverses the to-be-queried database 106 using the graph query through the graph analytics engine (described below in reference to FIG. 2) to obtain output graph entries for the graph query, where each output graph entry for the graph query includes data items matching the graph relationship defined by the graph query.

In some embodiments, for querying a to-be-queried database, a user no longer needs to choose between a SQL-based data model or a graph-based data model. For instance, as shown in FIG. 1, the to-be-queried database 106 can be constructed using SQL-based data models and/or graph-based data models, and it can then be accessed by a data query via the graph analytics engine.

FIG. 2 illustrates a second example data query system 200 based on the graph analytics engine 220, in accordance with some embodiments. A to-be-queried database 202 is built in accordance with a data architecture that includes at least one of relational database, data warehouse, data lake, or other forms. In some embodiments, the to-be-queried database 202 includes a non-SQL (NoSQL) database. The to-be-queried database 202 includes non-graph data and graph data, which are received from transactional systems 204 (e.g., storage devices) and/or streaming systems 206 (e.g., cloud storages). In particular, the non-graph data and graph data in the to-be-queried database 202 can be stored in formats compatible with SQL. A SQL analytics engine 208 is configured to traverse the to-be-queried database 202 using non-graph queries (e.g., written in SQL). On the other hand, the graph analytics engine 220 is configured to traverse the to-be-queried database 202 using both graph queries (e.g., written in graph languages) and non-graph queries (e.g., written in non-graph languages). Then, output entries obtained from the non-graph and/or graph queries are sent to accessory tools for data processing and/or visualization. For instance, the accessory tools include machine learning tools 210, data science tools 212, business intelligence tools 214, reports and dashboards 216, and applications 218 in other forms.

In some embodiments, the graph analytics engine is configured to generate a graph-based representation of output entries obtained from a data query. The graph-based representation can be a network diagram (e.g., network graph, neural network diagram, mesh topology diagram, or other forms). For instance, as shown in FIG. 2, it is optional that the graph analytics engine 220 also includes features for data processing and/or visualization, similar to features provided by the accessory tools (e.g., 210, 212, 214, 216, and 218).

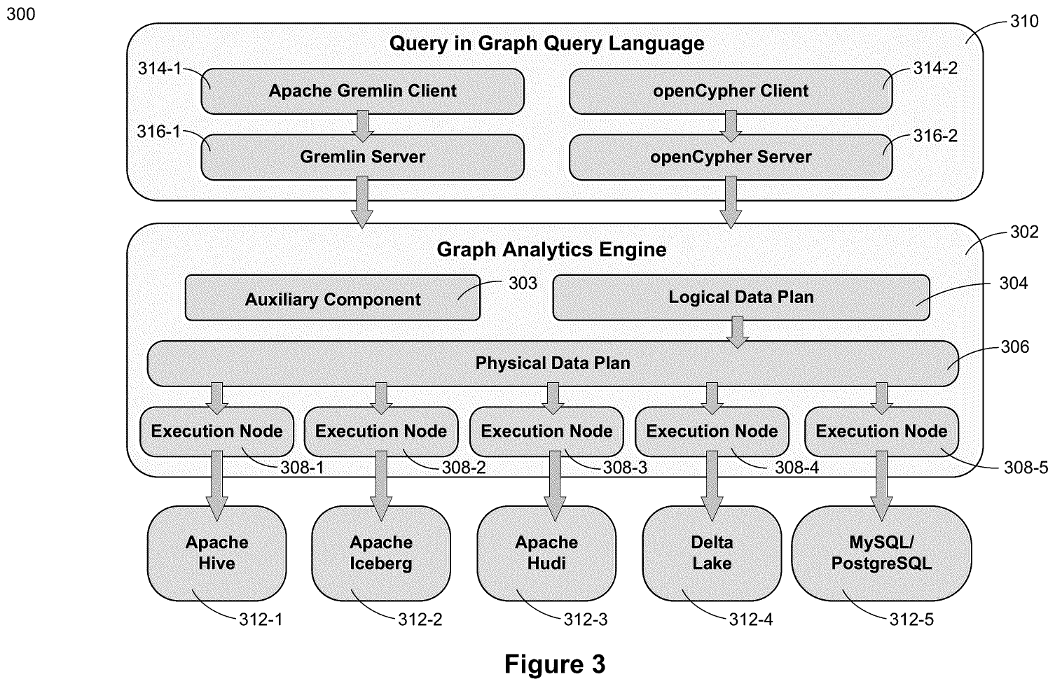

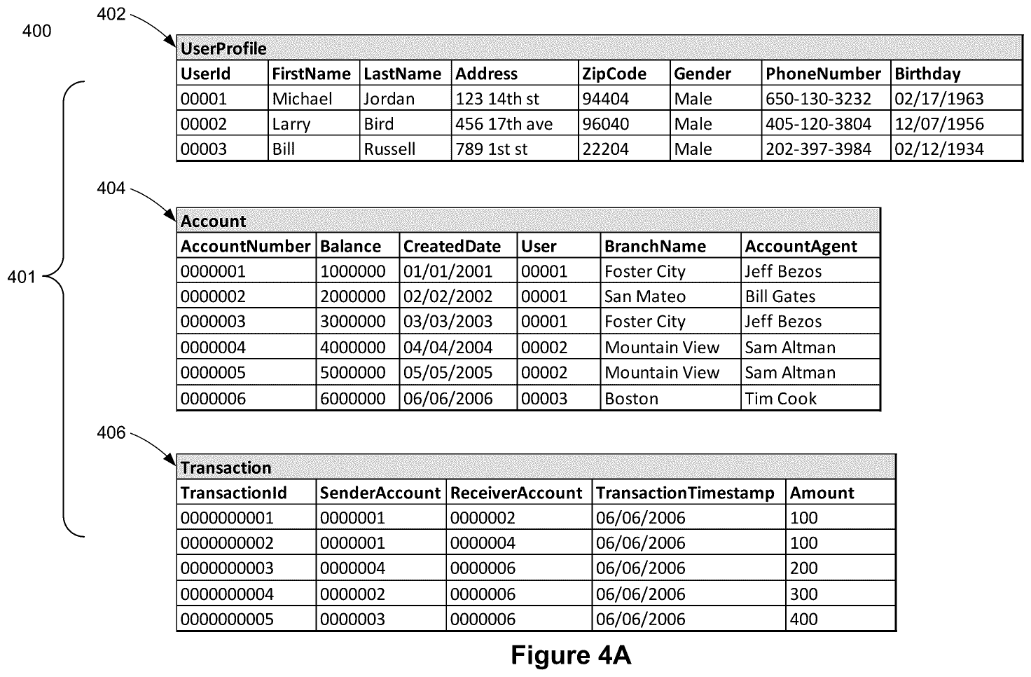

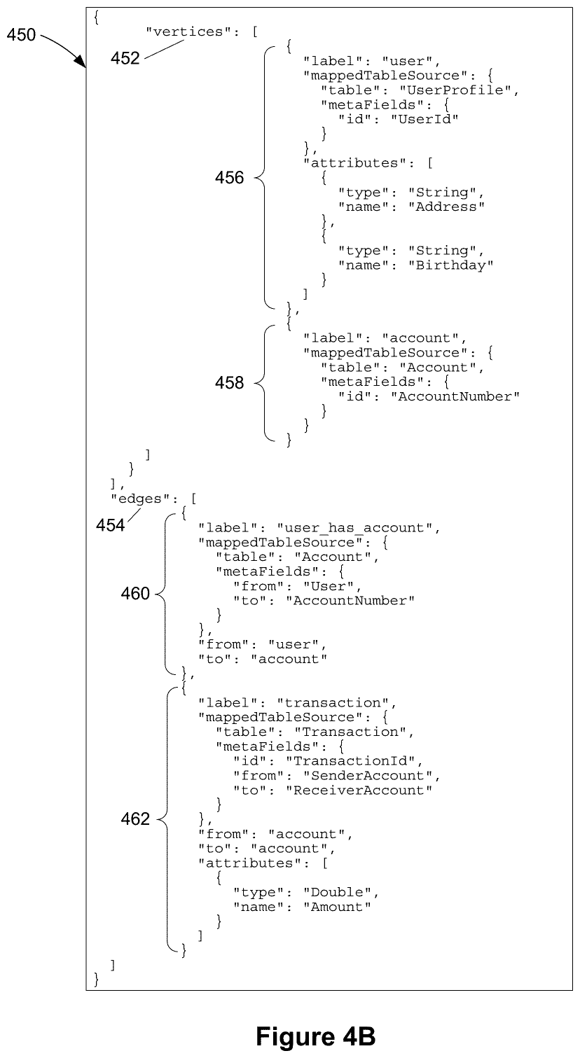

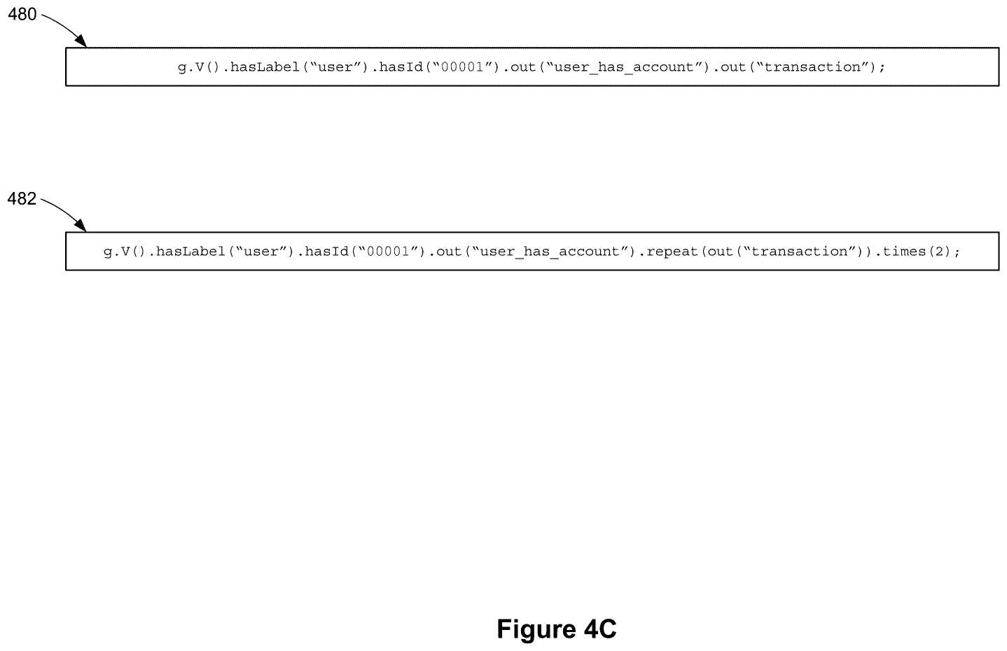

FIG. 3 illustrates an example graph query process 300 based on an example graph analytics engine 302, in accordance with some embodiments. The example graph analytics engine 302 is an example of the graph analytics engine 220. The example graph analytics engine 302 includes an auxiliary component 303, a logical data plan 304, a physical data plan 306, and one or more execution nodes 308. In the example graph query process 300, a user first creates a graph query and then traverses one or more to-be-queried databases 312 using the graph query through the graph analytics engine 302. Specifically, the user starts from creating the graph query on a platform 310 (e.g., software, network, user interface, or open-source project). The graph query defines a graph relationship between target entities within the one or more to-be-queried databases 312. The user can choose to create the graph query using an open-source project that is written in a graph query language. For instance, the user creates the graph query on a client portal of Apache Gremlin 314-1 and submit the graph query to a server portal of Apache Gremlin 316-1. In another instance, the user generates the graph query on a client portal of openCypher 314-2 and transfer the graph query to a server portal of openCypher 316-2. After the graph query is created, the user imports the graph query from the platform 310 to the example graph analytics engine 302. Next, the example graph analytics engine 302 is configured to map the graph query to the logical data plan 304 in accordance with a defined hierarchy of the target entities being stored in the auxiliary component 303 (described with more details below in reference to FIGS. 4A-4C). The example graph analytics engine 302 is further configured to translate the logical data plan 304 to the physical data plan 306. Then, the example graph analytics engine 302 is further configured to query, based on the physical data plan 306, the one or more to-be-queried databases 312 through the one or more execution nodes 308 for obtaining output graph entries. Each output graph entry includes data items that match the graph relationship defined by the graph query.

Additionally, as shown in FIG. 3, each execution node of the one or more execution nodes 308 is associated with a respective to-be-queried database of the one or more to-be-queried databases 312. The example graph analytics engine 302 includes five execution nodes (e.g., 308-1, 308-2, 308-3, 308-4, and 308-5), which are associated with five to-be-queried databases Apache Hive 312-1, Apache Iceberg 312-2, Apache Hudi 312-3, Delta Lake 312-4, and MySQL/Postgre SQL 312-5, respectively.

In some embodiments, a graph query process based on the graph analytics engine supports data sources distributed across cloud platforms and regional networks.

In some embodiments, the graph analytics engine includes an auxiliary component for a data query (e.g., a non-graph query and/or a graph query). The auxiliary component includes vertices and edges that are associated with a to-be-queried database, where each edge links two vertices. For instance, as shown in FIG. 3, the example graph analytics engine 302 includes the auxiliary component 303.

In some embodiments, traversing a to-be-queried database using a query through the graph analytics engine includes mapping the query into a logical data plan in accordance with an auxiliary component. Traversing the to-be-queried database using the query through the graph analytics engine includes translating the logical data plan to a physical data plan. Traversing the to-be-queried database using the query through the graph analytics engine further includes querying, based on the physical data plan, the to-be-queried database through an execution node. For instance, as shown in FIG. 3, the example graph analytics engine 302 is configured to receive the graph query from the platform 310 and map the graph query into the logical data plan 304 in accordance with the defined hierarchy of the target entities being stored in the auxiliary component 303. In an example, the defined hierarchy of the target entities reflects the graph relationship of the target entities. Next, the example graph analytics engine 302 is further configured to translate the logical data plan 304 to the physical data plan 306. Then, the example graph analytics engine 302 is configured to query, based on the physical data plan 306, the one or more to-be-queried databases 312 through execution nodes 308. Lastly, the example graph analytics engine 302 is configured to obtain output graph entries and generate a graph-based representation of the output entries, e.g., visualization using a network diagram.

In some embodiments, a logical data plan is a high-level structured representation of a data query (e.g., a non-graph query or a graph query). The logical data plan can be implemented based on a structural framework, e.g., tree architectures.

In some embodiments, a physical data plan is a low-level structured representation of a data query (e.g., a non-graph query or a graph query). The physical data plan defines physical storage structures (e.g., access methods and indexing) for data models and queries.

In some embodiments, the graph analytics engine includes a plurality of execution nodes, and each execution node is associated with a respective to-be-queried database. For instance, as shown in FIG. 3, the example graph analytics engine 302 includes five execution nodes (e.g., 308-1, 308-2, 308-3, 308-4, and 308-5). The execution nodes 308-1 to 308-5 are associated with the to-be-queried databases Apache Hive 312-1, Apache Iceberg 312-2, Apache Hudi 312-3, Delta Lake 312-4, and MySQL/Postgre SQL 312-5, respectively.

In some embodiments, the graph analytics engine includes a plurality of execution nodes, and one or more respective execution nodes of the plurality of execution nodes are associated with a respective to-be-queried database. For instance, the graph analytics engine can include two execution nodes that are associated with a respective to-be-queried data lake. As a result, the graph analytics engine can traverse the respective to-be-queried data lake through either one of the two execution nodes or through the two execution nodes simultaneously. Offering multiple execution nodes for one respective to-be-queried database bring several advantages, including parallel processing, scalability, and cost efficiency.

In some embodiments, a data query is written in a graph query language. For instance, as shown in FIG. 3, the data query can be written in Gremlin or openCypher. In some embodiments, the data query is written in a non-graph query language. For instance, as shown in FIG. 1, the data query can be written in SQL. Specifically, the graph analytics engine is not confined to particular query languages and can support a wide range of query languages.

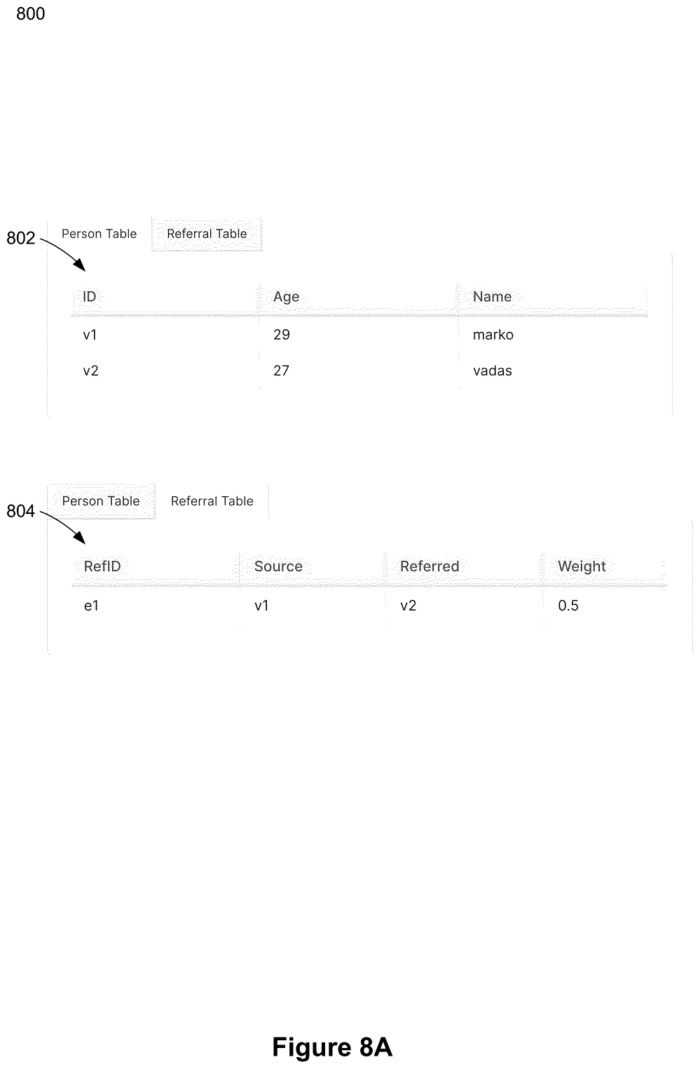

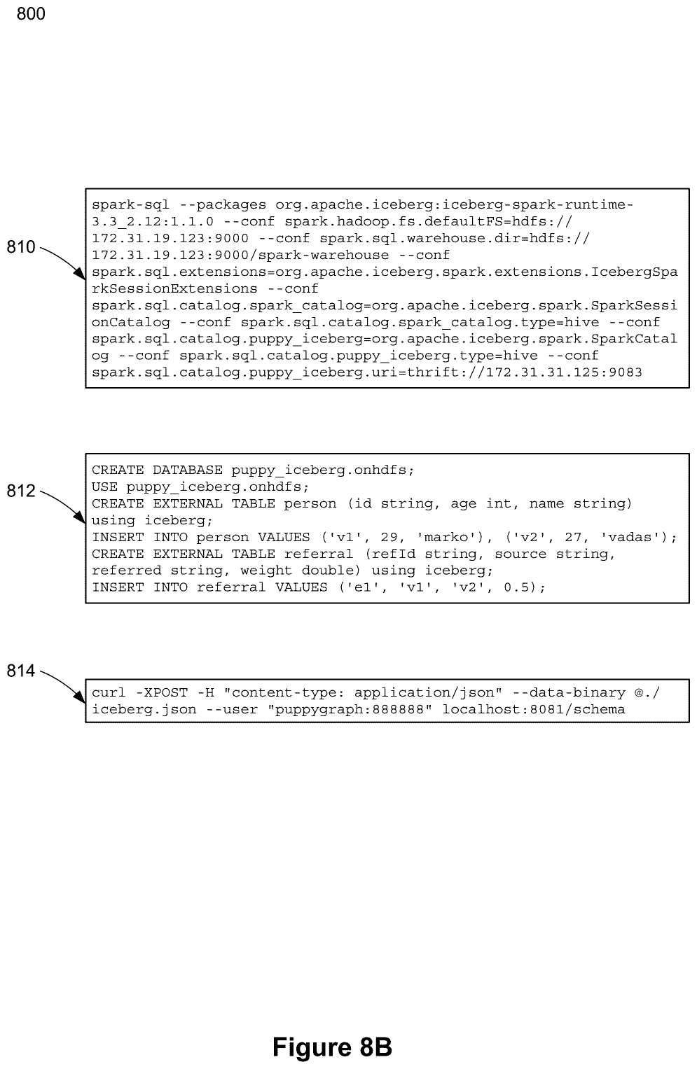

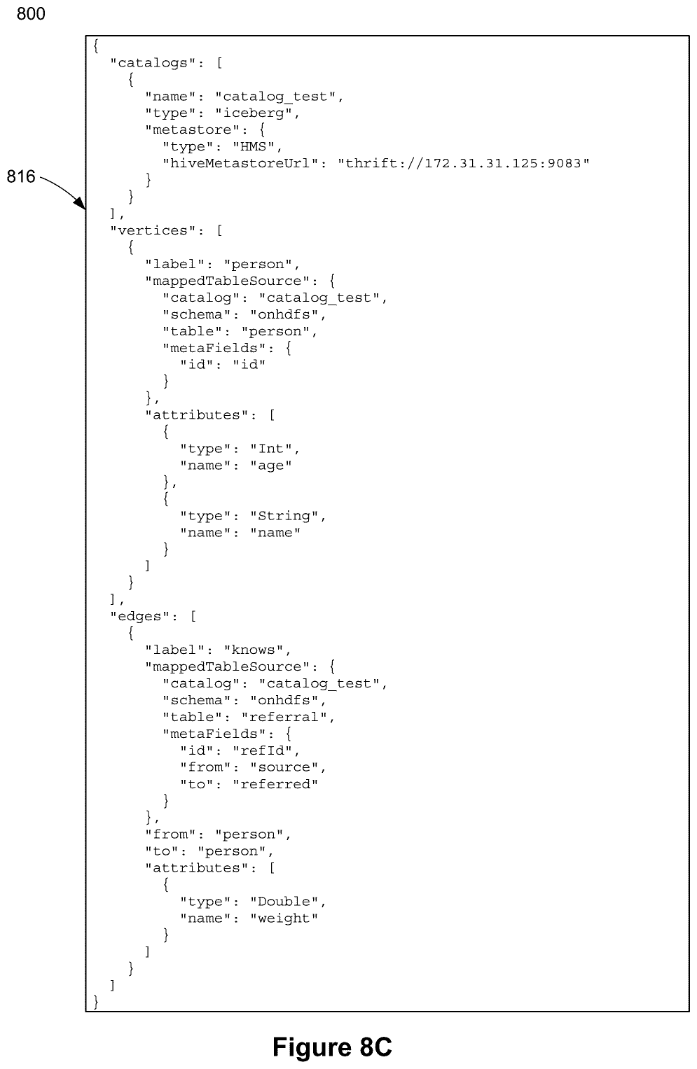

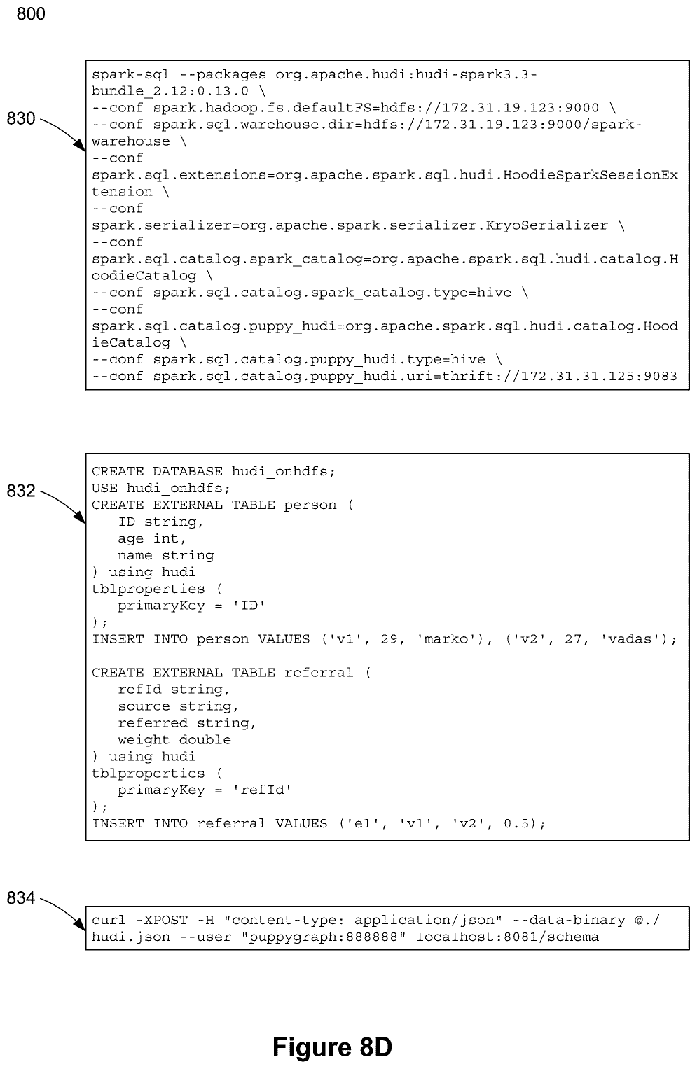

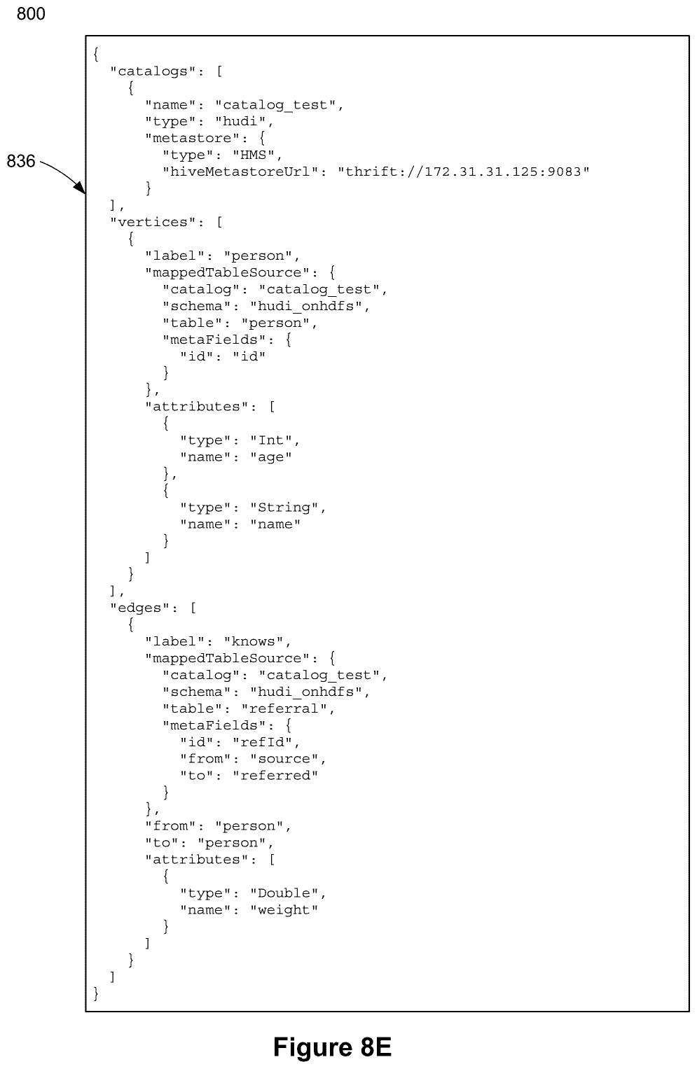

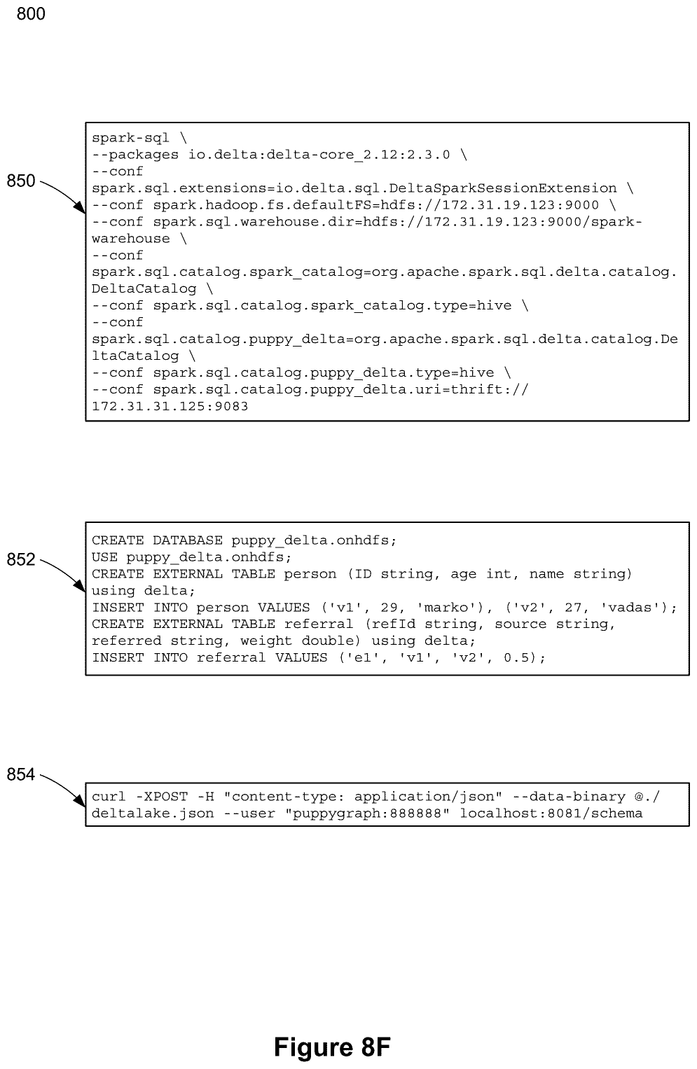

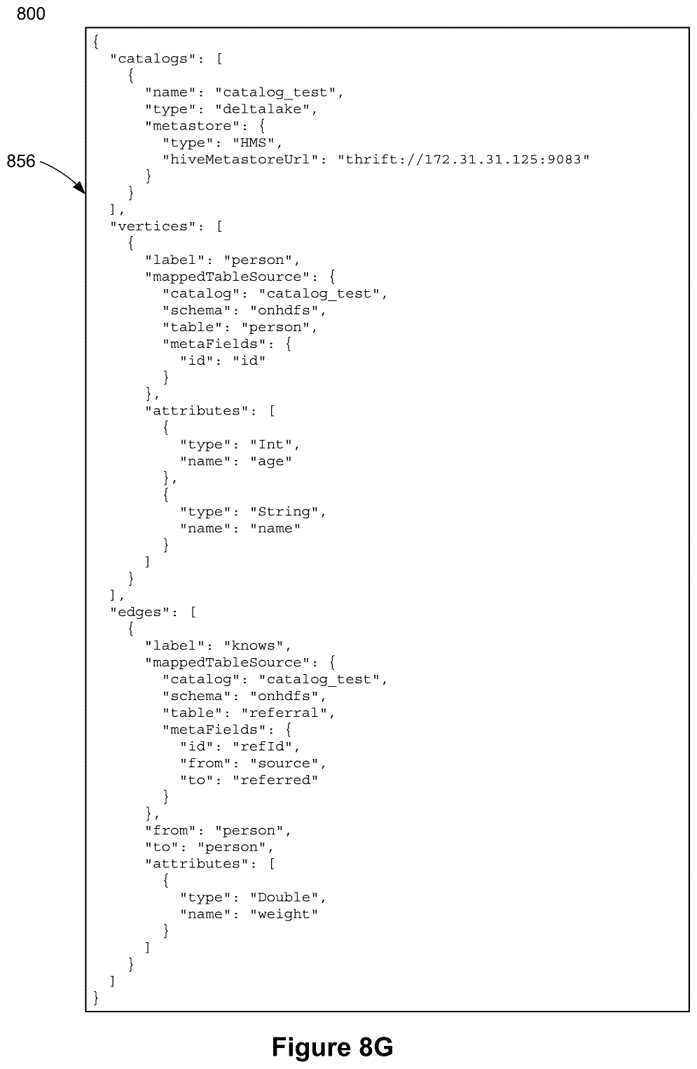

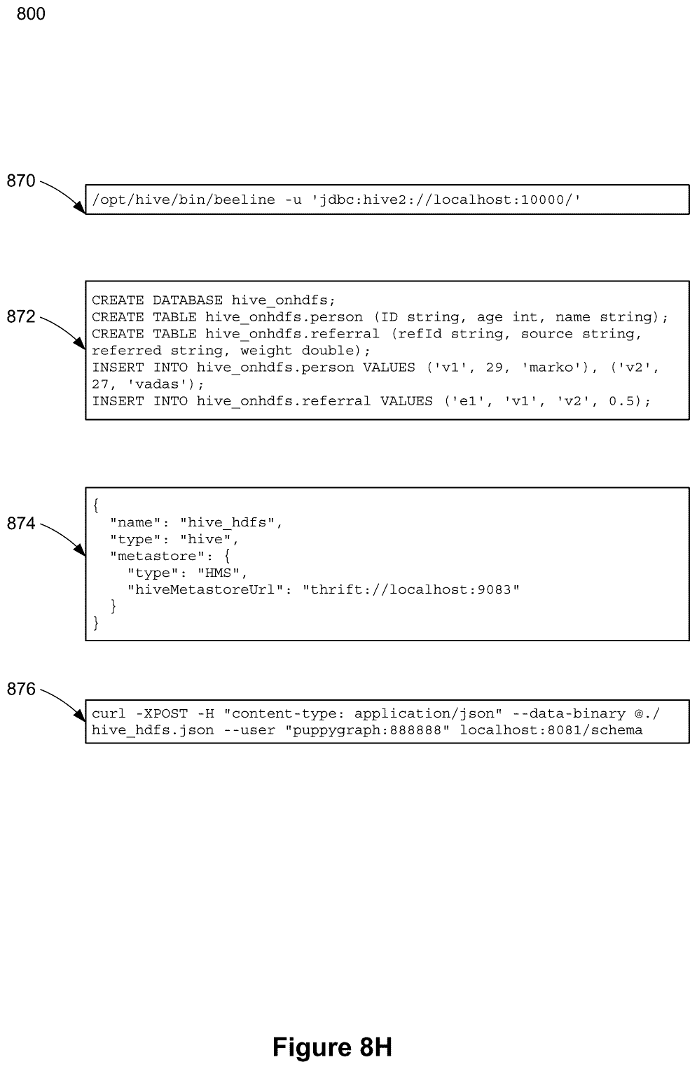

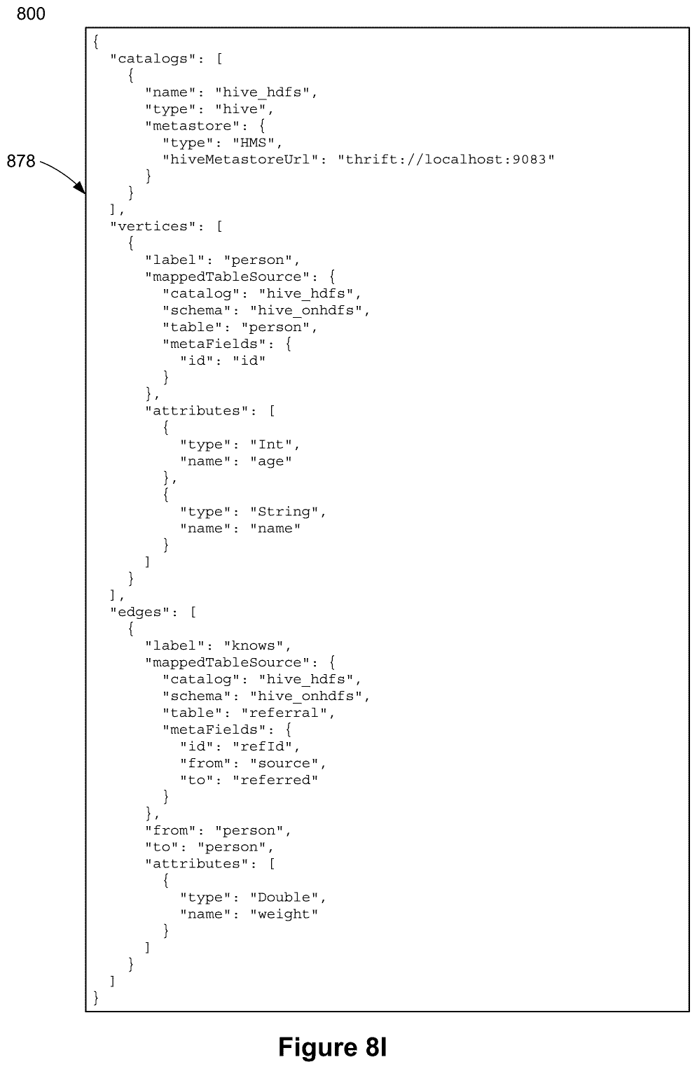

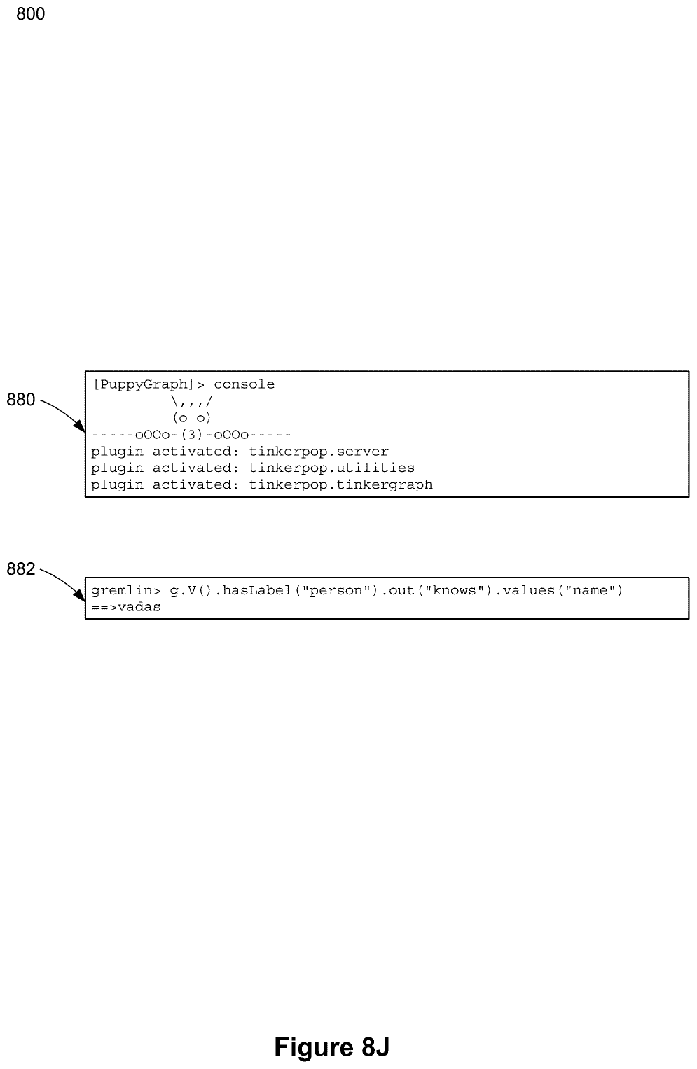

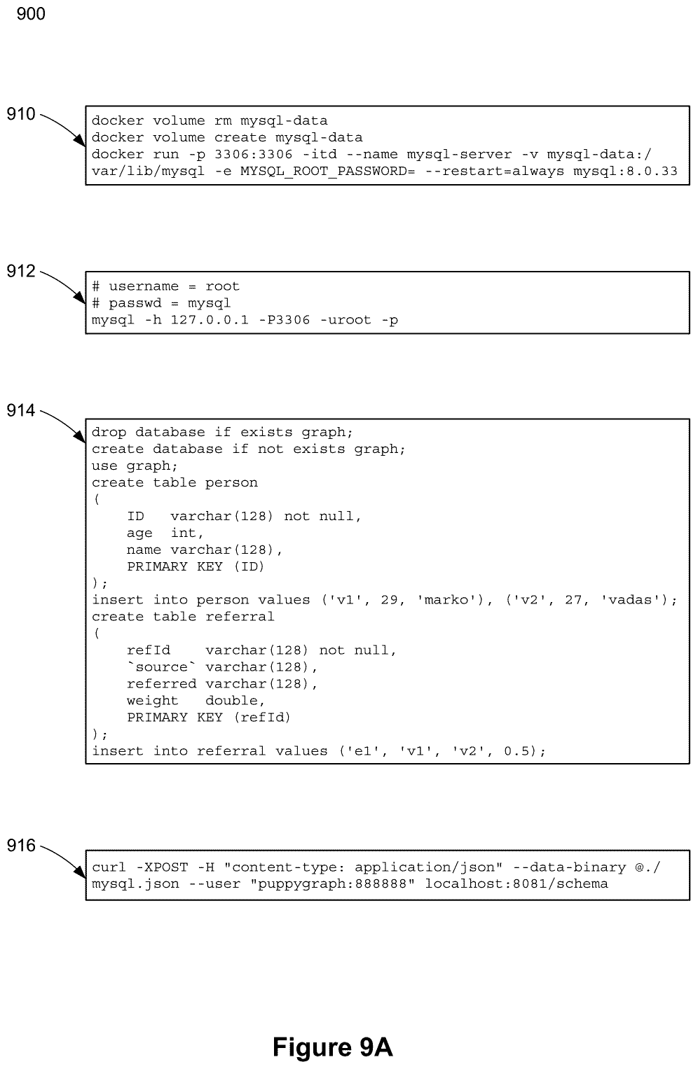

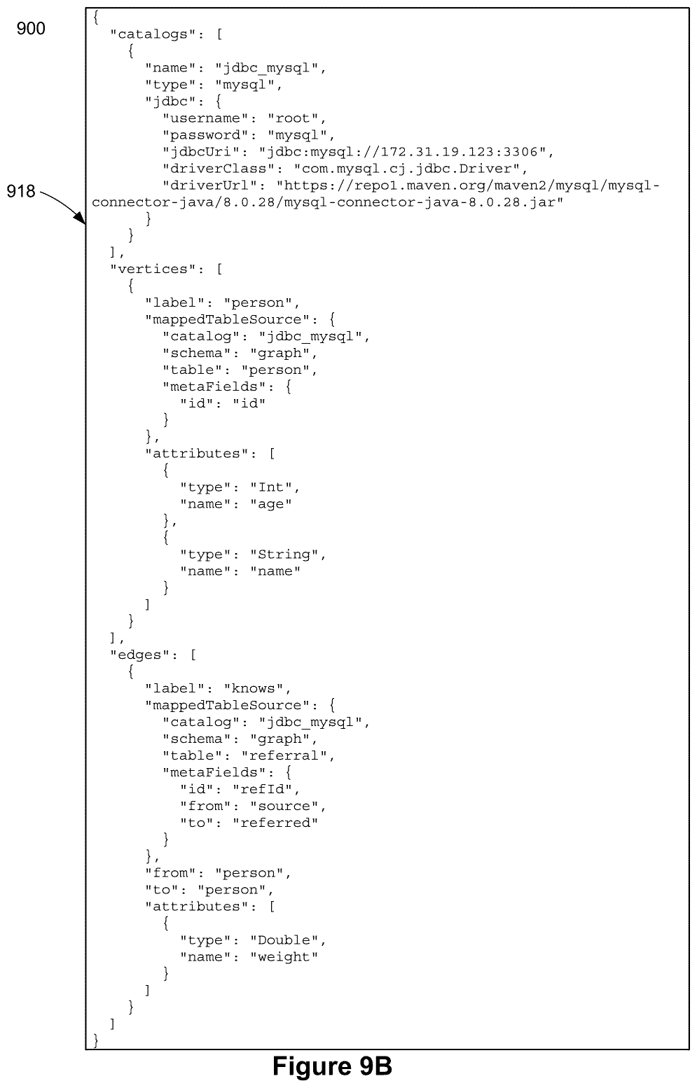

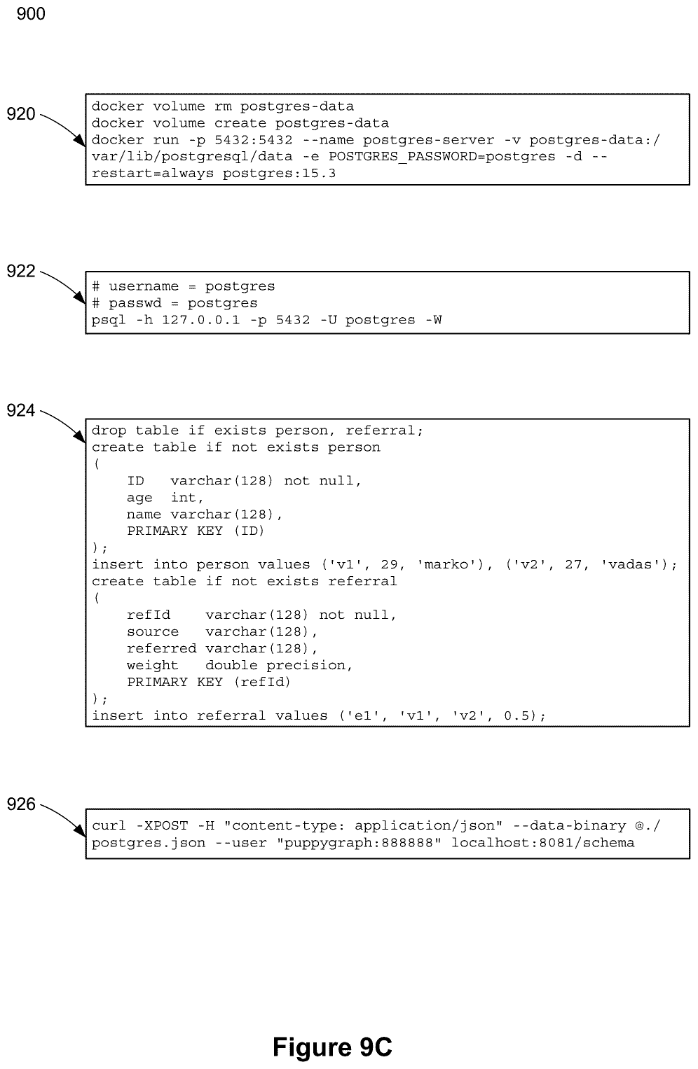

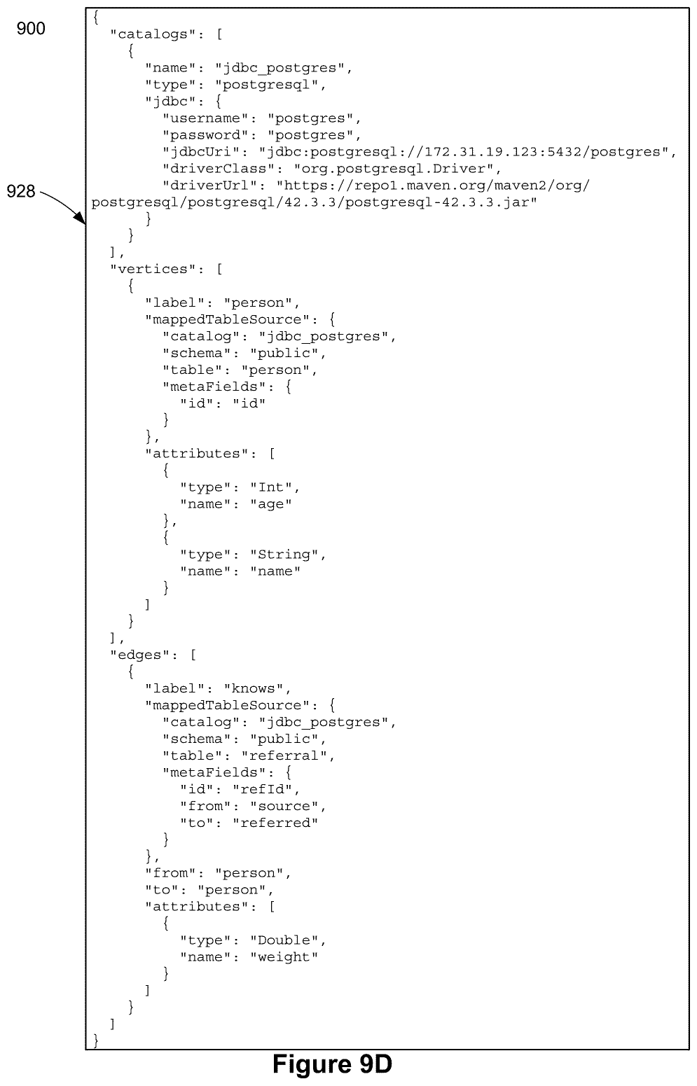

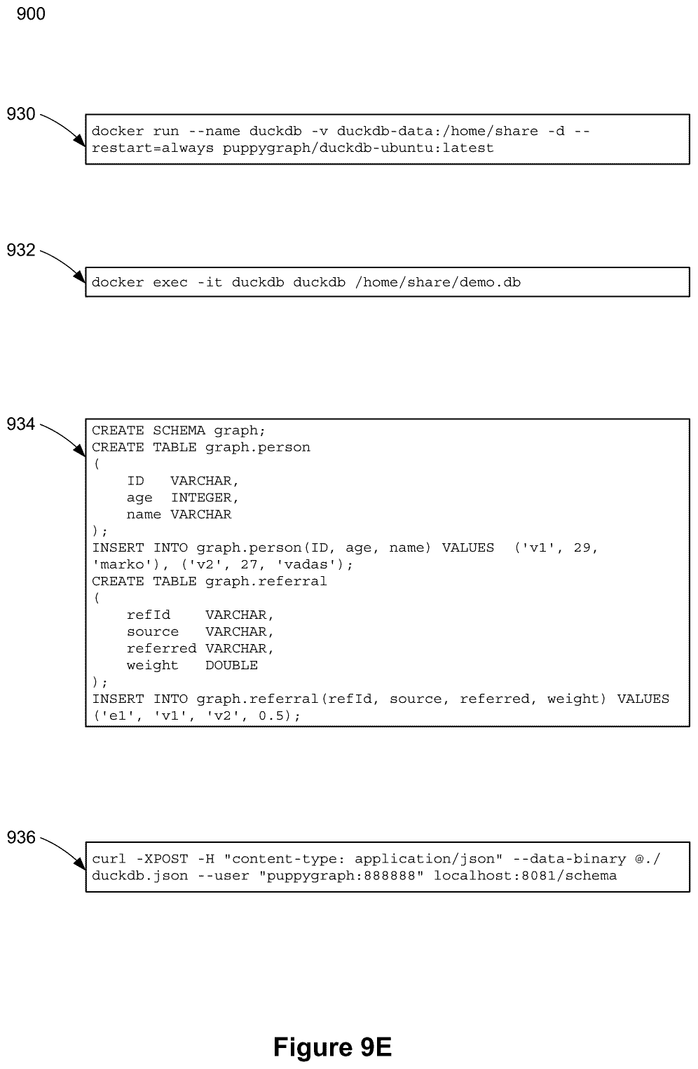

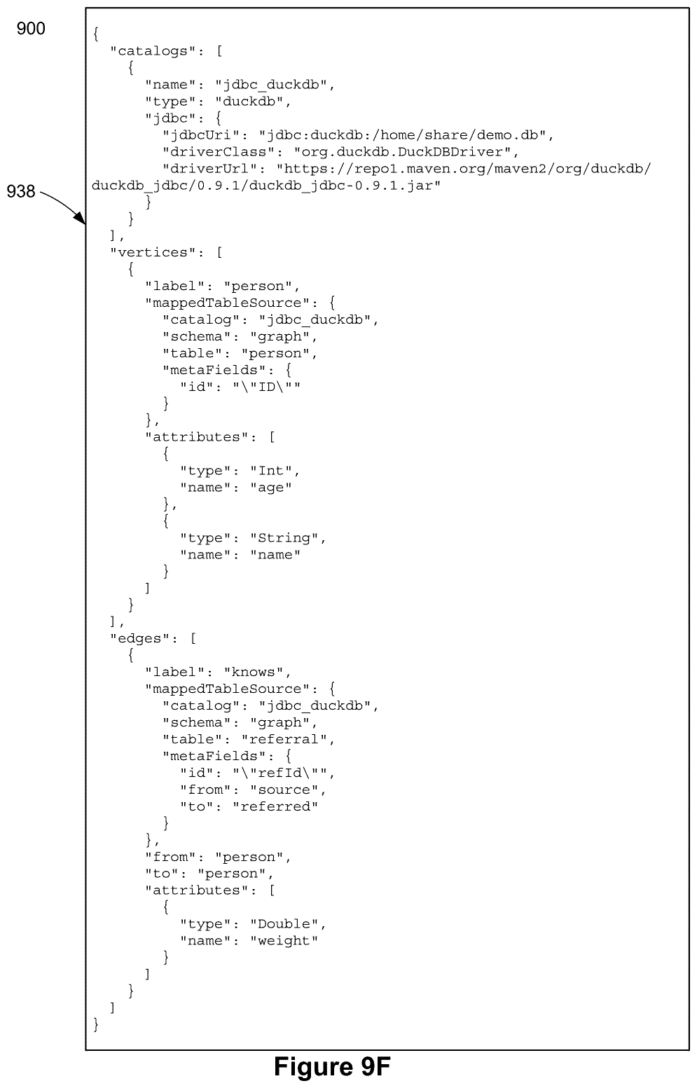

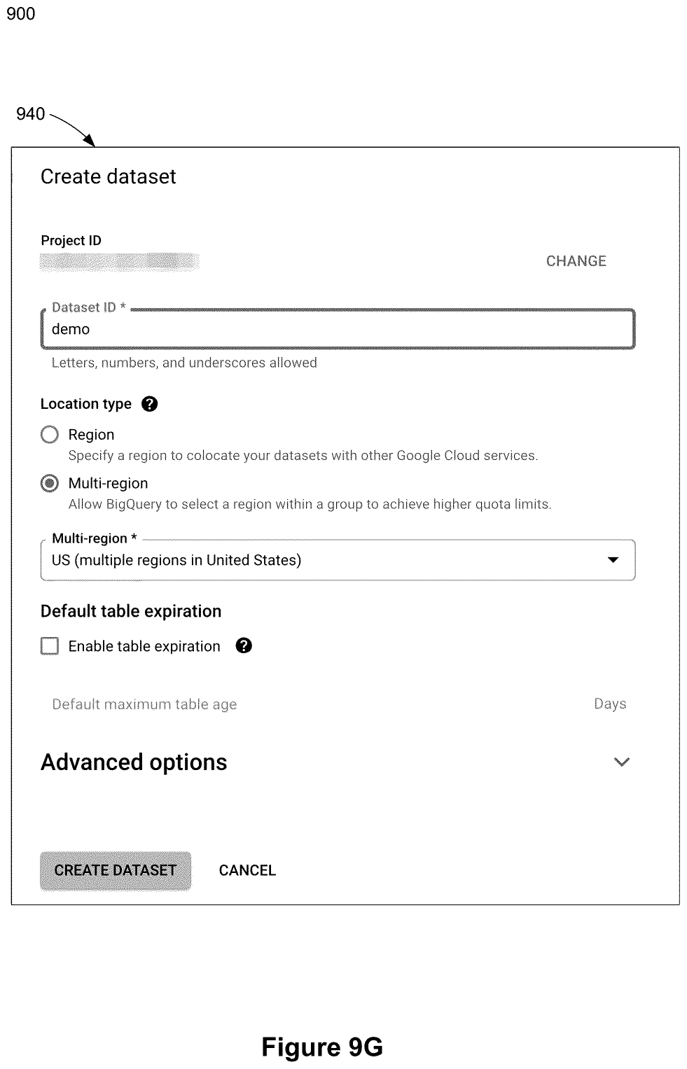

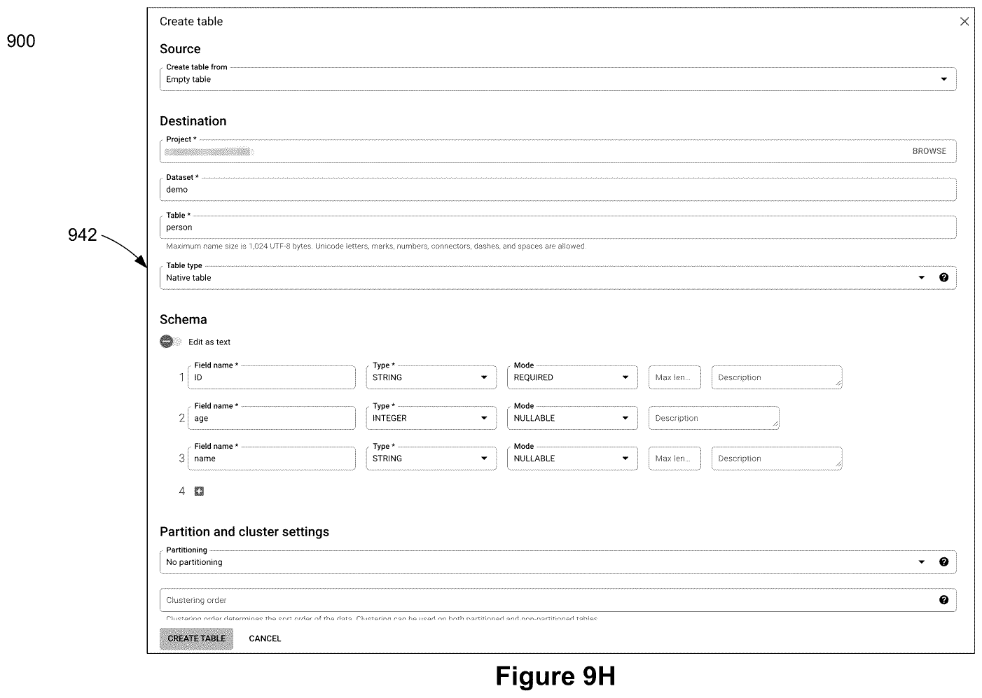

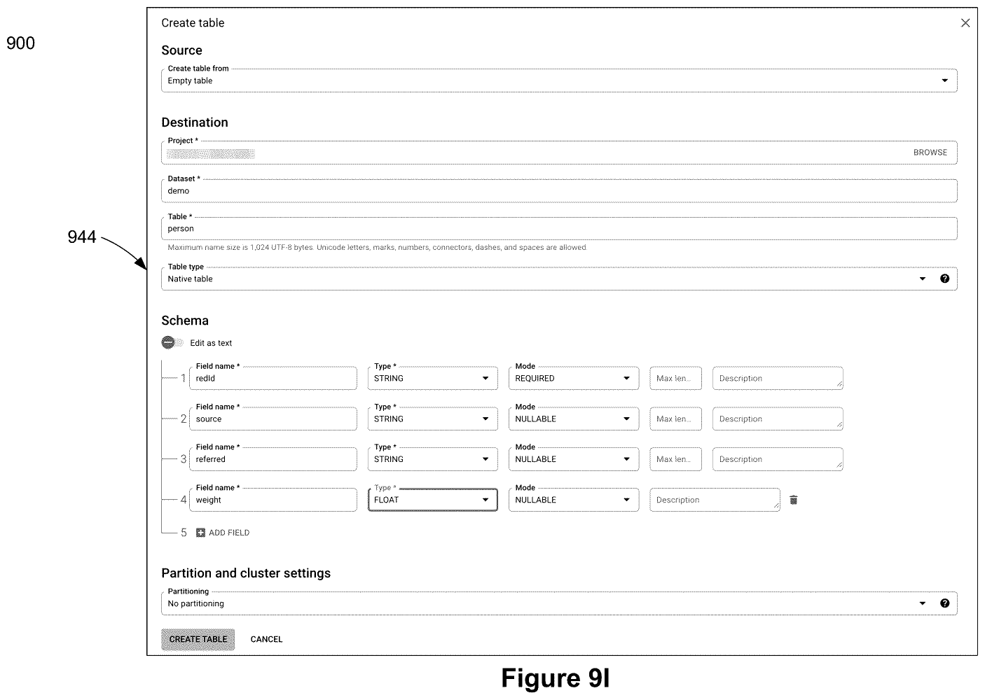

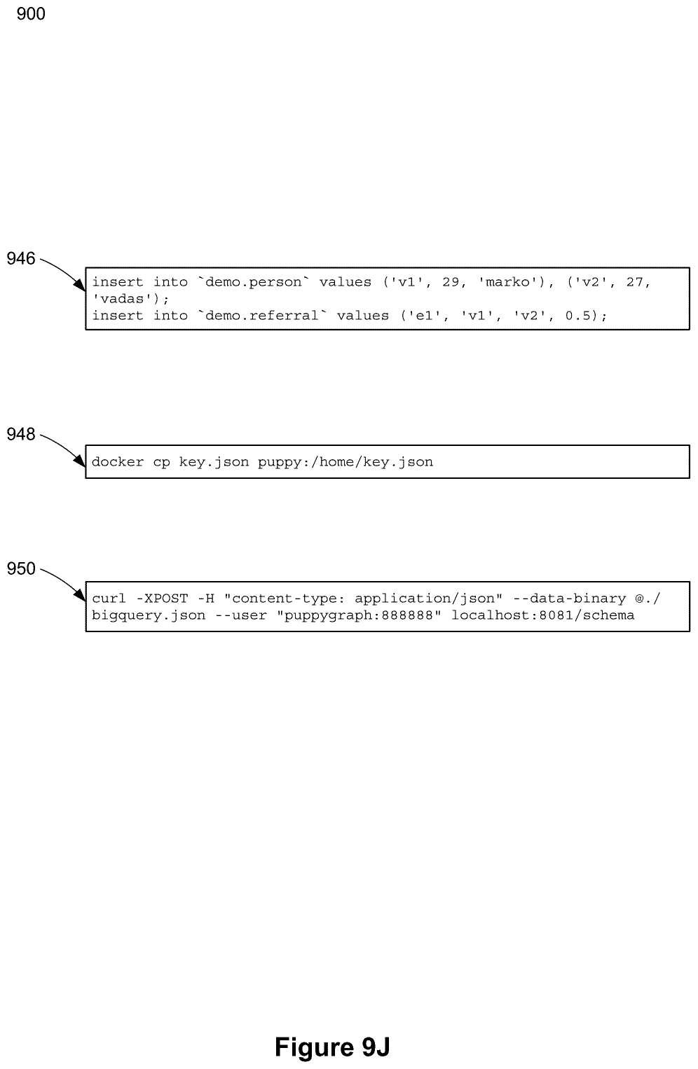

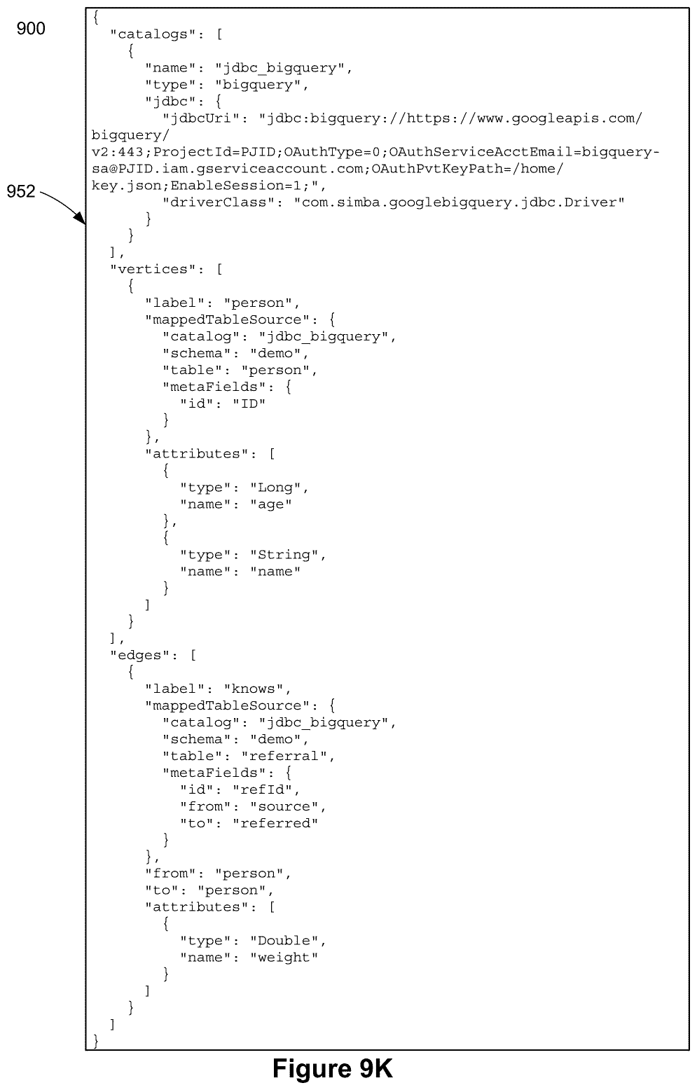

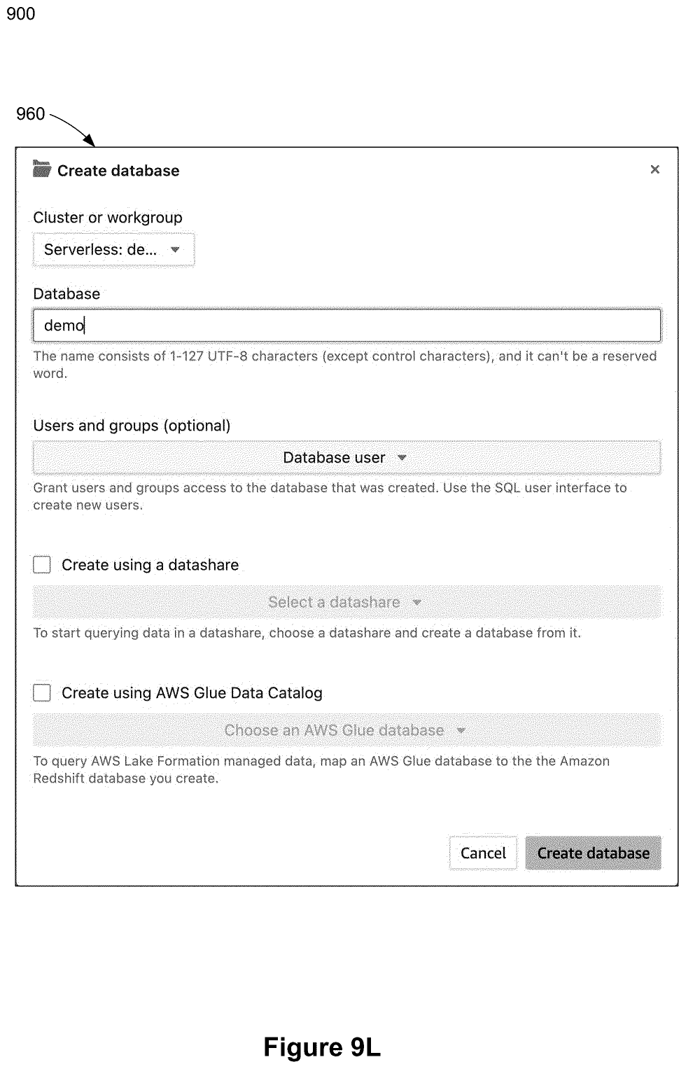

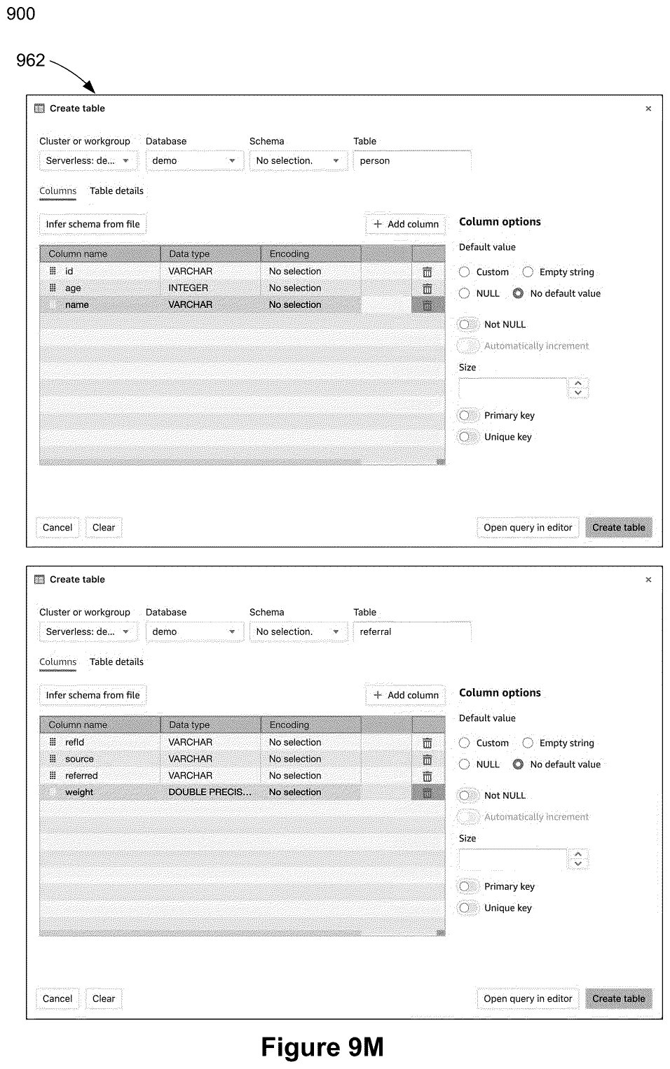

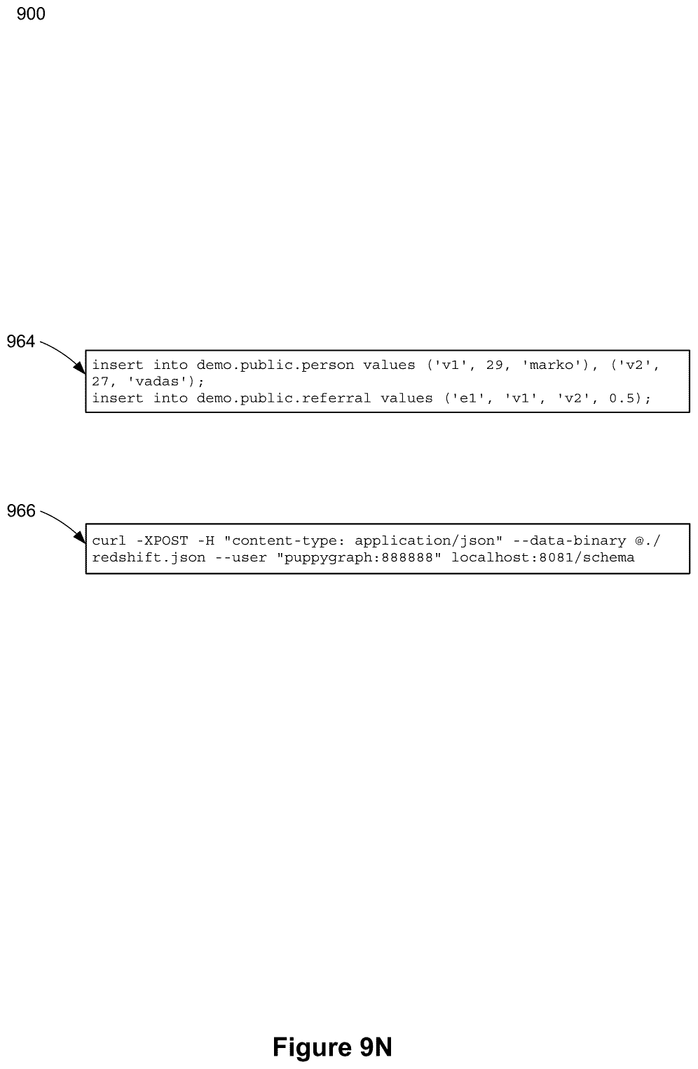

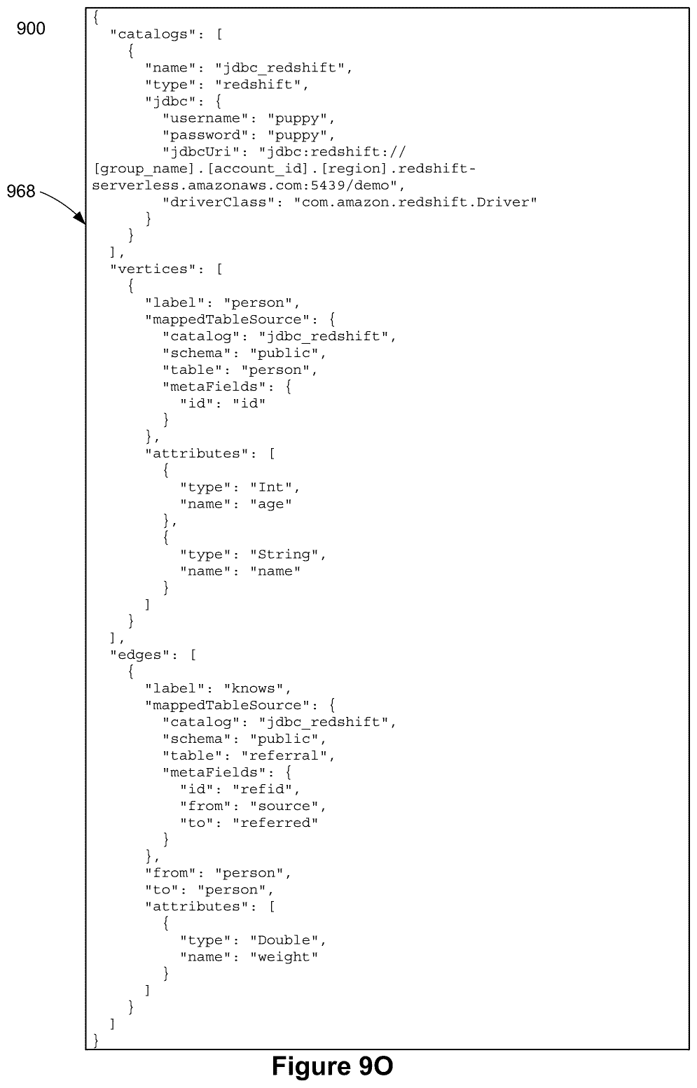

In some embodiments, a to-be-queried database is built in accordance with a data architecture that includes at least one of relational database, data warehouse, data lake, or other forms. For instance, as shown in FIG. 3, the one or more to-be-queried databases 312 include various kinds: Apache Hive 312-1, Apache Iceberg 312-2, Apache Hudi 312-3, Delta Lake 312-4, and MySQL/Postgre SQL 312-5. In another instance, the to-be-queried database is a relational database, e.g., MySQL, PostgreSQL, DuckDB, BigQuery, or Redshift (described below in reference to FIGS. 9A-9O). In yet another instance, the to-be-queried database is a data lake, e.g., Apache Iceberg, Apache Hudi, Delta Lake, or Apache Hive (described below in reference to FIGS. 8A-8J).

In some embodiments, a to-be-queried database defines a graph relationship between target entities in a tabular form. For instance, the to-be-queried database stores tabular forms that include the graph relationship of the target entities, e.g., person-knows-person (described below in reference to FIGS. 4A, 7B and 8A).

In some embodiments, a to-be-queried database is compatible with SQL. In particular, the to-be-queried database can be a SQL database. For instance, as shown in FIG. 3, Apache Hive 312-1 is compatible with SQL and MySQL/Postgre SQL 312-5 is a SQL database. The graph analytics engine 302 is configured to traverse Apache Hive 312-1 and MySQL/Postgre SQL 312-5 using the graph query created by the platform 310 through the execution nodes 308-1 and 308-5, respectively.

In some embodiments, a to-be-queried database includes a non-SQL (NoSQL) database.

Data Query with a JSON File

The graph analytics engine includes an auxiliary component for a query (e.g., a non-graph query and/or a graph query). The auxiliary component is a schema that defines a hierarchy of target entities. The hierarchy reflects a graph relationship of the target entities within a to-be-queried database. In particular, the auxiliary component includes vertices and edges that are associated with the to-be-queried database. Each edge links two vertices. After receiving the query (e.g., a graph query), the graph analytics engine is configured to map the query to a logical data plan in accordance with the defined hierarchy of the target entities being stored in the auxiliary component (described above in reference to FIG. 3). In some embodiments, the graph query is received from a platform, e.g., software, network, user interface, open-source project (described above in reference to FIG. 3).

Specifically, to create the auxiliary component for querying a tabular to-be-queried database, a user first obtains table catalogs, table schemas, and table attributes, based on a graph relationship between target entities within the tabular to-be-queried database. Next, the user defines vertices and edges in form of arrays based on the table catalogs, table schemas, and table attributes, where each edge links two vertices. The vertices and edges reflect a hierarchy of the target entities within the tabular to-be-queried database, and include information of the table catalogs, table schemas, and table attributes. Then, the user generates the auxiliary component based on the vertices and edges in form of arrays.

FIGS. 4A-4C illustrate an example transaction trace graph query 400 based on the graph analytics engine for a to-be-queried tabular database 401, in accordance with some embodiments. The example transaction trace graph query 400 is to obtain whom a User 00001 transfers to through a one-hop route or a two-hop route. More details of graph analytics engine architectures are described above in references to FIGS. 1-3. When querying transaction traces, a user first generates a JavaScript Object Notation (JSON) file 450 in accordance with graph relationships between target entities within the to-be-queried tabular database 401. Next, the user creates a graph query script (e.g., graph query statements) written in a graph query language. Then, the user queries the to-be-queried tabular database 401 using the JSON file 450 and the graph query script via the graph analytics engine.

FIG. 4A illustrates the to-be-queried tabular database 401 for transactions traces. The to-be-queried tabular database 401 includes three catalogs: a UserProfile catalog 402, an Account catalog 404, and a Transaction catalog 406. Specifically, the UserProfile catalog 402 includes (i) three records corresponding to three users (e.g., Users 00001, 00002, and 00003), and (ii) eight attributes (e.g., UserId, FirstName, LastName, Address, ZipCode, Gender, PhoneNumber, and Birthday). The Account catalog 404 includes (i) six records corresponding to six accounts (e.g., Accounts 0000001, 0000002, 0000003, 0000004, 0000005, and 0000006), and (ii) six attributes (e.g., AccountNumber, Balance, CreatedDate, User, BranchName, and AccountAgent). The Transaction catalog 406 includes (i) five records corresponding to five transactions (e.g., Transactions 0000000001, 0000000002, 0000000003, 0000000004, 0000000005), and (ii) six attributes (e.g., TransactionId, SenderAccount, ReceiverAccount, TransactionTimestamp, and Amount). The three catalogs 402, 404, and 406 are stored in a tabular format.

FIG. 4B illustrates the JSON file 450 associated with the to-be-queried tabular database 401 for transactions traces. The JSON file 450 for transaction traces defines a hierarchy of the target entities. As discussed, the example transaction trace graph query 400 is to obtain whom a User 00001 transfers to through a one-hop route or a two-hop route. As a result, the target entities of the example transaction trace graph query 400 can include several attributes of the UserProfile catalog 402 (e.g., UserId, Address, and Birthday), several attributes of the Account catalog 404 (e.g., AccountNumber and User), and several attributes of the Transaction catalog 406 (e.g., TransactionId, SenderAccount ReceiverAccount, and Amount). In particular, the JSON file 450 includes a “vertices” array 452 that defines vertices and a “edges” array 454 that defines edges. The “vertices” array 452 includes an “user” object 456 and an “account” object 458. The “user” object 456 further includes respective attributes (e.g., “User Id,” “Address,” “Birthday,” and “User”) listed in the catalogs 402, 404, and 406. Similarly, the “account” object 458 further includes respective attributes (e.g., “AccountNumber”) listed in the catalogs 402, 404, and 406. On the other hand, the “edges” array 454 includes an “user_has_account” object 460 and an “transaction” object 462. The “user_has_account” object 460 further includes attributes (e.g., “User” and “AccountNumber”) listed in the catalogs 402, 404, and 406. Similarly, the “transaction” object 462 further includes attributes (e.g., “TransactionId,” “SenderAccount,” “ReceiverAccount,”, and “Amount”) listed in the catalogs 402, 404, and 406.

FIG. 4C illustrates example graph query statements 480 and 482 for transaction traces. A first example graph query statement 480 and a second example graph query statement 482 is to obtain whom a User 00001 transfers to through a one-hop route and a two-hop route, respectively.

In the first example graph query statement 480, a step of .hasLabel (“user”) obtains a first set of vertices with a label of “user” (e.g., the “user” object 456), and a step of .hasId (“00001”) further filters the first set of vertices to obtain a second set of vertices that includes a specified “UserId” of “00001.” Next, .out (“user_has_account”) traverses edges with a label of “user_has_account” (e.g., the “user_has_account” object 460) from the second set of vertices and reach a third set of vertices through the edges with the label of “user_has_account.” Then, a step of .out (“transaction”) continues to traverse edges with the label of “transaction” from the third set of vertices and reach a fourth set of vertices through the edges with the label of “transaction.”

The second example graph query statement 482 is similar to the first example graph query statement 480, except that the second example graph query statement 482 includes a step of .repeat and with .time(2). The step of .repeat repeats .out (“transaction”) twice by traversing one level deeper from the fourth set of vertices.

In some embodiments, traversing a to-be-queried database using a query through the graph analytics engine includes obtaining catalogs, schemas, and attributes, based on a graph relationship between target entities. Traversing the to-be-queried database using the query through the graph analytics engine includes defining a plurality of vertices and a plurality of edges in form of arrays, based on the catalogs, schemas, and attributes. Traversing the to-be-queried database using the query through the graph analytics engine further includes generating an auxiliary component, based on the plurality of vertices and the plurality of edges. For instance, as shown in FIGS. 4A-4B, the user obtains the table catalogs, table schemas, and table attributes from the to-be-queried tabular database 401 and define the vertices 452 and edges 454 in form of arrays. The user further generates the JSON file 450 based on the vertices 452 and edges 454.

In some embodiments, an auxiliary component is a human-readable file. For instance, as shown in FIG. 4B, the JSON file 450 is a human-readable file. Further, in some embodiments, the human-readable file is in a standard text-based format, including at least one of JavaScript Object Notation (JSON), Human-Optimized Config Object Notation (HOCON), Extensible Markup Language (XML), or other forms.

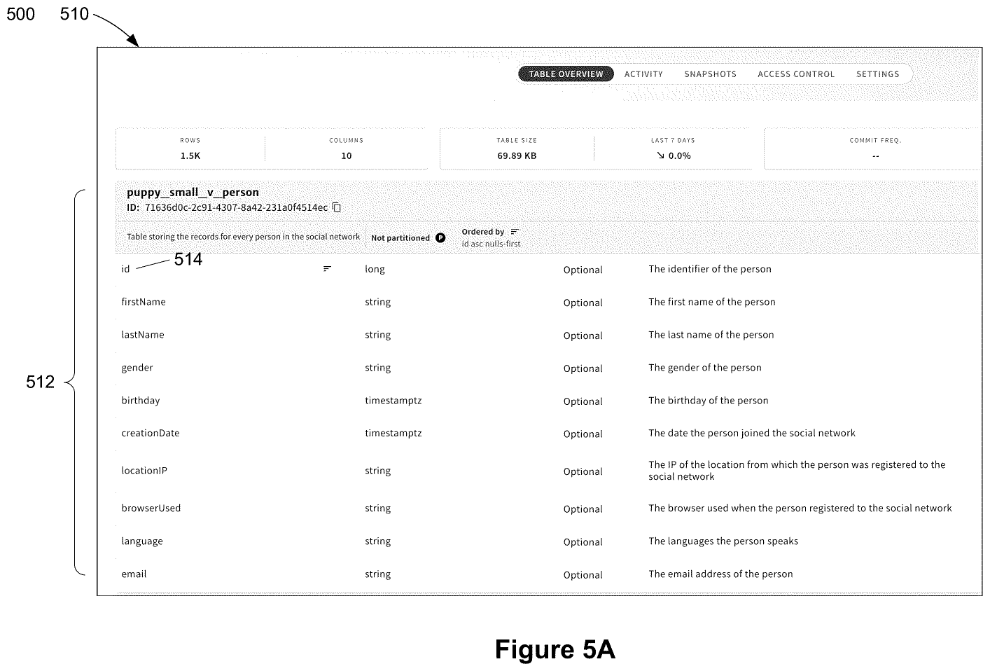

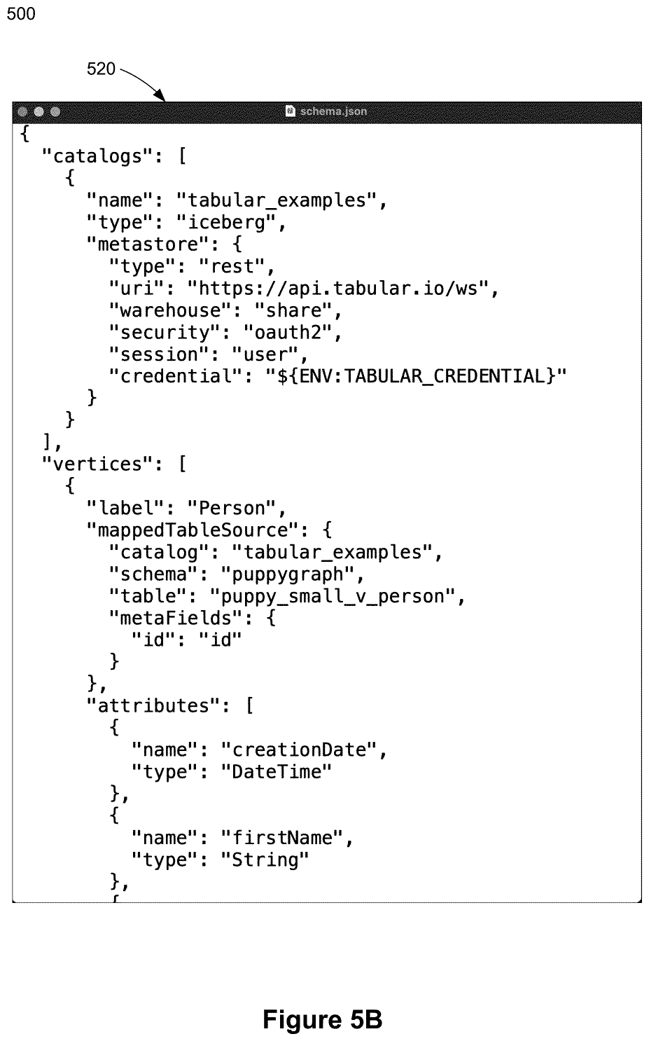

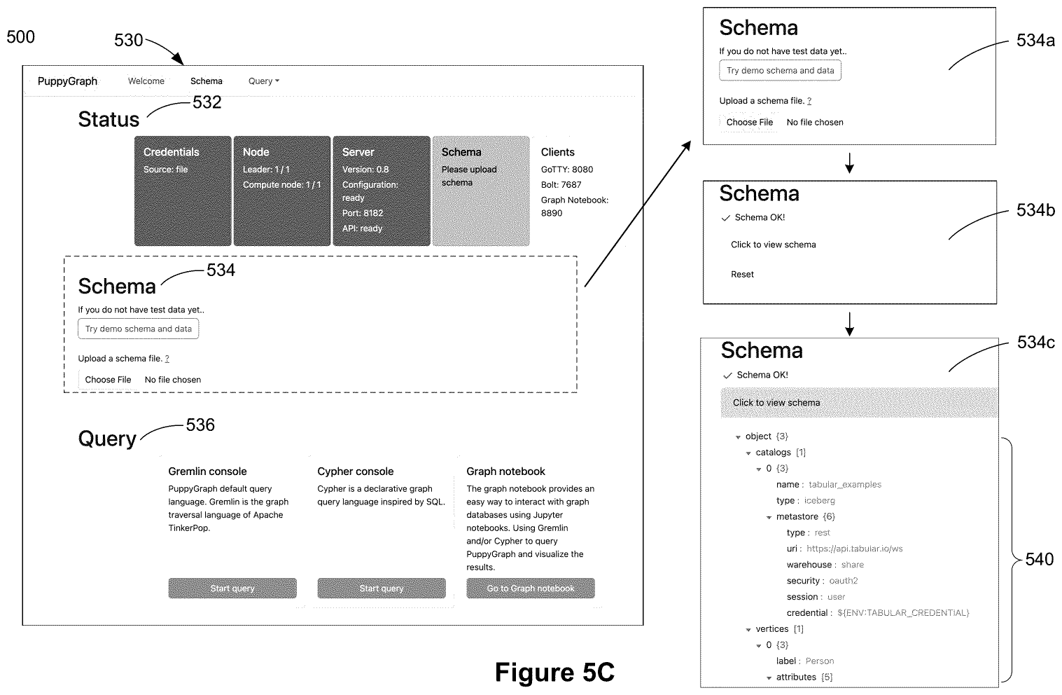

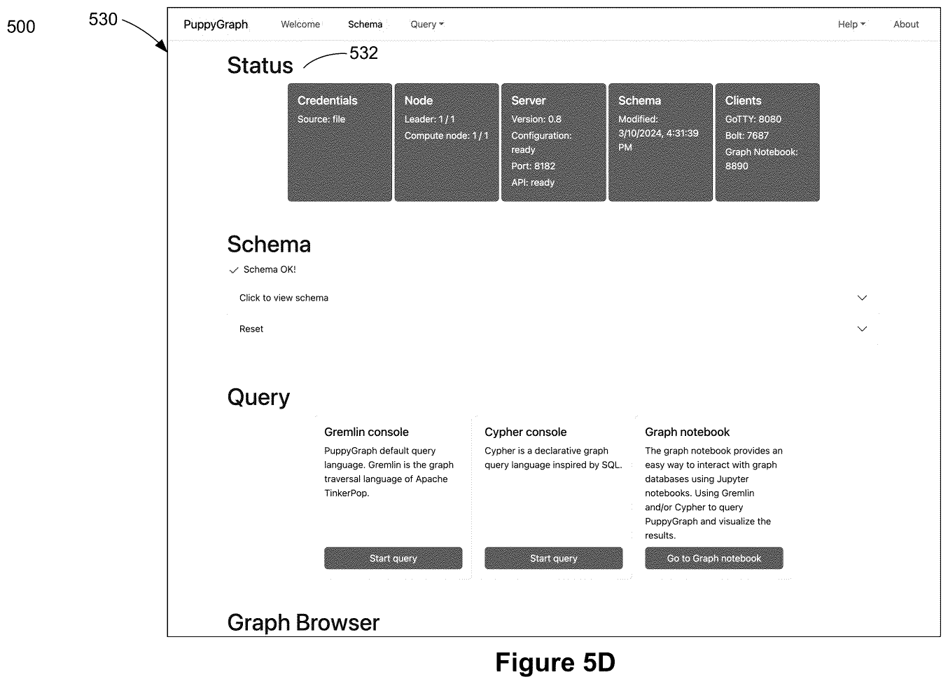

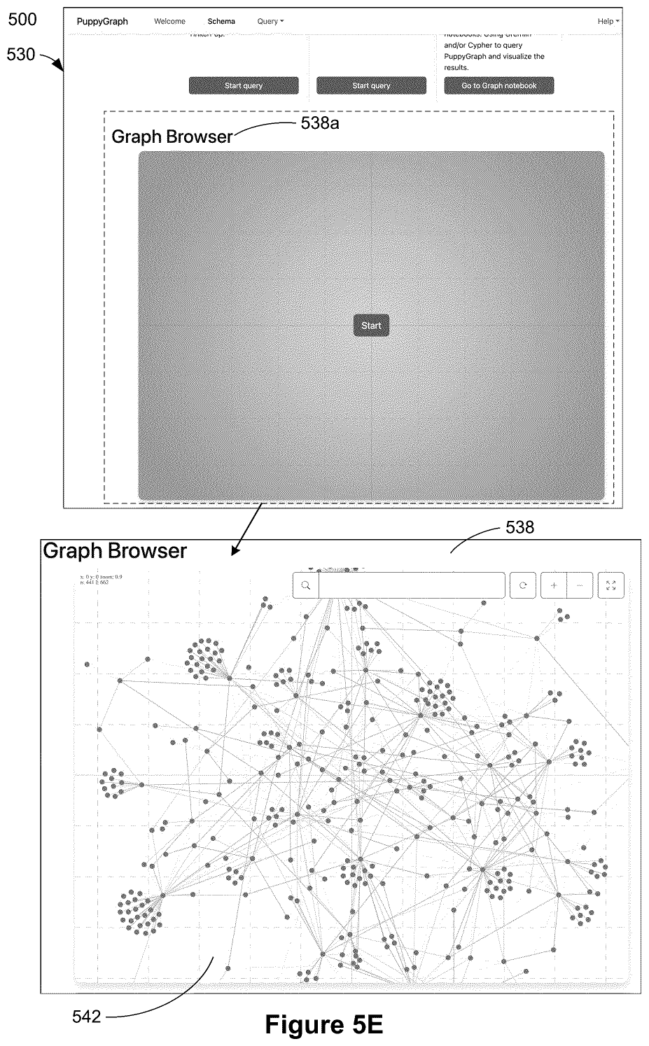

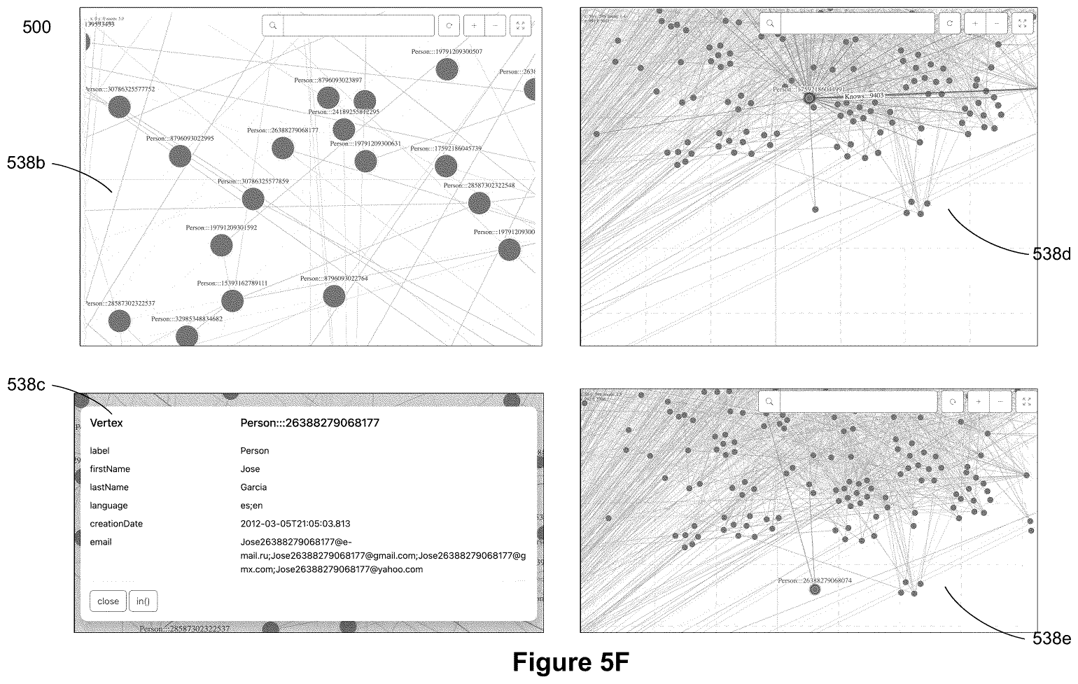

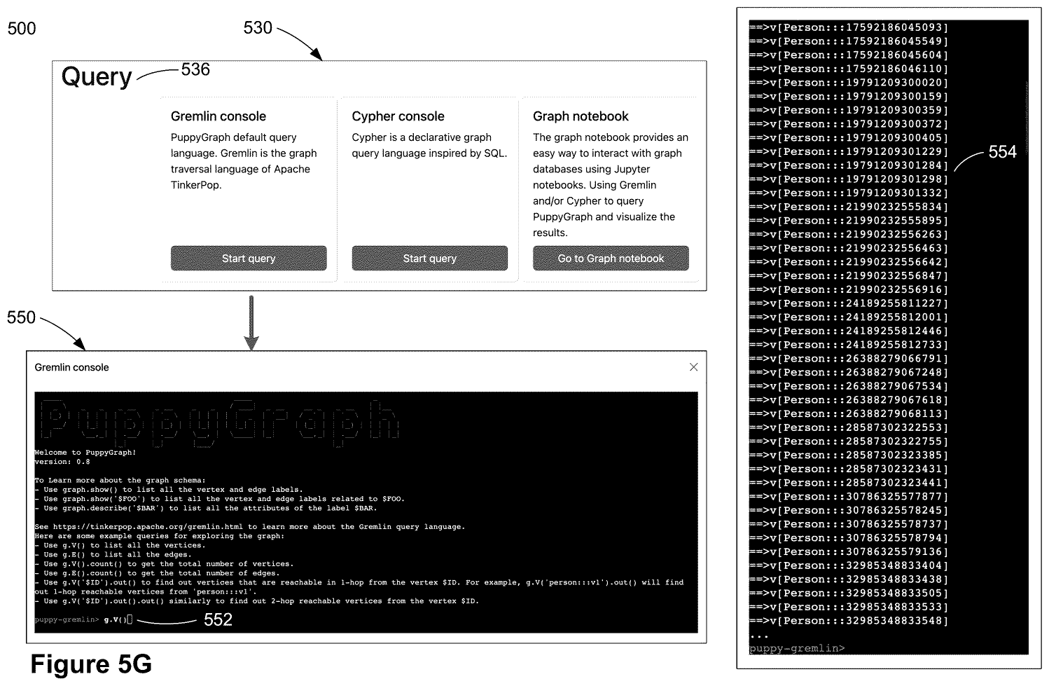

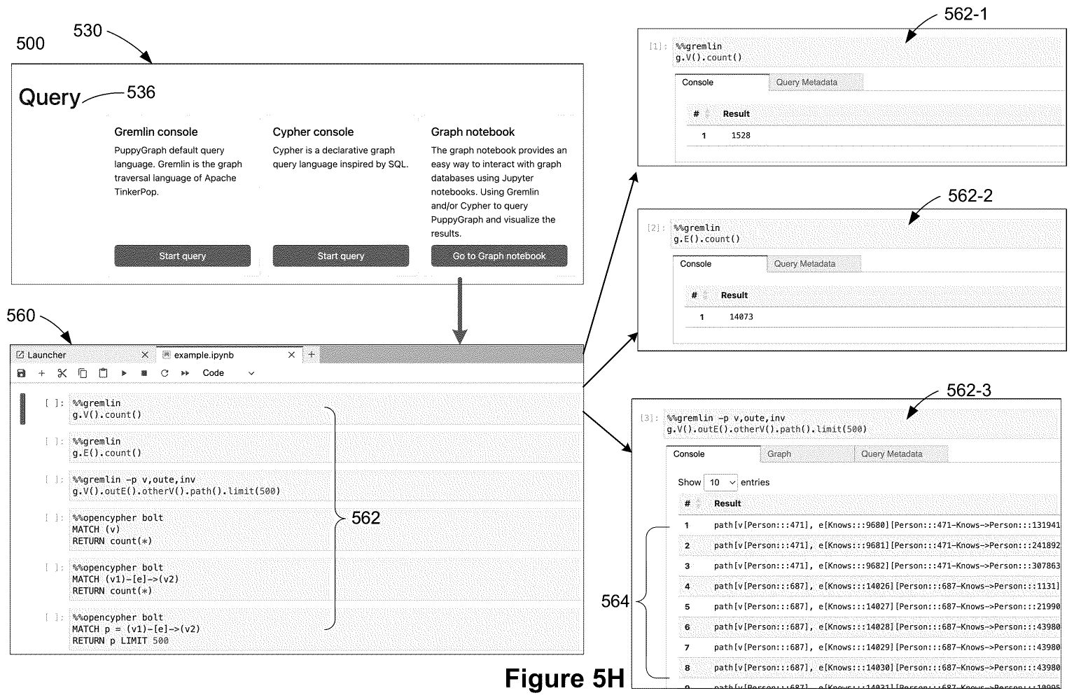

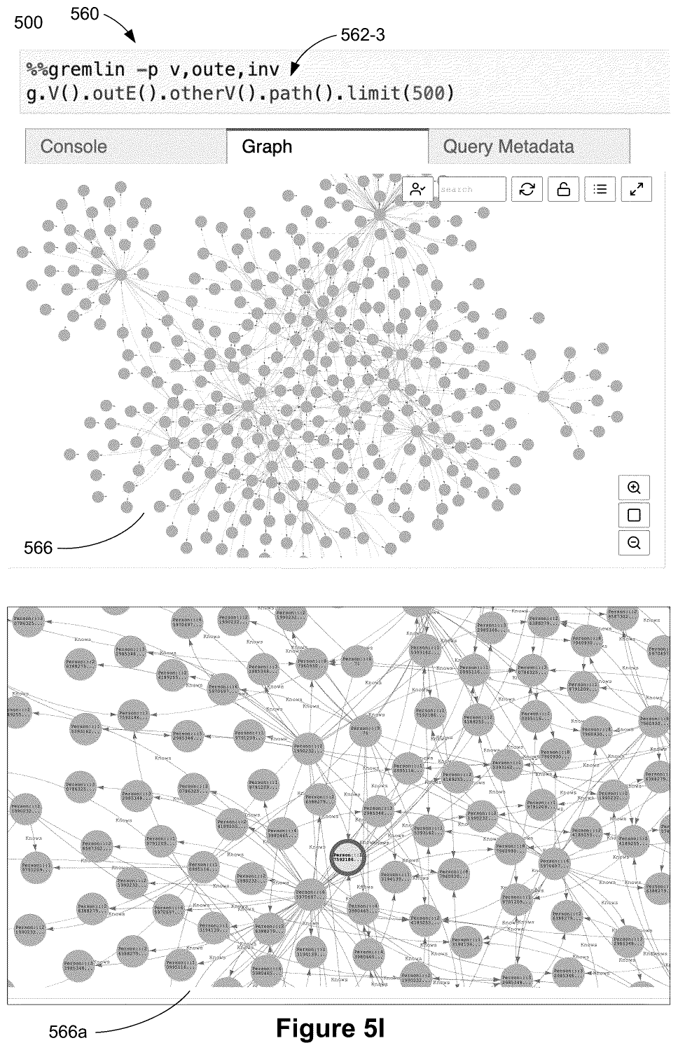

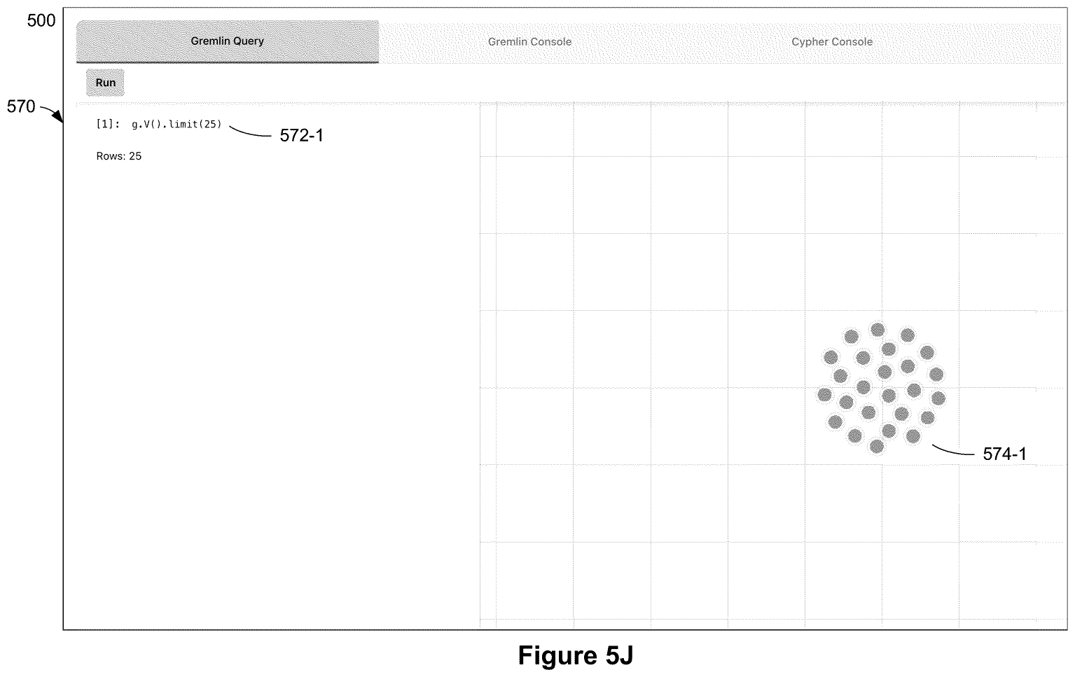

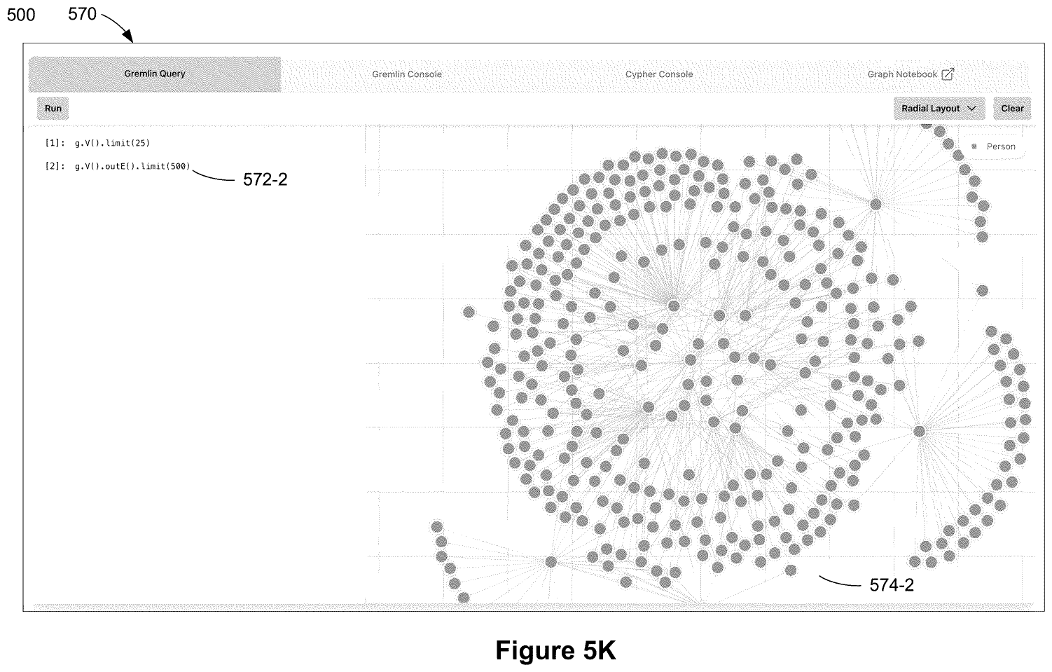

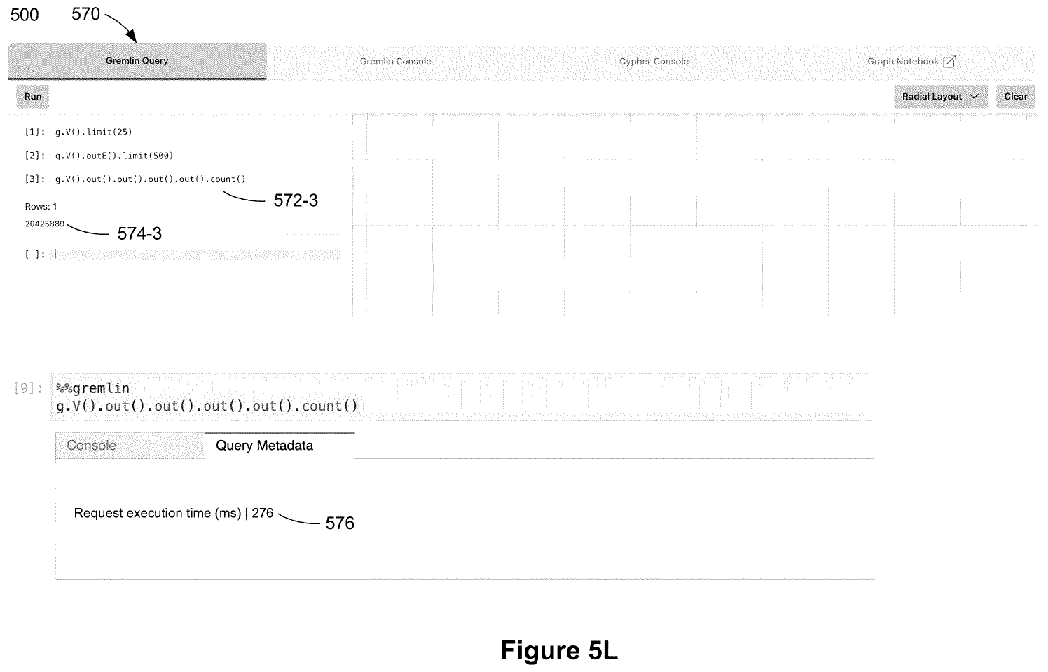

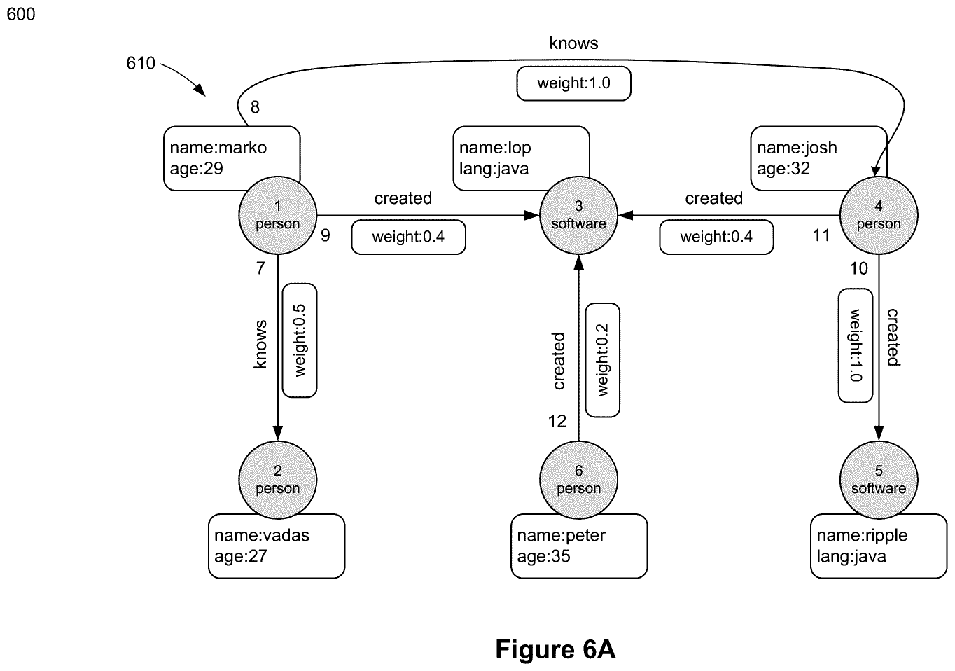

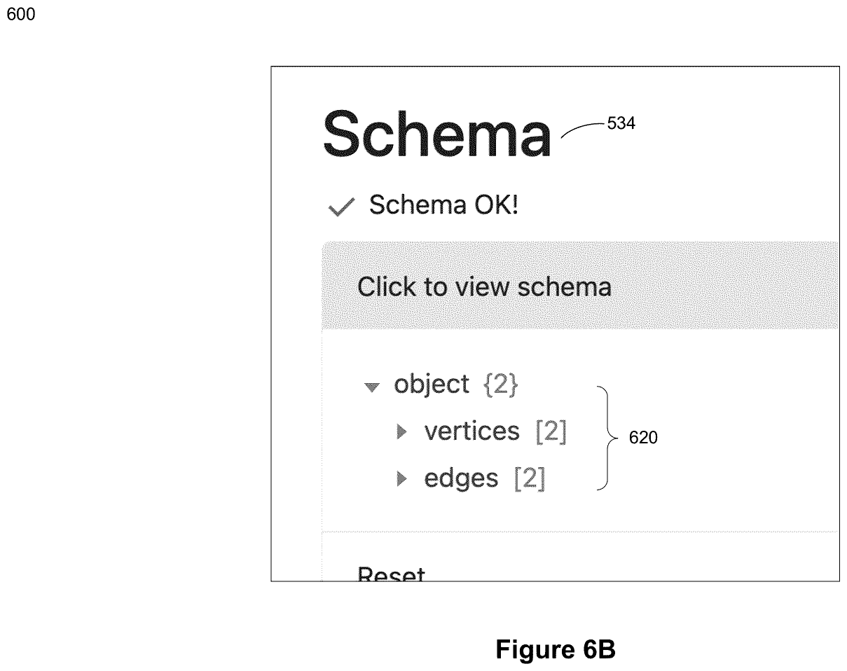

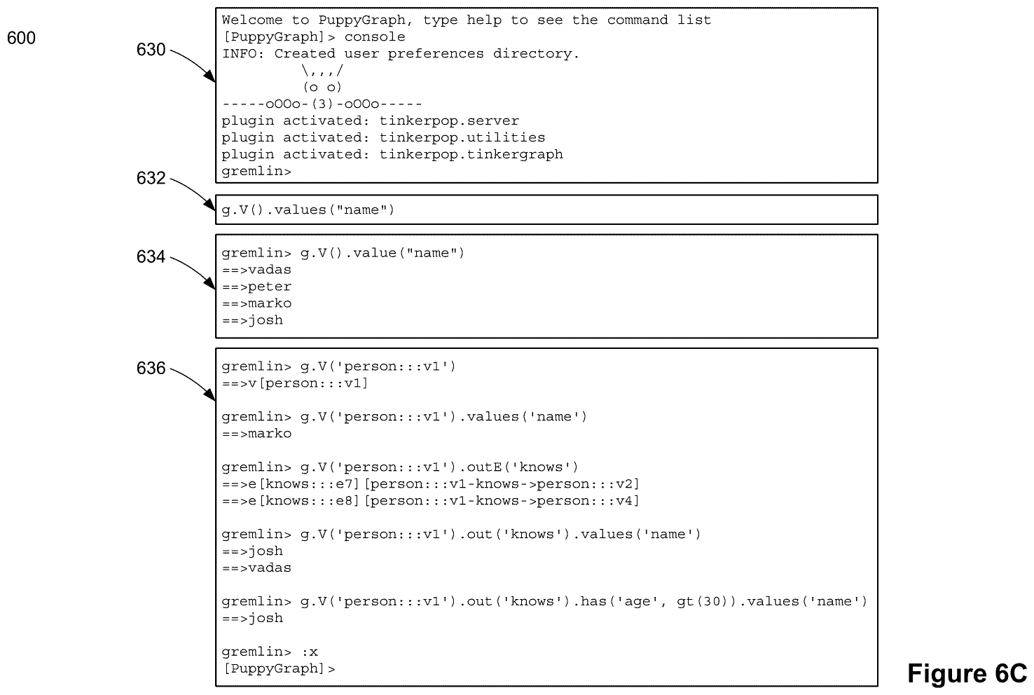

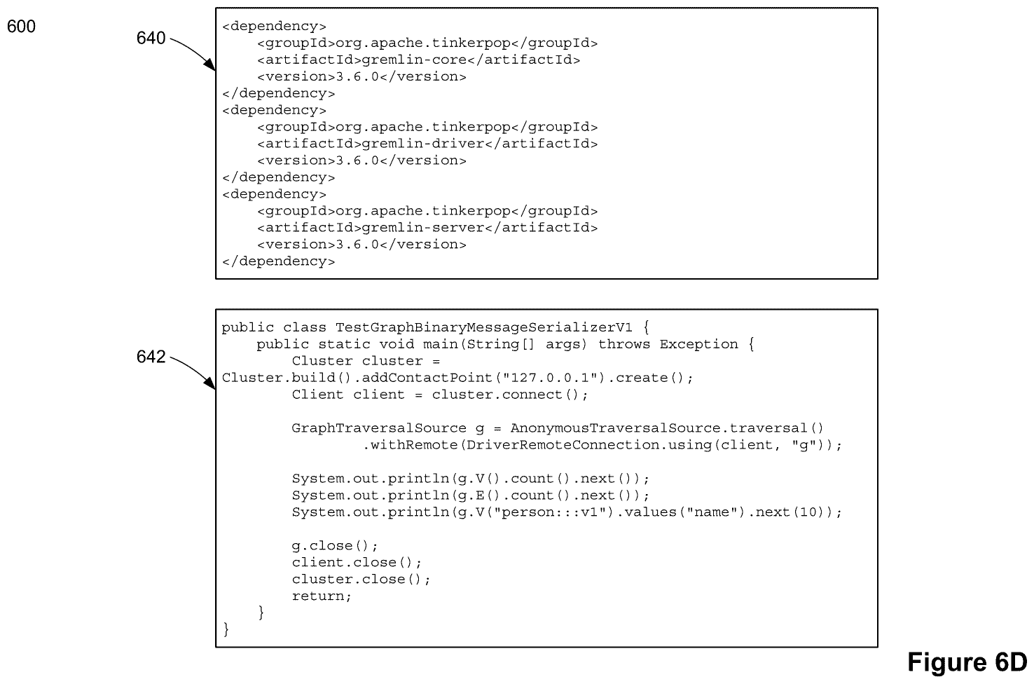

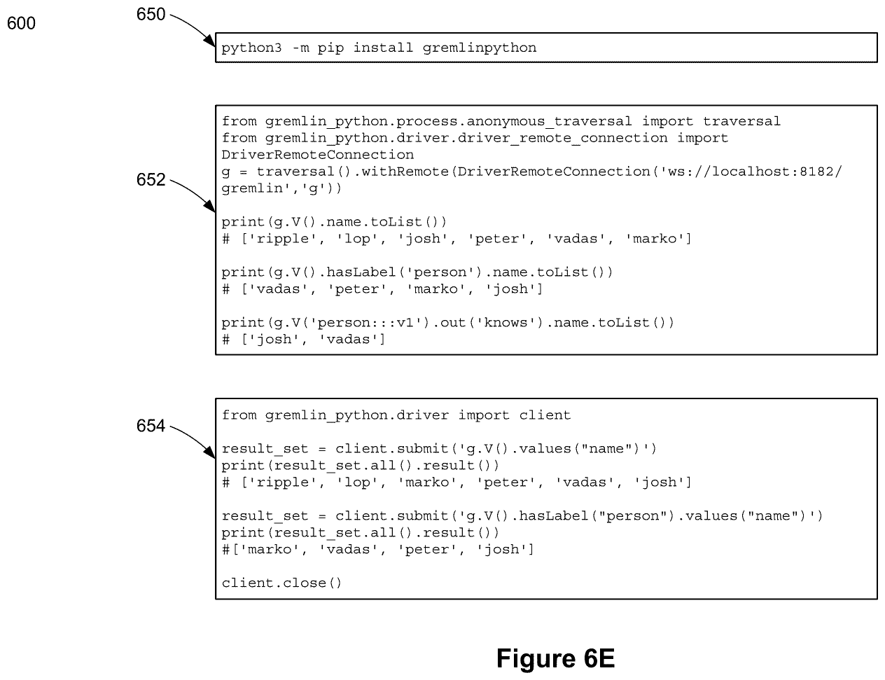

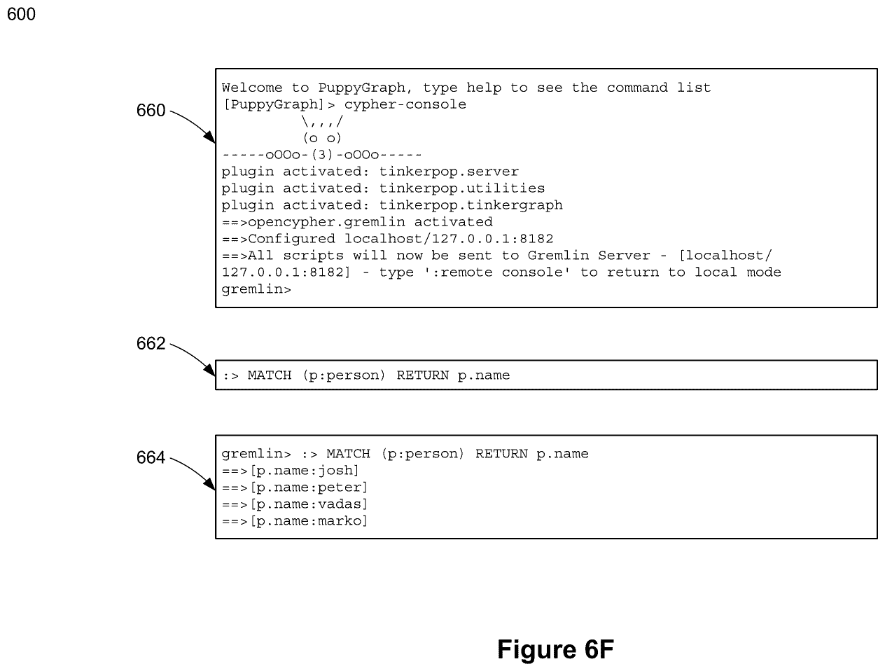

In some embodiments, a respective edge linking two adjacent vertices of a plurality of vertices is directed or undirected. The respective edge that is directed represents an asymmetric relation between the two adjacent vertices, while the respective edge that is undirected represents a symmetric relation between two adjacent vertices. For instance, as shown in the Transaction catalog 406 of FIG. 4A, edges associated with transactions between accounts can be directed (e.g., the first record of the Transaction catalog 406 shows a transaction from a SenderAccount of 0000001 to a ReceiverAccount 0000002). In another instance, edges associated with a scenario that person knows person can be undirected (described below in reference to FIGS. 5A-5L). Further, in some embodiments, the respective edge linking two adjacent vertices of the plurality of vertices includes a weight component. For instance, a query can be defined to find paths along respective edges with a certain sum of weights or a largest sum of weights (described below in reference to FIG. 6A).

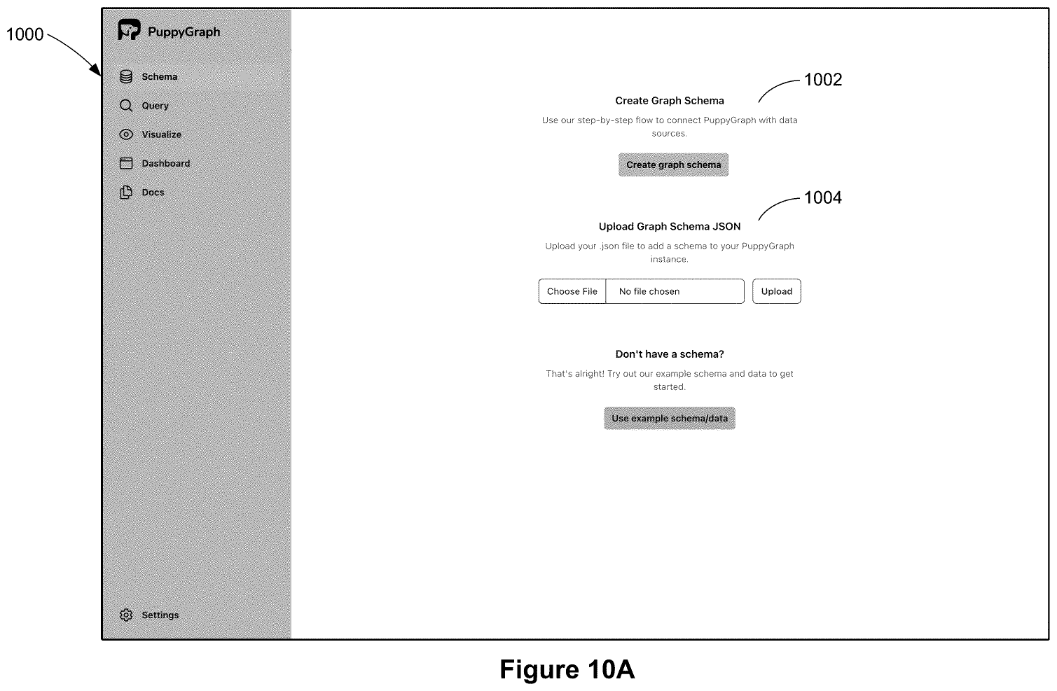

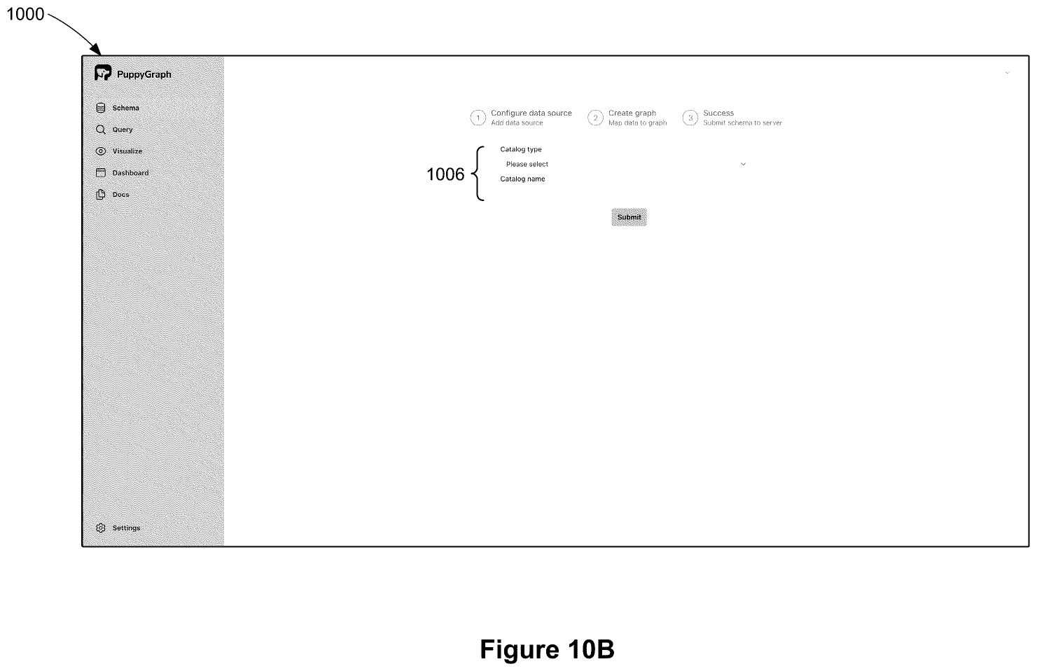

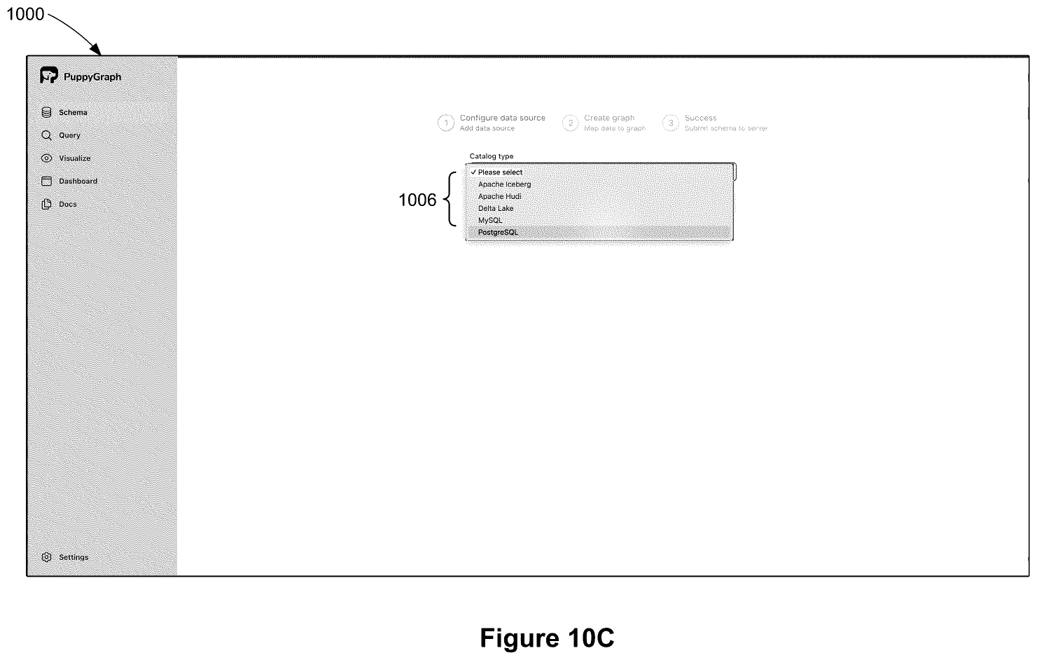

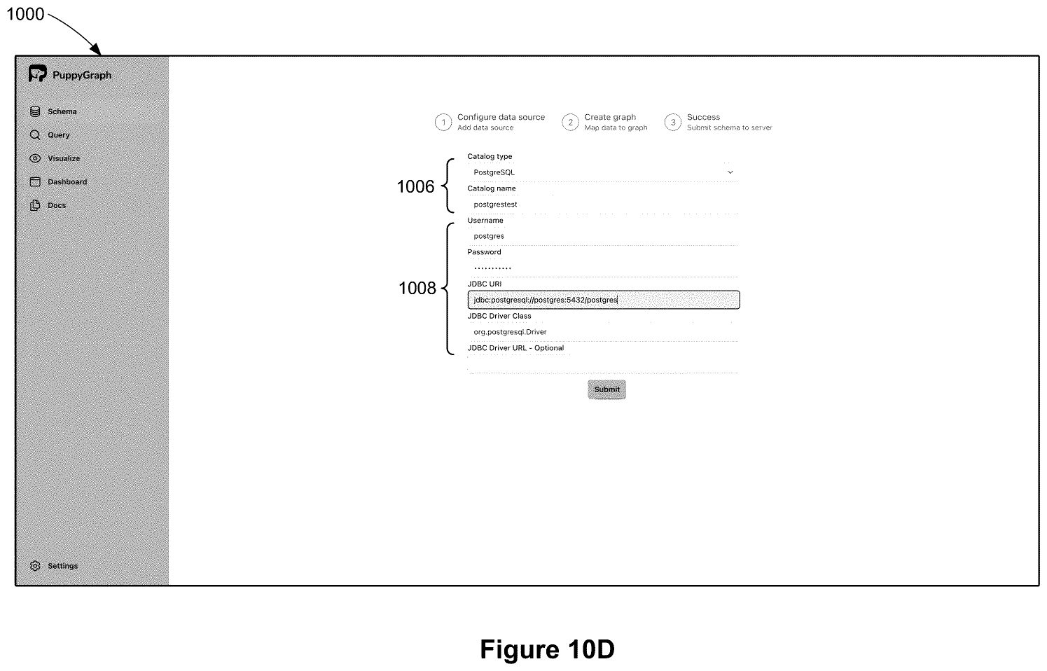

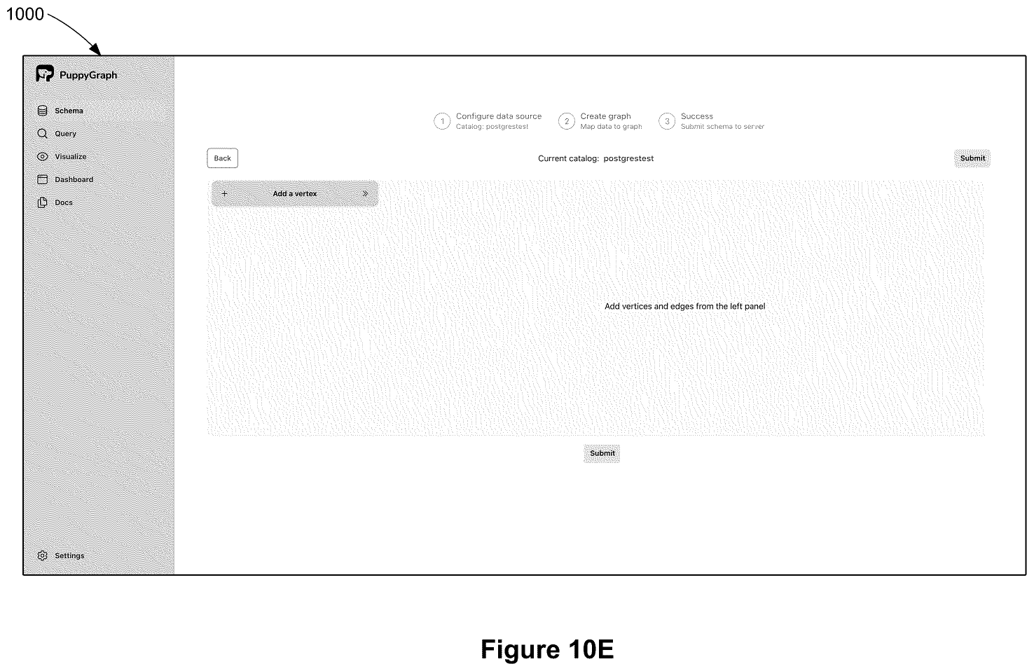

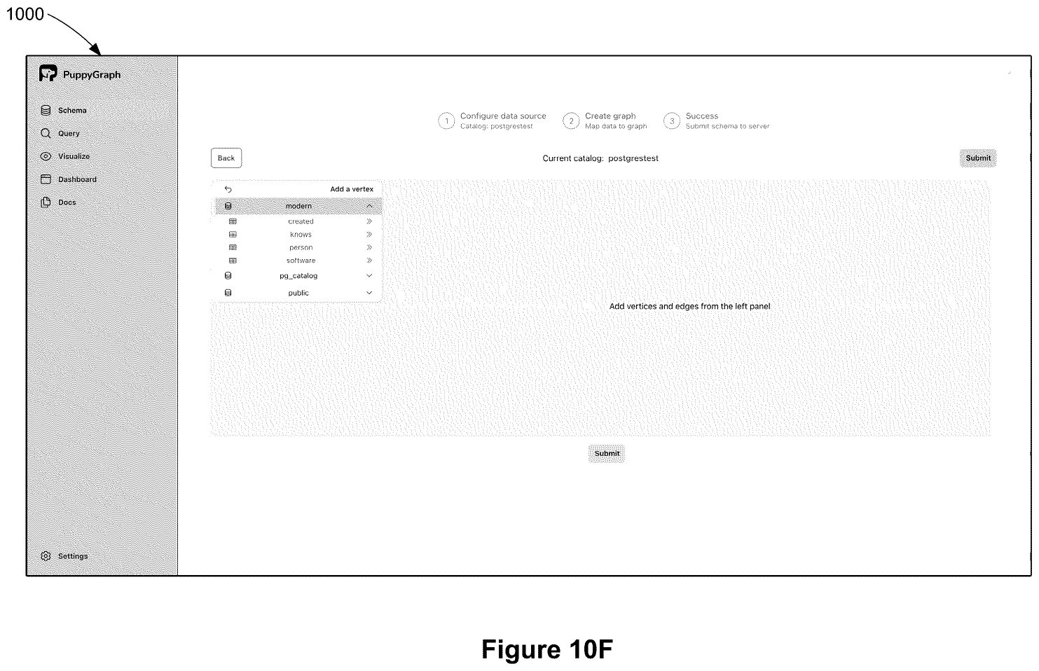

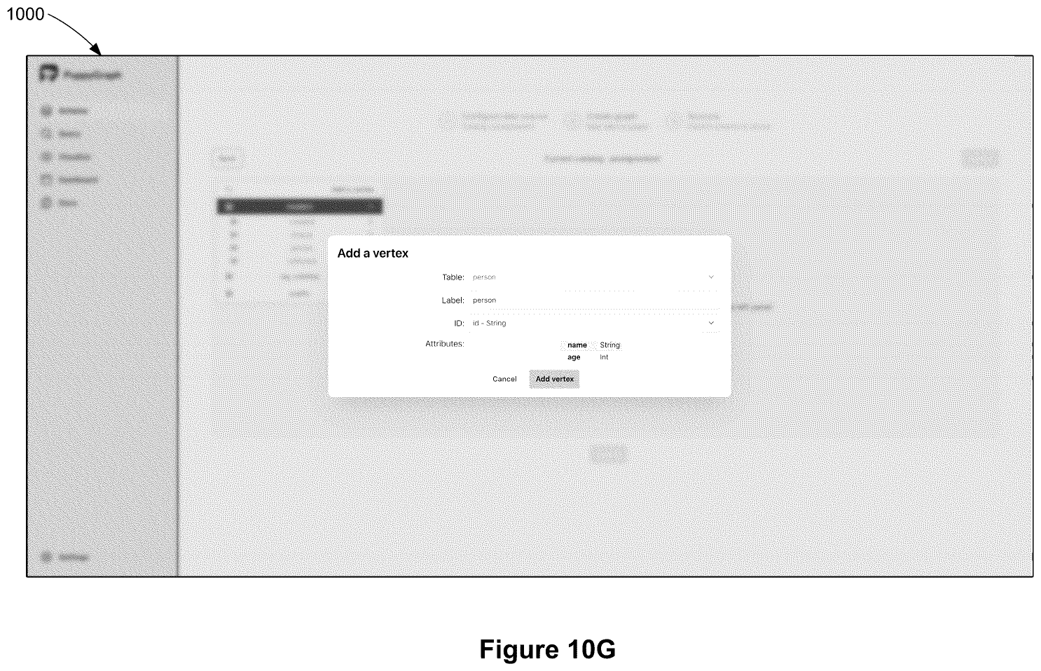

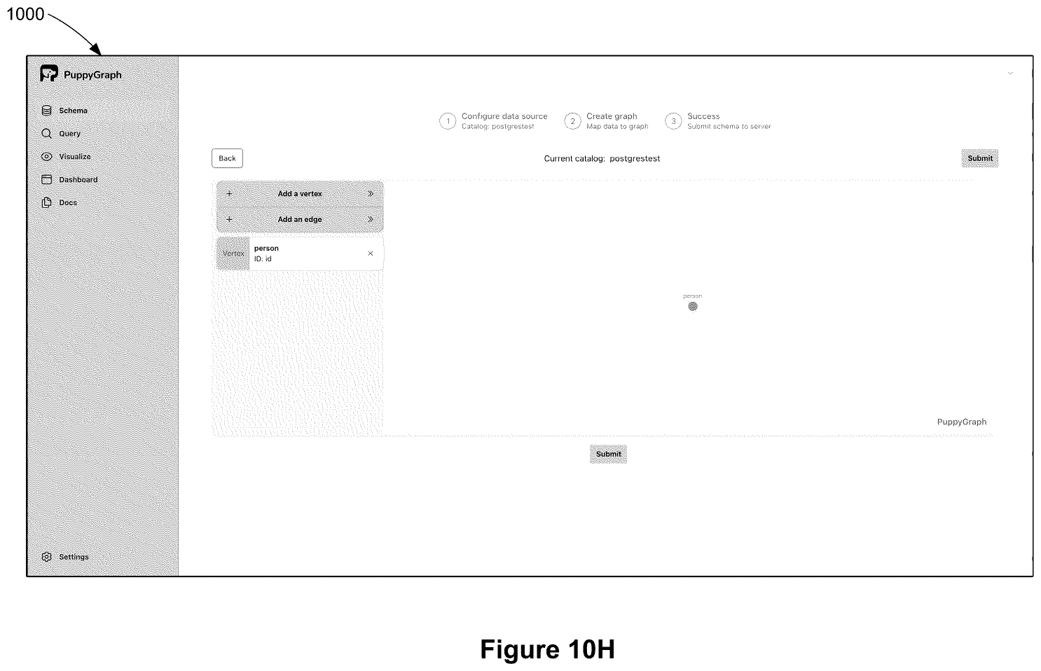

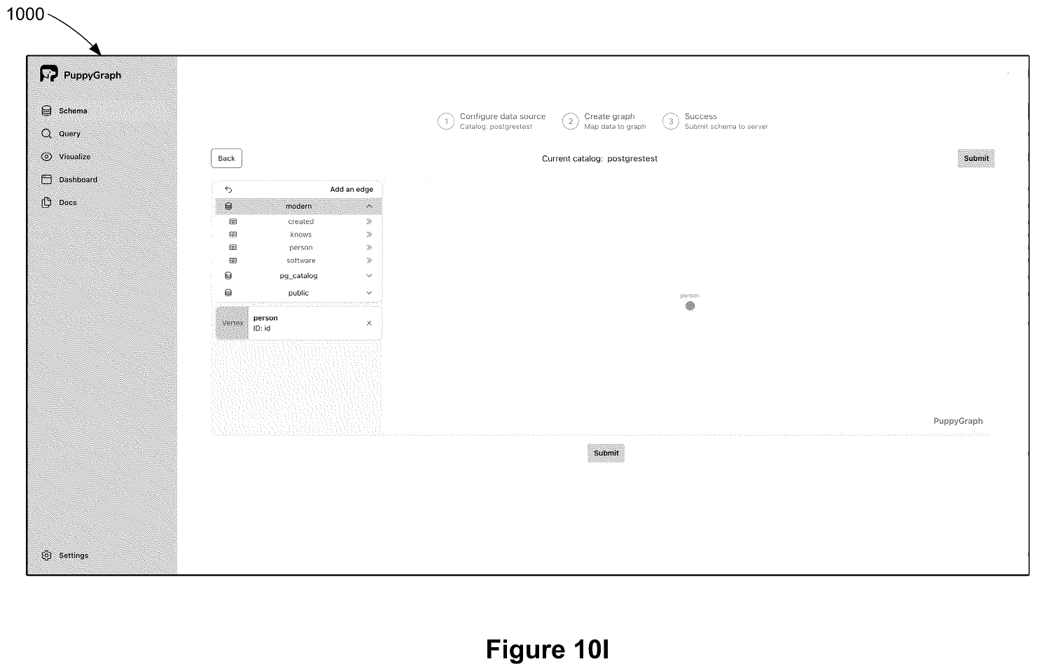

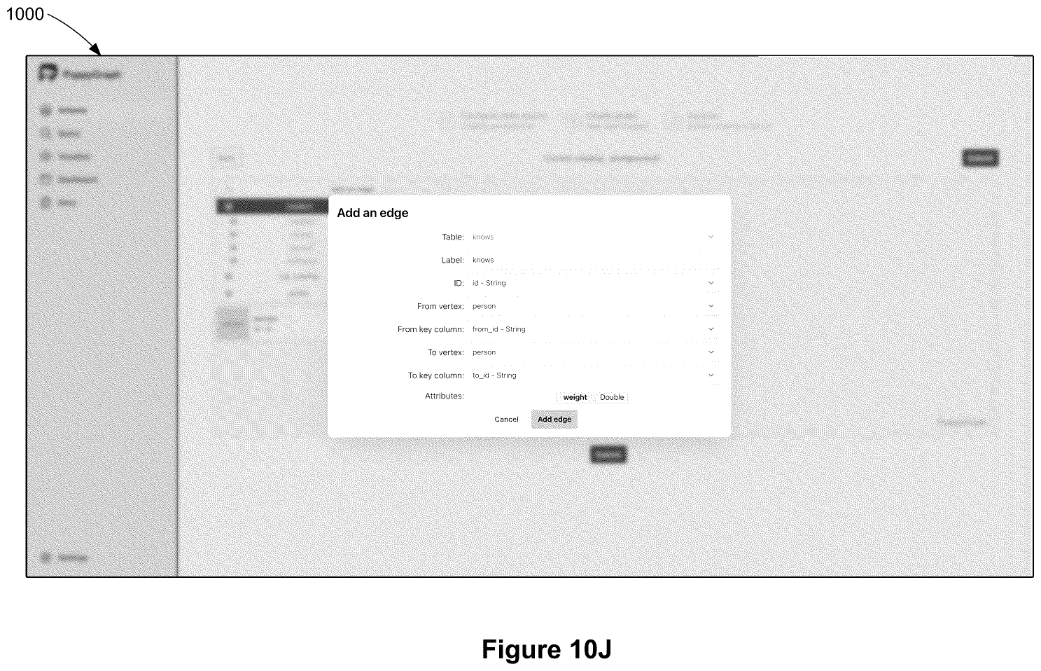

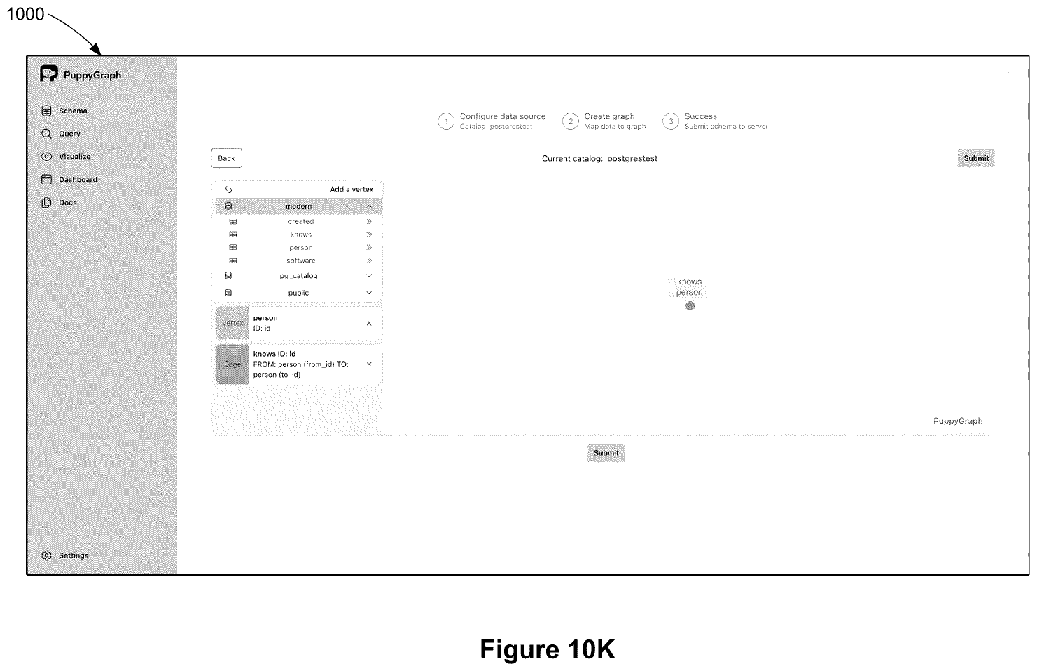

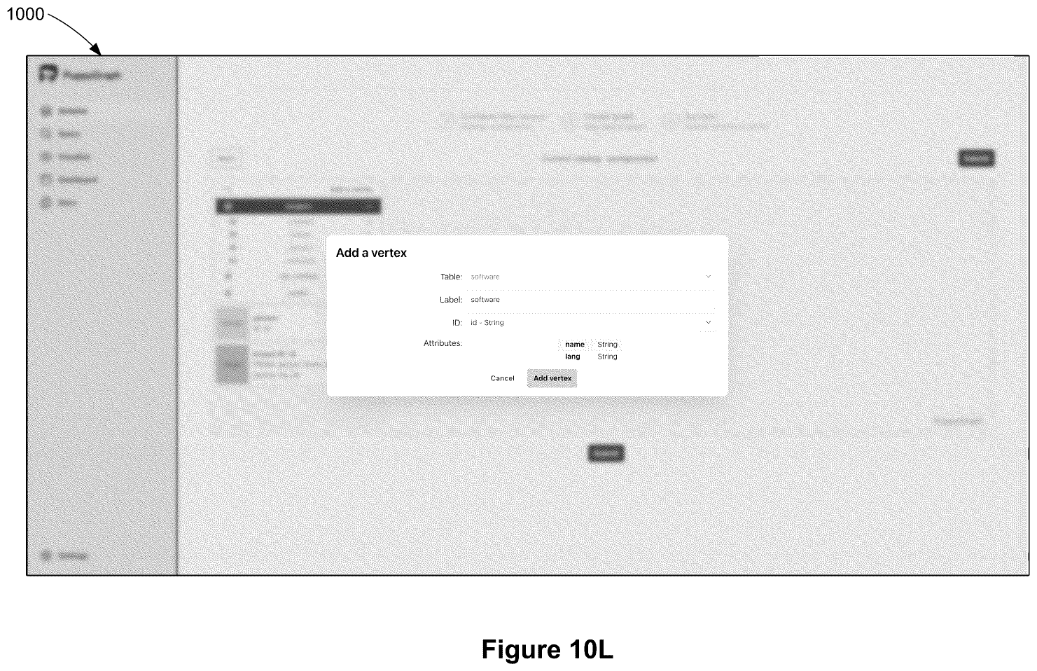

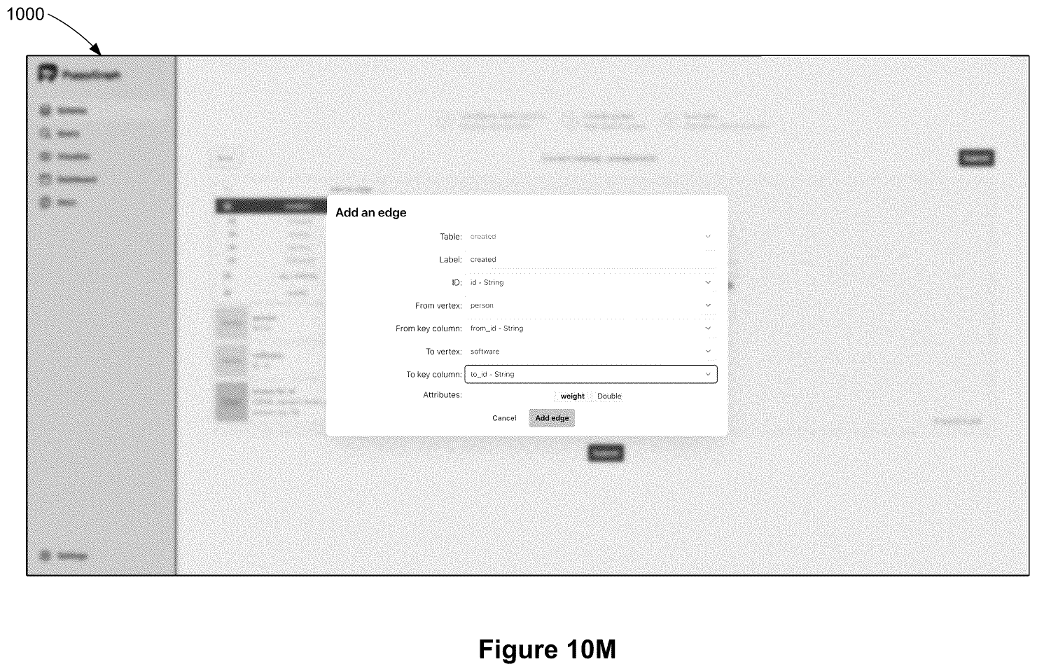

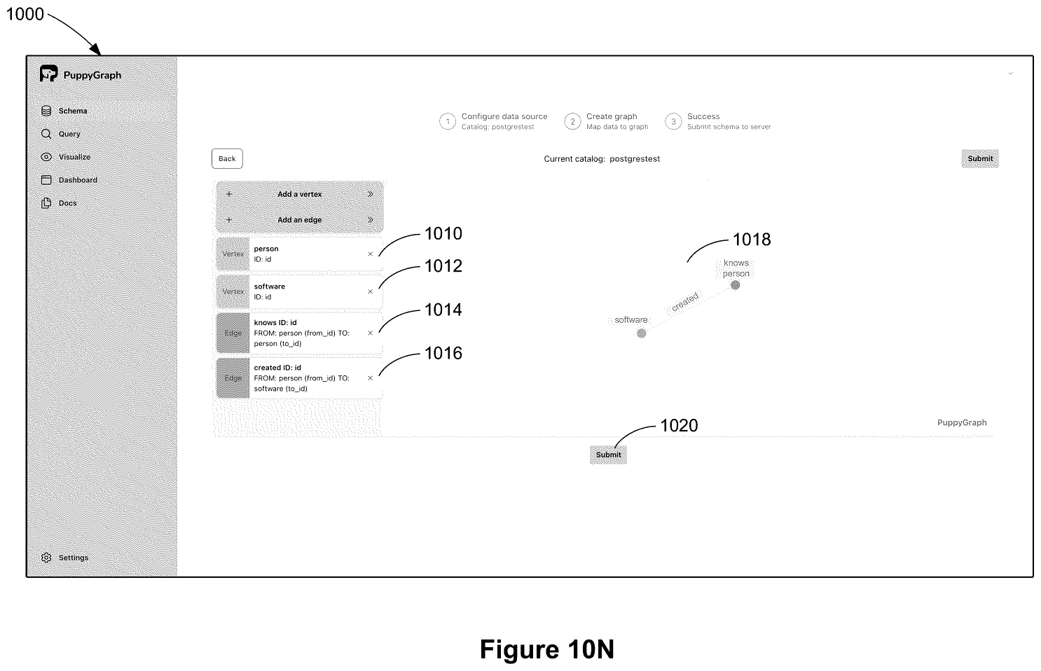

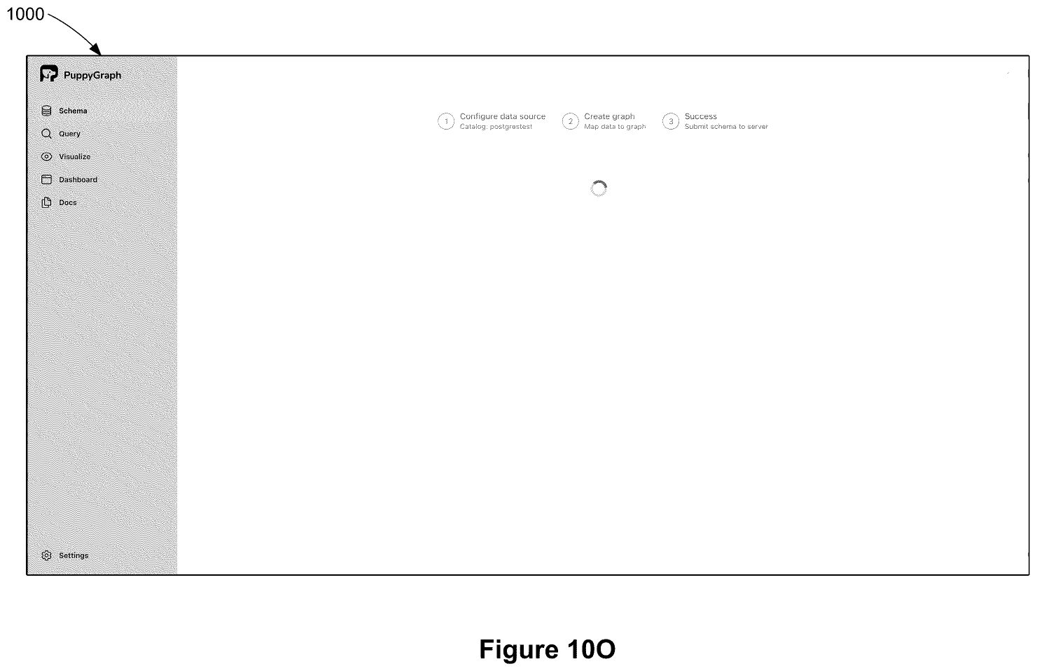

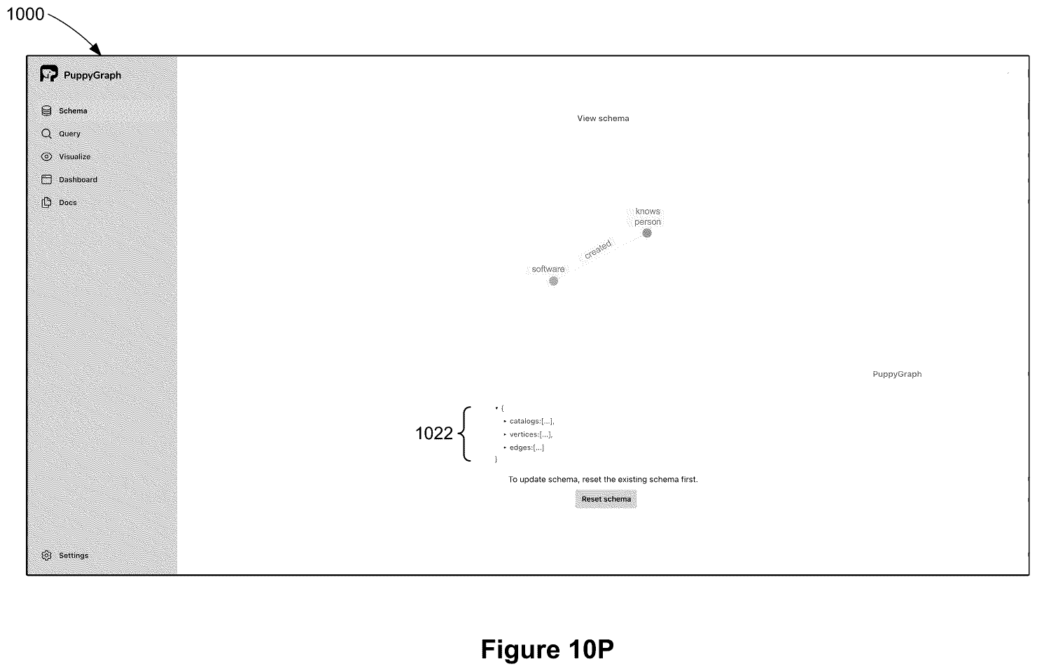

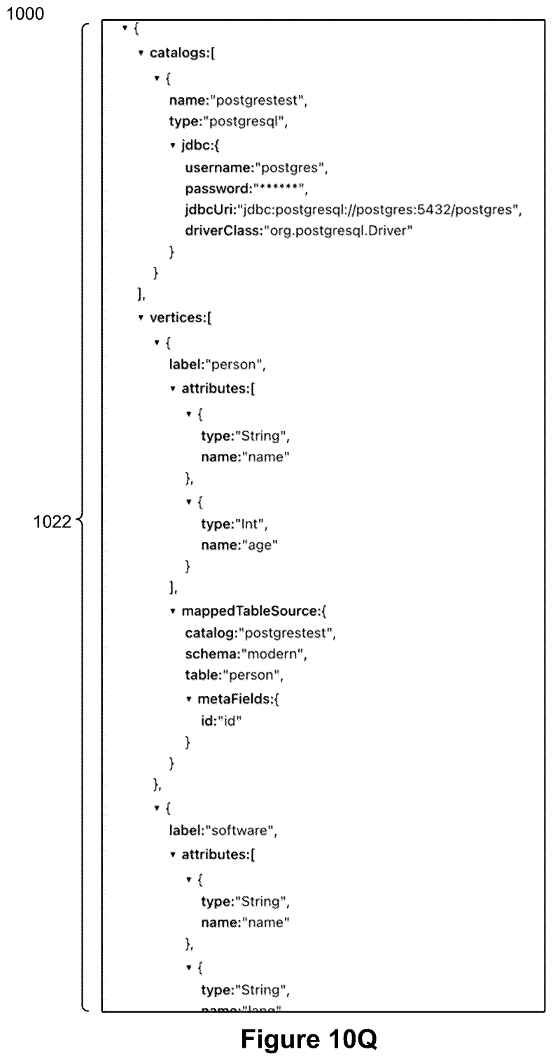

In some embodiments, an auxiliary component is created through a user interface associated with the auxiliary component (described below in reference to FIGS. 10A-10Q).

### Management User Interface of Graph Analytics Engine

FIGS. 5A-5L illustrate a series of graph query steps 500 associated with a first example puppy_small_v_person graph query that is performed based on a management user interface (UI) 530 of the graph analytics engine, in accordance with some embodiments. The management UI 530 of the graph analytics engine also generates graph-based representations of output entries from the first example puppy_small_v_person graph query. In some embodiments, the management UI 530 of the graph analytics engine supports both graph queries and non-graph queries.

FIG. 5A illustrates creating a to-be-queried puppy_small_v_person tabular database 512 (e.g., a tabular table named “puppy_small_v_person”) using a first tabular database UI 510 (e.g., applications, open-source projects, etc.). As shown in the first tabular database UI 510, the to-be-queried puppy_small_v_person tabular database 512 includes table schemas 514 associated with target entities of the to-be-queried puppy_small_v_person tabular database 512.

FIG. 5B illustrates a JSON file 520 corresponding to the first example puppy_small_v_person graph query based on the to-be-queried puppy_small_v_person tabular database 512. The JSON file 520 (e.g., “schema.JSON”) defines a hierarchy of the target entities of the to-be-queried puppy_small_v_person tabular database 512.

FIG. 5C illustrates uploading the JSON file 520 to the graph analytics engine through the management UI 530 of the graph analytics engine. In some embodiments, the graph analytics engine is stored on a server. The management UI 530 of the graph analytics engine includes a status section 532, a schema section 534, and a query section 536. The status section 532 shows a current status of an associated schema file (e.g., a JSON file). The schema section 534 processes the associated schema file (e.g., a JSON file). The query section 536 illustrates example resources (e.g., consoles, open-source projects, etc.) that are used to create graph queries in graph query languages.

As shown in a first zoomed view 534a of the schema section 534, a user selects the JSON file 520 (e.g., “schema.JSON”) and uploads it. Then, the server performs a process (e.g., a check) on the uploaded JSON file 520 to obtain processed information of the JSON file 520. After the process is complete, the schema section 534 presents “Scheme OK!” as shown in a second zoomed view 534b of the schema section 534. The schema section 534 also provides an option for the user to inspect the uploaded JSON file 520 by clicking “Click to view schema.” Then, as shown in a third zoomed view 534c of the schema section 534a, a drop-down list 540 then emerges and provides the processed information of the JSON file 520 related to catalogs, vertices, and edges.

FIG. 5D illustrates the status section 532 after the process on the JSON file 520 is complete.

FIG. 5E illustrates generating graph representations of the vertices and edges. The management UI 530 of the graph analytics engine includes a graph browser section 538. To visualize the vertices and edges, the user clicks “Start” to generate a graph-based representation 542 (e.g., a network graph) of the vertices and edges, as shown in a first zoomed view 538a of the graph browser section 538.

FIG. 5F illustrates a second to a fifth zoomed views 538b-538e of the graph browser section 538 that further show the graph-based representation 542 of the vertices and edges. The user may zoom in a portion of the graph-based representation 542, as shown in the second zoomed view 538b of the graph browser section 538. The user may click on vertices to check their attributes, as shown in the third zoomed view 538c of the graph browser section 538. The user may also explore the graph-based representation 542 along different edges, and obtain respective neighboring vertices and different paths between the respective neighboring vertices, as shown in the fourth and fifth zoomed views 538d-538e of the graph browser section 538.

FIG. 5G illustrates performing a first set of example graph query statements 552 of the first example puppy_small_v_person graph query. The user enters a first console UI 550 by clicking “Start query” associated with the first console UI 550 in the query section 536 of the management UI 530 of the graph analytics engine. Then, the user provides the first set of example graph query statements to obtain output entries. For instance, the user can type g.V( ) and obtain a list 554 of vertices for “Persons”.

FIG. 5H illustrates performing a second set of example graph query statements 562 of the first example puppy_small_v_person graph query. The user enters a second console UI 560 by clicking “Go to Graph notebook” associated with the second console UI 560 in the query section 536 of the management UI 530 of the graph analytics engine. As shown in the second console UI 560, the second set of example graph query statements 562 includes a graph query 562-1 for obtaining a count of the vertices, a graph query 562-3 for obtaining a count of the edges, and a graph query 562-3 for obtaining paths between persons. Output entries of the graph queries 562-1 to 562-3 can be printed out (e.g., a print-out 564 of the output entries of the graph query 562-3 for obtaining paths between persons).

FIG. 5I illustrates virtualizing the output entries of the graph query 562-3 for obtaining paths between persons in the second console UI 560. A visualization is realized in an example graph-based representation 566 (e.g., a network graph) of the output entries of the graph query 562-3 for obtaining paths between persons. A zoomed view 566a of the example graph-based representation 566 provide more details of the output entries of the graph query 562-3 for obtaining paths between persons.

FIGS. 5J-5L illustrate virtualizing output entries of graph queries from a third set of example graph query statements 572 of the first example puppy_small_v_person graph query through a first visualization UI 570. FIG. 5J illustrates a graph query 572-1 of the third set of example graph query statements 572 that randomly picks 25 vertices and a corresponding graph-based representation 574-1 of the picked 25 vertices. Similarly, in FIG. 5K, the user submits a graph query 572-2 of the third set of example graph query statements 572 that randomly picks 500 edges and then creates a corresponding graph-based representation 574-2 of the picked 500 edges. Moreover, respective attributes and neighbors of edges can be visualized by leveraging functions of the first visualization UI 570. FIG. 5L illustrates a graph query 572-3 of the third set of example graph query statements 572 for obtaining a count 574-3 of four-hop paths. As shown in FIG. 5L, the count 574-3 of the four-hop paths is 20,425,889, which is computed within a total execution time 576 less than 300 milliseconds.

In some embodiments, generating a graph-based representation of a plurality of output entries includes obtaining a respective graph relationship of the plurality of output entries. Generating the graph-based representation of the plurality of output entries further includes optimizing the respective graph relationship of the plurality of output entries for scalability. Generating the graph-based representation of the plurality of output entries further includes visualizing the optimized respective graph relationship of the plurality of output entries. For instance, as shown in FIGS. 5I-5L, the graph-based representations of the output entries from the graph queries (e.g., 562 and 572) can be optimized and scaled based on different UI functions (e.g., scripts, embedded UI features).

In some embodiments, receiving a graph query, traversing a to-be-queried database, and generating a graph-based representation of output entries are performed via an application or a user interface. For instance, as shown in FIGS. 5A-5L, the first example puppy_small_v_person graph query is performed based on the management UI 530 of the graph analytics engine. In particular, the management UI 530 of the graph analytics engine can be built as a cloud-native application. To facilitate graph-based representations of output entries from graph queries, additional graphical features can be incorporated within the management UI 530 of the graph analytics engine.

### Data Query Using Graph Analytics Engine

FIGS. 6A-6F illustrate a series of graph query steps 600 associated with a second example person_knows_person graph query that is performed based on the management UI 530 of the graph analytics engine, in accordance with some embodiments.

A user can access the graph analytics engine in a browser page with the URL http://<hostname>:8081. For instance, a locally deployed graph analytics engine is available at http://localhost:8081.

The user logins the graph analytics engine with a default username and a default password. Then, the user refreshes the browser page to restart the graph analytics engine. After logging in with the username and password, the user sees the management UI 530 of the graph analytics engine (in reference to FIGS. 5C-5E). As discussed, the management UI 530 of the graph analytics engine includes the status section 532, the schema section 534, the query section 536, and the graph browser section 538.

The user first creates a graph (e.g., a to-be-queried database) and loads it into the graph analytics engine. In some embodiments, the graph can be stored within internal data sources (e.g., local drivers) or external data sources (e.g., data lakes or databases). FIG. 6A illustrates an example person-knows-person graph 610 for the second example person_knows_person graph query. In some embodiments, a respective edge that links two adjacent vertices is directed or undirected (e.g., an asymmetric or symmetric relation between two adjacent vertices). In some embodiments, the respective edge that links two adjacent vertices includes a weight component. For instance, as shown in FIG. 6A, an edge linking vertices “person 1” and “person 2” includes a weight of 0.5.

Next, the user creates a schema (e.g., a JSON file) that defines a hierarchy of target entities within the graph. After creating the schema, the user views the schema on the management UI 530 of the graph analytics engine, as shown in FIG. 6B. FIG. 6B illustrates a drop-down list 620 in the schema section 534. The drop-down list 620 provides that the graph has two vertex types and two edge types.

Then, the user queries the graph using graph query languages (e.g., Gremlin and Cypher). To query the graph using Gremlin, the user may use an embedded Gremlin console (in reference to FIG. 5G) in the graph analytics engine. FIG. 6C illustrates a start 630 of the embedded Gremlin console, a sample query 632 asking for all names of the vertices in the graph, an output 634 of the sample query 632. FIG. 6C further illustrates additional example queries and their corresponding outputs 636. The user may alternatively use Java Client. FIG. 6D illustrates dependencies 640 to be added into Java dependency for connecting with Java Client. FIG. 6D further illustrates an example connection with Gremlin Server 642. In addition, the user may alternatively use Python Client. FIG. 6E illustrates a portion 650 of a script for connecting official gremlin-python client and a query to a local Gremlin server 652 using a native driver. It is optional to submit a query directly via Python Client such that the query string is consistent with the one used in the embedded Gremlin console, as shown in an example script 654 of FIG. 6E.

Instead of Gremlin, the user can query the graph using Cypher. The user may use an embedded Cypher console (e.g., clicking “Start Query” under a “Cypher console” subsection of the query section 536 in reference to FIG. 5C) provided by the graph analytics engine. FIG. 6F illustrates a start 660 of the embedded Cypher console, a sample query 662 asking for all names of the vertices in the graph, an output 664 of the sample query 662.

Graph Analytics Engine with Locally Deployed Apache Iceberg

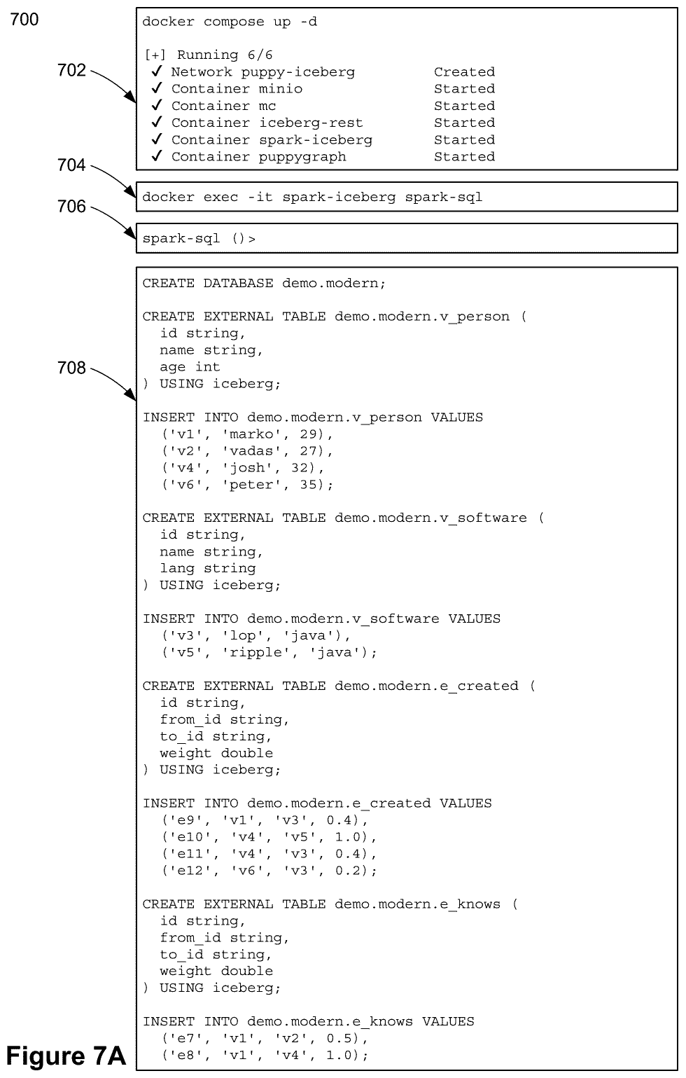

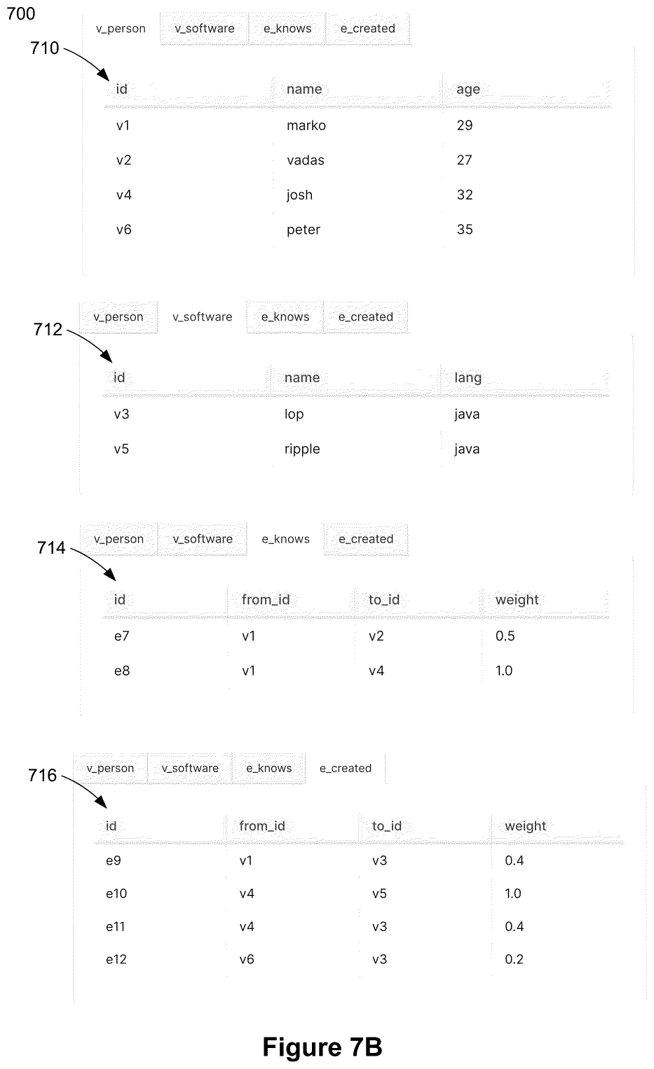

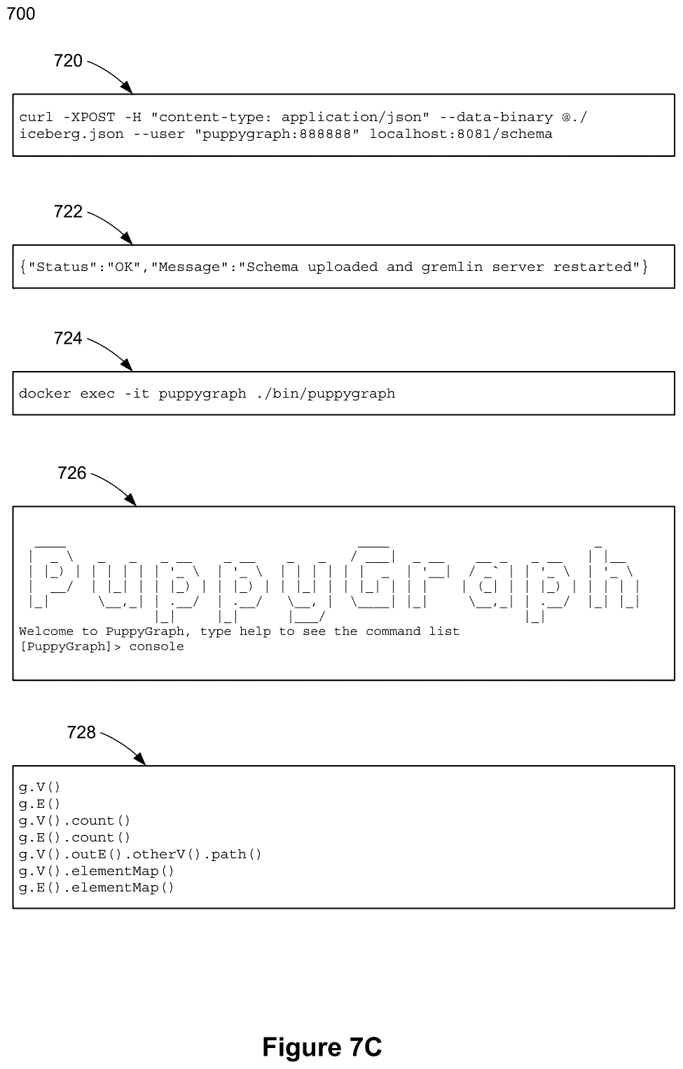

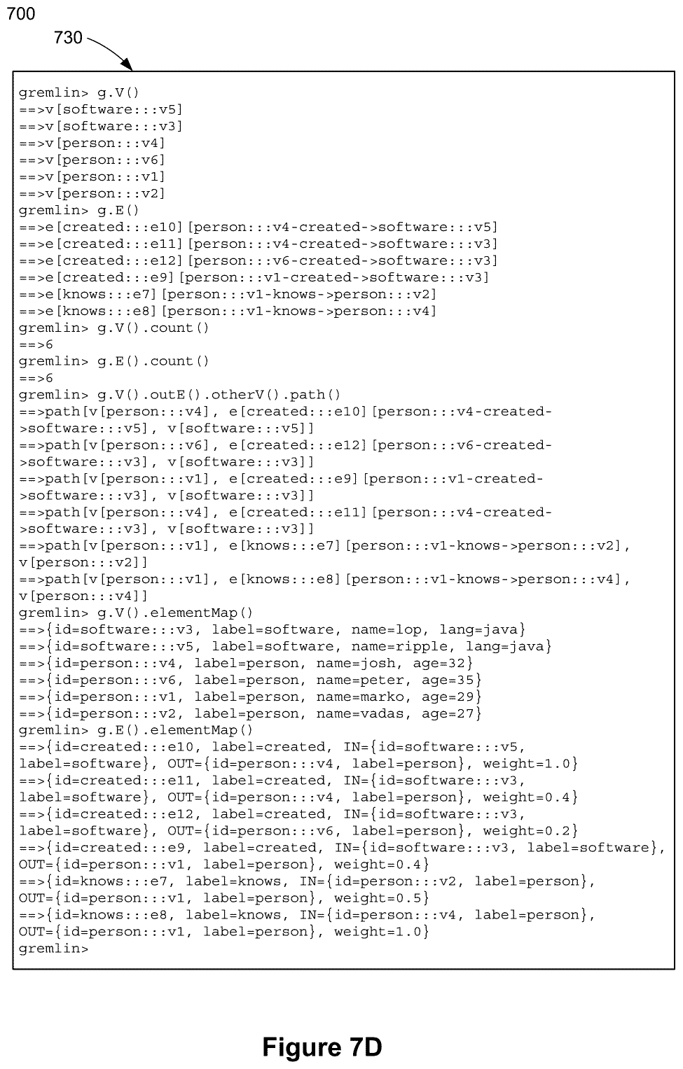

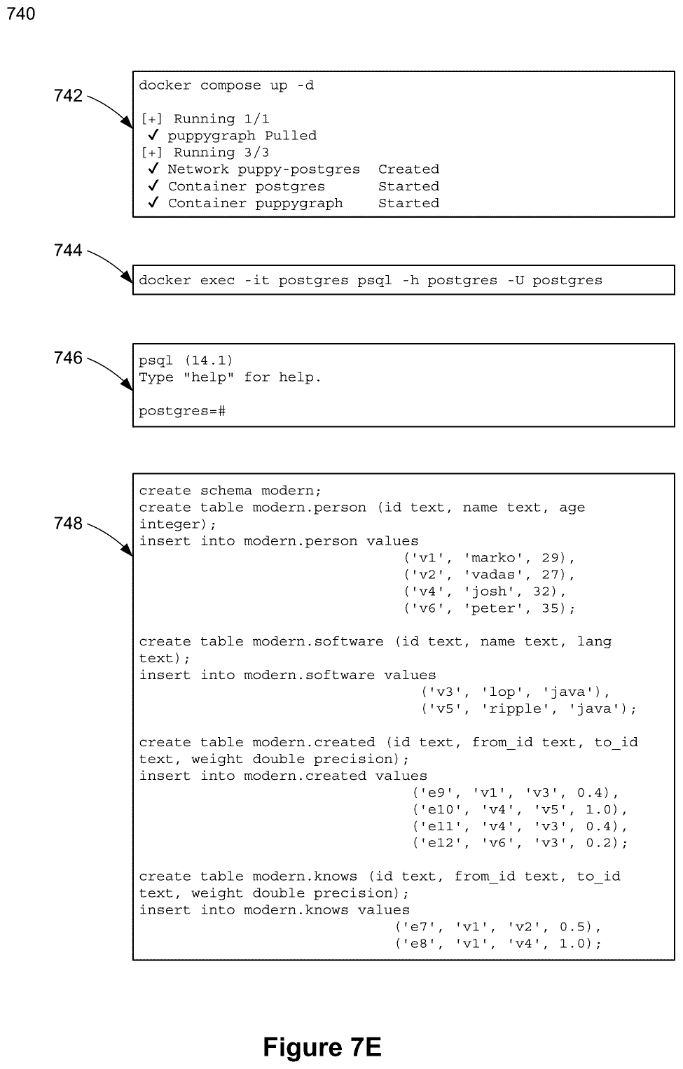

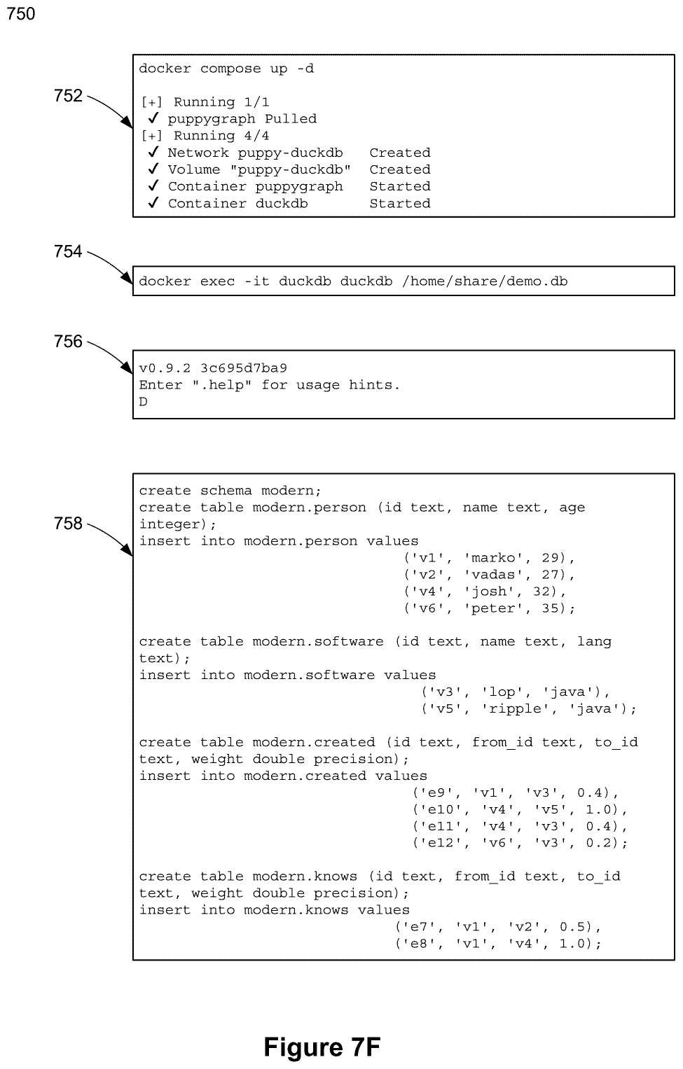

FIGS. 7A-7D illustrate an example graph query 700 using the graph analytics engine with locally deployed Apache Iceberg, in accordance with some embodiments. The example graph query 700 is based on the example person-knows-person graph 610 for the second example person_knows_person graph query in reference to FIG. 6A.

A user creates a file docker-compose.yaml with content “docker-compose.yaml.” The user then runs command 702 to start Iceberg and graph analytics engine services, as illustrated in FIG. 7A.

To prepare data on Iceberg, the user runs command 704 to start a Spark-SQL shell 706 to access Iceberg for creating database, as illustrated in FIG. 7A. The user then executes SQL statements 708 in the Spark-SQL shell, as illustrated in FIG. 7A, to create tables and insert data. The SQL statements 708 create Iceberg tables (e.g., a “v_person” table 710, a “v_software” table 712, a “e_knows” table 714, and a “e_created” table 716”).

Then, the user defines a schema in accordance with the created Iceberg tables. The user creates a graph schema file iceberg.json with content “iceberg.json” based on the example person-knows-person graph 610. The user runs command 720 to upload the graph schema file iceberg.json, as illustrated in FIG. 7C. A response 722 shows that the graph schema file iceberg.json is uploaded, as illustrated in FIG. 7C.

After the graph schema file iceberg.json is uploaded, the user queries the example person-knows-person graph 610 through a web-based Gremlin console embedded in the graph analytics engine. To access a command-line interface (CLI) of the graph analytics engine, the user runs command 724, as illustrated in FIG. 7C. In the CLI of the graph analytics engine, the user types “console” to start the embedded Gremlin console 726, as illustrated in FIG. 7C.

The user then queries the example person-knows-person graph 610 using Gremlin query language. For instance, the user creates graph queries 728, as shown in FIG. 7C, and obtain output entries 730, as shown in FIG. 7D.

Graph Analytics Engine with Locally Deployed PostgreSQL

FIG. 7E illustrates an example graph query 740 using the graph analytics engine with locally deployed PostgreSQL, in accordance with some embodiments. The example graph query 740 is based on the example person-knows-person graph 610 for the second example person_knows_person graph query in reference to FIG. 6A. A major portion of the example graph query 740 with the locally deployed PostgreSQL is substantially similar to the example graph query 700 with the locally deployed Apache Iceberg.

A user creates a file docker-compose.yaml with content “docker-compose.yaml.” The user then runs command 742 to start Postgres and graph analytics engine services, as illustrated in FIG. 7E.

To prepare data on Iceberg, the user runs command 744 to start a PostgreSQL shell 746 to access PostgreSQL for creating database, as illustrated in FIG. 7E. The user then executes SQL statements 748 in the PostgreSQL shell, as illustrated in FIG. 7E, to create tables and insert data. The SQL statements 748 create PostgreSQL tables (e.g., similar to Iceberg tables in reference to FIG. 7B).

Then, the user defines a graph schema file in accordance with the created PostgreSQL tables, upload graph schema file to the graph analytics engine, and queries the example person-knows-person graph 610 using Gremlin query language.

Graph Analytics Engine with Locally Deployed DuckDB

FIG. 7F illustrates an example graph query 750 using the graph analytics engine with locally deployed DuckDB, in accordance with some embodiments. The example graph query 750 is based on the example person-knows-person graph 610 for the second example person_knows_person graph query in reference to FIG. 6A. Similarly, the example graph query 750 with locally deployed DuckDB involves steps that closely resemble those for the locally deployed PostgreSQL and Apache Iceberg.

A user creates a file docker-compose.yaml with content “docker-compose.yaml.” The user then runs command 752 to start DuckDB and graph analytics engine services, as illustrated in FIG. 7F.

To prepare data on Iceberg, the user runs command 754 to create a database file /home/share/demo.db and start a DuckDB shell 756 to access DuckDB for creating database, as illustrated in FIG. 7F. The user then executes SQL statements 758 in the DuckDB shell, as illustrated in FIG. 7F, to create tables and insert data. The SQL statements 758 create DuckDB tables (e.g., similar to Iceberg tables in reference to FIG. 7B).

Then, the user defines a graph schema file in accordance with the created DuckDB tables, upload graph schema file to the graph analytics engine, and queries the example person-knows-person graph 610 using Gremlin query language.

### Query Data Lakes

FIGS. 8A-8J illustrate an example graph query 800 using the graph analytics engine with data lakes, in accordance with some embodiments.

A user can query data by connecting to the data lakes, which include Apache Iceberg, Apache Hudi, Delta Lake, and Apache Hive.

In the example graph query 800 with the data lakes, the user creates example person-referral tables (e.g., a person table 802 and a referral table 804) in the data lakes, as shown in FIG. 8A.

### Query Data Lakes: Apache Iceberg

The user runs shell command 810 to start a Spark SQL shell for data preparation. A spark-sql executable is in a bin folder of a Spark directory, as illustrated in FIG. 8B. The shell command 810 assumes data are stored on Hadoop Distributed File System (HDFS) at 172.31.19.123:9000 and that Hive Metastore is at 172.31.31.125:9083. Then, the user runs Spark-SQL statements 812 to create the example person-referral tables 802 and 804 in Iceberg database onhdfs and insert data, as illustrated in FIG. 8B. A catalog name puppy_iceberg is specified in the shell command 810. In some embodiments, running the shell 810 and the Spark-SQL statements 812 is optional.

The user then defines a graph before querying the graph by creating a schema file iceberg.json 816, as shown in FIG. 8C. The schema file iceberg.json 816 requires:
A catalog object named catalog_test defines an Iceberg data source. The hiveMetastoreUrl field matches the Hive Metastore URL.
Labels of vertices and edges may not be the same as names of tables in Iceberg. A mappedTableSource object in each vertex or edge type specifies a schema and/or database name onhdfs and a table name referral.
The mappedTableSource object also refers to columns (e.g., attributes) in the tables.
   An id field refers to a column storing identities for vertices ID and edges refId.
   Fields from and to refer to two columns in the tables as ends of edges. Values of these two columns match the id field of the vertices. In the example graph query 800 with the data lakes, each row in the referral table models an edge in the graph from source to referred.

Once the schema file iceberg.json 816 is created, the user uploads it to the graph analytics engine with shell command 814, as shown in FIG. 8B.

### Query Data Lakes: Apache Hudi

The user runs shell command 830 to start a SparkSQL instance for data preparation, as illustrated in FIG. 8D. The shell command 830 assumes delta lake data are stored on HDFS at 172.31.19.123:9000 and that Hive Metastore is at 172.31.31.125:9083. Then, the user runs SparkSQL query 832 to create the example person-referral tables 802 and 804 in delta lake database hudi_onhdfs and insert data, as illustrated in FIG. 8D. A catalog name puppy_delta is specified in the shell command 830. In some embodiments, running the shell 830 and the SparkSQL query 832 is optional.

The user then defines a graph before querying the graph by creating a schema file hudi.json 836, as illustrated in FIG. 8E. The schema file hudi.json 836 requires:
A catalog object named catalog_test specifies remote data source in Apache Hudi. A hiveMetastoreUrl field has the same value as the one used to create data.
Labels of vertices and edges may not be the same as names of tables in Apache Hudi. A mappedTableSource object in each vertex or edge type specifies a schema and/or database name onhdfs and a table name referral.
The mappedTableSource object marks meta columns (e.g., attributes) in the tables. For instance, fields from and to refer to two columns that form endpoints of the edges.

Once the schema file hudi.json 836 is created, the user uploads it to the graph analytics engine with shell command 834, as shown in FIG. 8D.

### Query Data Lakes: Delta Lake

The user runs shell command 850 to start a SparkSQL instance for data preparation, as illustrated in FIG. 8F. The shell command 850 assumes delta lake data are stored on HDFS at 172.31.19.123:9000 and that Hive Metastore is at 172.31.31.125:9083. Then, the user runs SparkSQL query 852 to create the example person-referral tables 802 and 804 in Delta Lake database onhdfs and insert data, as illustrated in FIG. 8F. A catalog name puppy_delta is specified in the shell command 850. In some embodiments, running the shell 850 and the SparkSQL query 852 is optional.

The user then defines a graph before querying the graph by creating a schema file deltalake.json 856, as illustrated in FIG. 8G. The schema file deltalake.json 856 requires:
A catalog object named catalog_test specifies remote data source in Delta Lake. A hiveMetastoreUrl field has the same value as the one used to create data.
Labels of vertices and edges may not be the same as names of tables in Delta Lake. A mappedTableSource object in each vertex or edge type specifies a schema and/or database name onhdfs and a table name referral.
The mappedTableSource object marks meta columns (e.g., attributes) in the tables. For instance, fields from and to refer to two columns that form endpoints of the edges.

Once the schema file deltalake.json 856 is created, the user uploads it to the graph analytics engine with shell command 854, as shown in FIG. 8F.

### Query Data Lakes: Apache Hive

The user runs command 870 to use Hive beeline client to connect to Hive Server, as illustrated in FIG. 8H. A Hive home path is/opt/hive. If the Hive Server is not at a localhost, the user changes URL accordingly. Then, the user creates tables by statements 872 in Hive beeline console, as illustrated in FIG. 8H. In some embodiments, running the command 870 and the statements 872 is optional.

The user then defines a graph before querying the graph by creating a schema file hive_hdfs.json 878, as illustrated in FIG. 8I. The schema file hive_hdfs.json defines a Hive Catalog 874, as illustrated in FIG. 8H. The schema file hive_hdfs.json 878 requires:
The name hive_hdfs defines a reference within the hive_hdfs.json schema. The name hive_hdfs is used by definition of vertices and edges.
A type of the Hive Catalog is hive, and a metastore type of the Hive Catalog is HMS.
A metastore.hiveMetastoreUrl specifies URL of a Hive Metastore Service. The user can change a hostname accordingly if the Hive Metastore Service is not deployed at the localhost.

Once the schema file hive_hdfs.json 878 is created, the user uploads it to the graph analytics engine with shell command 876, as shown in FIG. 8H.

In some embodiments, the graph analytics engine supports querying Iceberg, Hudi, and Delta Lake with metastore (e.g., Hive metastore, AWS Glue) and with storage (e.g., HDFS, AWS S3, MinIO).

To query the data based on the data lakes (e.g., Apache Iceberg, Apache Hudi, Delta Lake, and Apache Hive) discussed above, the user connects to the graph analytics engine at http://localhost:8081 and start the embedded Gremlin console UI 550 (e.g., in reference to FIG. 5G) through the management UI 530 of the graph analytics engine.

After connecting to the embedded Gremlin Console, the user starts to query the graph. For instance, the user submits an example graph query 880 for checking names of people known by a person and subsequently receives corresponding output entries 882, as shown in FIG. 8J.

### Query Relational Databases

FIGS. 9A-9O illustrates an example graph query 900 using the graph analytics engine with relational databases, in accordance with some embodiments.

A user can query data by connecting to the relational databases, which include MySQL, PostgreSQL, DuckDB, BigQuery, and Redshift.

In the example graph query 900 with the relational databases, the user creates example person-referral tables (e.g., a person table 802 and a referral table 804 in reference to FIG. 8A) in the relational databases.

### Querying Relational Databases: MySQL

The user starts a MySQL container through Docker by command 910, as illustrated in FIG. 9A, and writes data to MySQL. An IP address of a machine that runs the MySQL container is assumed to be 172.31.19.123. After waiting for the MySQL container to start, the user connects through MySQL client 912, as illustrated in FIG. 9A. Then, the user creates a database and a data table by statements 914, as illustrated in FIG. 9A, and writes the data to MySQL. In some embodiments, running the command 910 and the statements 914 is optional.

The user then defines a schema file mysql.json 918 before querying the table, as illustrated in FIG. 9B. The schema file mysql.json 918 requires:
A catalog jdbc_mysql is added to specify remote data source in MySQL.
   Set type to mysql.
   Set driverClass to com.mysql.jdbc.Driver for MySQL v5.x and earlier. Alternatively, set driverClass to com.mysql.cj.jdbc.Driver for MySQL v6.x and later.
   Set driverUrl to provide a URL where the graph analytics engine finds the MySQL driver.
Labels of vertices and edges may not be the same as names of tables in MySQL. A mappedTableSource object in each vertex or edge type specifies a schema name graph and a table name referral.
The mappedTableSource object marks meta columns (e.g., attributes) in the tables. For instance, fields from and to refer to two columns that form endpoints of the edges.

Once the schema file mysql.json 918 is created, the user uploads it to the graph analytics engine at localhost with shell command 916, as shown in FIG. 9A.

### Querying Relational Databases: PostgreSQL

The user starts a PostgreSQL container through Docker by command 920, as illustrated in FIG. 9C, and writes data to PostgreSQL. An IP address of a machine that runs the PostgreSQL container is assumed to be 172.31.19.123. After waiting for the PostgreSQL container to start, the user connects through PostgreSQL client 922, as illustrated in FIG. 9C. Then, the user creates a database and a data table by statements 924, as illustrated in FIG. 9C, and writes the data to PostgreSQL. In some embodiments, running the command 920 and the statements 924 is optional.

The user then defines a schema file postgres.json 928 before querying the table, as illustrated in FIG. 9D. The schema file postgres.json 928 requires:
A catalog jdbc_postgres is added to specify remote data source in postgreSQL.
   Set type to postgresql.
   Set driverClass to org.postgresql.Driver.
   Set driverUrl to provide a URL where the graph analytics engine finds the PostgreSQL driver.
Labels of vertices and edges may not be the same as names of tables in PostgreSQL. A mappedTableSource object in each vertex or edge type specifies a schema name public and a table name referral.
The mappedTableSource object marks meta columns (e.g., attributes) in the tables. For instance, fields from and to refer to two columns that form endpoints of the edges.

Once the schema file mysql.json 928 is created, the user uploads it to the graph analytics engine at localhost with shell command 926, as shown in FIG. 9C.

### Querying Relational Databases: DuckDB

The user starts a DuckDB container through Docker by command 930, as illustrated in FIG. 9E, and writes data to DuckDB. After waiting for the DuckDB container to start, the user runs command 932 to start DuckDB interactive shell, as illustrated in FIG. 9E. Then, the user creates a database and a data table by statements 934, as illustrated in FIG. 9E, and writes the data to DuckDB. After writing the data to DuckDB, the user stops the DuckDB interactive shell by typing .exit to close the DuckDB client. This is to avoid a conflict with other programs (e.g., the graph analytics engine). In some embodiments, running the commands 930 and 932 and the statements 934 is optional.

The user then defines a schema file duckdb.json 938 before querying the table, as illustrated in FIG. 9F. The schema file duckdb.json 938 requires:
A catalog jdbc_duckdb is added to specify remote data source in DuckDB.
   Set type to duckdb.
   Set driverClass to org.duckdb.DuckDBDriver.
   Set driverUrl to provide a URL where the graph analytics engine finds the DuckDB driver.
Labels of vertices and edges may not be the same as names of tables in DuckDB. A mappedTableSource object in each vertex or edge type specifies a schema name graph and a table name referral.
The mappedTableSource object marks meta columns (e.g., attributes) in the tables. For instance, fields from and to refer to two columns that form endpoints of the edges.

Once the schema file duckdb.json 938 is created, the user uploads it to the graph analytics engine at localhost with shell command 936, as shown in FIG. 9E.

### Querying Relational Databases: BigQuery

For creating tables and insert data to BigQuery, the user performs steps below as shown in screenshots (e.g., 940, 942, and 944) of FIGS. 9G-9I.
Create a dataset with multiple-region support in (e.g., the screenshot 940).
Create tables using a web console (e.g., the screenshots 942 and 944).
   After that, the user opens a query table and execute SQL statements 946, as illustrated in FIG. 9J. In some embodiments, performing steps shown in FIGS. 9G-9I and executing SQL statements 946 are optional. In some embodiments, a BigQuery Authentication is required.

Next, the user starts the graph analytics engine container named puppy through a key key.json command 948, as illustrated in FIG. 9J.

Then, the user defines a schema file bigquery.json 952 before querying the table, as illustrated in FIG. 9K. The schema file bigquery.json 952 requires:
A catalog jdbc_bigquery is added to specify remote data source in BigQuery.
   Set type to bigquery.
   Set driverClass to com.simba.googlebigquery.jdbc.Driver.
   Set driverUrl to provide a URL where the graph analytics engine finds the DuckDB driver.
jdbcUri needs to be set in accordance with the user's service account configuration.
   Set ProjectId=PJID. PJID for service account project id.
   Set OAuthServiceAcctEmail=for service account id.
   Set OAuthPvtKeyPath=for a key file path in the docker container (e.g., /home/key.json).
Labels of vertices and edges may not be the same as names of tables in BigQuery. A mappedTableSource object in each vertex or edge type specifies a schema name demo and a table name referral.
The mappedTableSource object marks meta columns (e.g., attributes) in the tables. For instance, fields from and to refer to two columns that form endpoints of the edges.

Once the schema file bigquery.json 952 is created, the user uploads it to the graph analytics engine at localhost with shell command 950, as shown in FIG. 9J.

### Querying Relational Databases: RedShift

For creating tables and insert data to RedShift, the user follows steps below as shown in screenshots (e.g., 960 and 962) in FIGS. 9L-9M.
Create a database with a query editor (e.g., the screenshot 960).
Create tables in the database (e.g., the screenshot 962).
   After that, the user executes SQL statements 964 to insert data into the tables, as illustrated in FIG. 9N. In some embodiments, performing steps shown in FIGS. 9L-9M and executing SQL statements 964 are optional.

Then, the user defines a schema file redshift.json 968 before querying the table, as illustrated in FIG. 9O. The schema file redshift.json 968 requires:
A catalog jdbc_redshift is added to specify remote data source in RedShift.
Replace username and password.
Replace jdbcUri with the user's JDBC URL.
Labels of vertices and edges may not be the same as names of tables in RedShift. A mappedTableSource object in each vertex or edge type specifies a schema name public and a table name referral.
The mappedTableSource object marks meta columns (e.g., attributes) in the tables. For instance, fields from and to refer to two columns that form endpoints of the edges.

Once the schema file redshift.json 968 is created, the user uploads it to the graph analytics engine at localhost with shell command 966, as shown in FIG. 9N.

To query the data based on the relational databases (e.g., MySQL, PostgreSQL, DuckDB, BigQuery, and Redshift) discussed above, the user connects to the graph analytics engine at http://localhost:8081 and start the embedded Gremlin console UI 550 (e.g., in reference to FIG. 5G) through the management UI 530 of the graph analytics engine.

After connecting to the embedded Gremlin Console, the user starts to query the graph. For instance, the user submits an example graph query 880 for checking names of people known by a person and subsequently receives corresponding output entries 882, as shown in FIG. 8J.

### Schema Creation User Interfaces

FIGS. 10A-10Q illustrate a series of screenshots of an example schema creation UI 1000 for creating an example person_knows_person_UI graph schema 1022, in accordance with some implementations. The example schema creation UI 1000 allows a user to create graph schemas (e.g., JSON files) by UI features provided by the example schema creation UI 1000 such that there is no need for the user to upload separate JSON files.

FIG. 10A illustrates a “Create Graph Schema” section 1002 and a “Upload Graph Schema JSON” section 1004 within the example schema creation UI 1000. The user can choose the “Create Graph Schema” section 1002 to initiate a schema creation process using UI features provided by the example schema creation UI 1000.

FIGS. 10B-10D illustrate the user's selection of respective catalog information 1006 and respective to-be-queried database information 1008 in accordance with the example person_knows_person_UI graph schema.

FIGS. 10E-10N illustrate a series of steps of creating respective vertices (e.g., 1010 and 1012) and respective edges (1014 and 1016) of the example person_knows_person_UI graph schema. In addition, FIG. 10N illustrates a respective graph representation of the respective vertices (e.g., 1010 and 1012) and respective edges (1014 and 1016). The user clicks “Submit” 1020 to start processing the respective vertices (e.g., 1010 and 1012) and respective edges (1014 and 1016) for generating a respective graph schema, as shown in FIGS. 10N-10O.

FIGS. 10P-10Q illustrate the example person_knows_person_UI graph schema 1022 generated by the example schema creation UI 1000 in accordance with the respective vertices (e.g., 1010 and 1012) and respective edges (1014 and 1016).

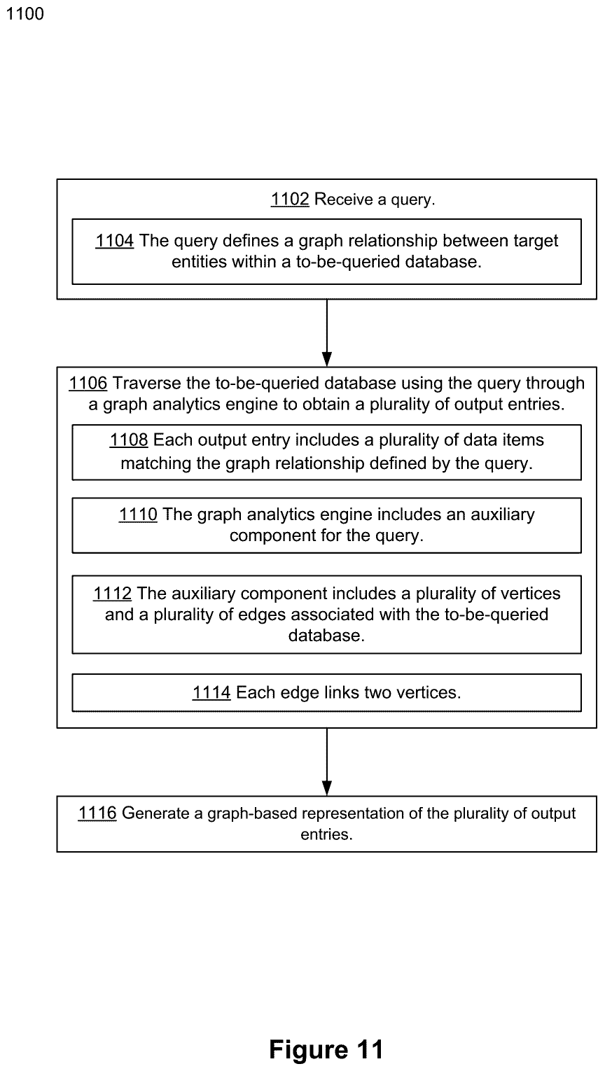

FIG. 11 illustrates a flow diagram of an example data query method 1100, in accordance with some embodiments. In some embodiments, the example data query method 1100 is performed at a computer system. In some embodiments, the example data query method 1100 is governed by instructions that are stored in a non-transitory computer-readable storage medium and that are executed by one or more processors of the computer system.

In the example data query method 1100, the computer system receives (1102) a query. The query defines (1104) a graph relationship between target entities within a to-be-queried database. The computer system traverses (1106) the to-be-queried database using the query through a graph analytics engine to obtain a plurality of output entries. Each output entry includes (1108) a plurality of data items matching the graph relationship defined by the query. The graph analytics engine includes (1110) an auxiliary component for the query. The auxiliary component includes (1112) a plurality of vertices and a plurality of edges associated with the to-be-queried database. Each edge links (1114) two vertices. The computer system generates (1116) a graph-based representation of the plurality of output entries.

In some embodiments, traversing the to-be-queried database using the query through the graph analytics engine further comprises: mapping the query into a logical data plan in accordance with the auxiliary component; translating the logical data plan to a physical data plan; and querying, based on the physical data plan, the to-be-queried database through an execution node. Further, in some embodiments, the graph analytics engine includes a plurality of execution nodes. Each execution node is associated with a respective to-be-queried database.

In some embodiments, the query is written in a graph query language.

In some embodiments, the to-be-queried database is built in accordance with a data architecture. The data architecture includes at least one of relational database, data warehouse, or data lake.

In some embodiments, the to-be-queried database defines the graph relationship between the target entities in a tabular form.

In some embodiments, the to-be-queried database is compatible with structured query language (SQL).

In some embodiments, the to-be-queried database includes a non-SQL (NoSQL) database.

In some embodiments, traversing the to-be-queried database using the query through the graph analytics engine further comprises: obtaining catalogs, schemas, and attributes, based on the graph relationship between the target entities; defining the plurality of vertices and the plurality of edges in form of arrays, based on the catalogs, schemas, and attributes; and generating the auxiliary component, based on the plurality of vertices and the plurality of edges. Moreover, in some embodiments, the auxiliary component is a human-readable file. In some embodiments, the human-readable file is in a standard text-based format, including at least one of JavaScript Object Notation (JSON), Human-Optimized Config Object Notation (HOCON), or Extensible Markup Language (XML). Further, in some embodiments, a respective edge linking two adjacent vertices of the plurality of vertices is directed or undirected. In some embodiments, the respective edge linking two adjacent vertices of the plurality of vertices includes a weight component. Additionally, in some embodiments, the auxiliary component is created through a user interface associated with the auxiliary component.

In some embodiments, generating the graph-based representation of the plurality of output entries further comprises: obtaining a respective graph relationship of the plurality of output entries; optimizing the respective graph relationship of the plurality of output entries for scalability; and visualizing the optimized respective graph relationship of the plurality of output entries.

In some embodiments, the receiving the graph query, the traversing the to-be-queried database using the query through the graph analytics engine to obtain the plurality of output entries, and the generating the graph-based representation of the plurality of output entries are performed via an application or a user interface.

It should be understood that the particular order in which the operations in FIG. 10 have been described are merely exemplary and are not intended to indicate that the described order is the only order in which the operations could be performed. One of ordinary skill in the art would recognize various ways to providing a computer system for performing data queries. It is also noted that more details on the data query method are explained above with reference to FIGS. 1-10Q. For brevity, these details are not repeated in the description herein.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A data query method, comprising:
receiving a query, the query defining a graph relationship between target entities within a to-be-queried database;
traversing the to-be-queried database using the query through a graph analytics engine to obtain a plurality of output entries, each output entry including a plurality of data items matching the graph relationship defined by the query, wherein:
the graph analytics engine includes an auxiliary component for the query, the auxiliary component including a plurality of vertices and a plurality of edges associated with the to-be-queried database, each edge linking two vertices; and
generating a graph-based representation of the plurality of output entries.

2. The data query method of claim 1, wherein traversing the to-be-queried database using the query through the graph analytics engine further comprises:
mapping the query into a logical data plan in accordance with the auxiliary component;
translating the logical data plan to a physical data plan; and
querying, based on the physical data plan, the to-be-queried database through an execution node.

3. The data query method of claim 2, wherein the graph analytics engine includes a plurality of execution nodes, each execution node being associated with a respective to-be-queried database.

4. The data query method of claim 1, wherein the query is written in a graph query language.

5. The data query method of claim 1, wherein the to-be-queried database is built in accordance with a data architecture, the data architecture including at least one of relational database, data warehouse, or data lake.

6. The data query method of claim 1, wherein the to-be-queried database defines the graph relationship between the target entities in a tabular form.

7. The data query method of claim 1, wherein the to-be-queried database is compatible with structured query language (SQL).

8. The data query method of claim 1, wherein the to-be-queried database includes a non-SQL (NoSQL) database.

9. The data query method of claim 1, wherein traversing the to-be-queried database using the query through the graph analytics engine further comprises:
obtaining catalogs, schemas, and attributes, based on the graph relationship between the target entities;
defining the plurality of vertices and the plurality of edges in form of arrays, based on the catalogs, schemas, and attributes; and
generating the auxiliary component, based on the plurality of vertices and the plurality of edges.

10. The data query method of claim 9, wherein the auxiliary component is a human-readable file.

11. The data query method of claim 10, wherein the human-readable file is in a standard text-based format, including at least one of JavaScript Object Notation (JSON), Human-Optimized Config Object Notation (HOCON), or Extensible Markup Language (XML).

12. The data query method of claim 9, wherein a respective edge linking two adjacent vertices of the plurality of vertices is directed or undirected.

13. The data query method of claim 12, wherein the respective edge linking two adjacent vertices of the plurality of vertices includes a weight component.

14. The data query method of claim 9, wherein the auxiliary component is created through a user interface associated with the auxiliary component.

15. The data query method of claim 1, wherein generating the graph-based representation of the plurality of output entries further comprises:
obtaining a respective graph relationship of the plurality of output entries;
optimizing the respective graph relationship of the plurality of output entries for scalability; and
visualizing the optimized respective graph relationship of the plurality of output entries.

16. The data query method of claim 1, wherein the receiving, the traversing, and the generating are performed via an application or a user interface.

17. A computer system, comprising:
one or more processors; and
memory storing one or more programs, the one or more programs comprising instructions that, when executed by the one or more processors, cause the one or more processors to perform operations comprising:
receiving a query, the query defining a graph relationship between target entities within a to-be-queried database;
traversing the to-be-queried database using the query through a graph analytics engine to obtain a plurality of output entries, each output entry including a plurality of data items matching the graph relationship defined by the query, wherein:
the graph analytics engine includes an auxiliary component for the query, the auxiliary component including a plurality of vertices and a plurality of edges associated with the to-be-queried database, each edge linking two vertices; and
generating a graph-based representation of the plurality of output entries.

18. A non-transitory computer-readable storage medium storing one or more programs, the one or more programs comprising instructions that, when executed by a computer system that includes one or more processors, cause the one or more processors to perform operations comprising:
receiving a query, the query defining a graph relationship between target entities within a to-be-queried database;
traversing the to-be-queried database using the query through a graph analytics engine to obtain a plurality of output entries, each output entry including a plurality of data items matching the graph relationship defined by the query, wherein:
the graph analytics engine includes an auxiliary component for the query, the auxiliary component including a plurality of vertices and a plurality of edges associated with the to-be-queried database, each edge linking two vertices; and
generating a graph-based representation of the plurality of output entries.
